(19) United States
(12) Patent Application Publication
(10) Pub. No.: US 2024/0284428 A1
(43) Pub. Date: Aug. 22, 2024

(54) SL BEAM INDICATION

(71) Applicant: Samsung Electronics Co., Ltd., Suwon-si (KR)

(72) Inventors: Emad Nader Farag, Flanders, NJ (US); Eko Onggosanusi, Coppell, TX (US); Dalin Zhu, Allen, TX (US)

(21) Appl. No.: 18/419,267

(22) Filed: Jan. 22, 2024

Related U.S. Application Data
(60) Provisional application No. 63/443,616, filed on Feb. 6, 2023.
(60) Provisional application No. 63/443,851, filed on Feb. 7, 2023.

(51) Int. Cl. H04W 72/044; H04L 5/00; H04W 72/40

(52) U.S. Cl. CPC H04W 72/046; H04L 5/005; H04W 72/40

(57) ABSTRACT

Methods and apparatuses for sidelink (SL) beam indication. A method of operating a user equipment (UE) includes transmitting, to a second UE, a first set of reference signals or receiving, from the second UE, a second set of reference signal. The method further includes identifying a beam indication for transmission to or reception from the second UE; determining, based on the beam indication, a spatial transmission filter or a spatial reception filter; and determining a time T to apply the beam indication. The beam indication is associated with a reference signal from the first set of reference signals or the second set of reference signals. The method further includes transmitting, to the second UE, a first SL channel using the spatial transmission filter starting from the time T or receiving, from the second UE, a second SL channel using the spatial reception filter starting from the time T.

### CROSS-REFERENCE TO RELATED APPLICATIONS AND CLAIM OF PRIORITY

The present application claims priority to U.S. Provisional Patent Application No. 63/443,616, filed on Feb. 6, 2023, and U.S. Provisional Patent Application No. 63/443,851, filed on Feb. 7, 2023. The contents of the above-identified patent documents are incorporated herein by reference.

### TECHNICAL FIELD

The present disclosure relates generally to wireless communication systems and, more specifically, the present disclosure relates to a sidelink (SL) beam indication in frequency range 2 (FR2) in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to a SL beam indication in FR2 in a wireless communication system.

In one embodiment, a user equipment (UE) is provided. The UE includes a transceiver configured to transmit, to a second UE, a first set of reference signals or receive, from the second UE, a second set of reference signal. The UE further includes a processor operably coupled to the transceiver. The processor is configured to identify a beam indication for transmission to the second UE, or reception from the second UE, determine, based on the beam indication, a spatial transmission filter or a spatial reception filter, and determine a time T to apply the beam indication. The beam indication is associated with a reference signal from the first set of reference signals or the second set of reference signals. The transceiver is further configured to transmit, to the second UE, a first SL channel using the spatial transmission filter starting from the time T or receive, from the second UE, a second SL channel using the spatial reception filter starting from the time T.

In another embodiment, a base station (BS) is provided. The BS includes a transceiver configured to transmit configuration information for a set of reference signals on a sidelink interface and a processor operably coupled to the transceiver. The processor is configured to determine a beam indication, based on the set of reference signals, for a sidelink channel. The transceiver is further configured to transmit a downlink control channel (DCI) format that includes the beam indication.

In yet another embodiment, a method of operating a UE is provided. The method includes transmitting, to a second UE, a first set of reference signals or receiving, from the second UE, a second set of reference signal. The method further includes identifying a beam indication for transmission to the second UE, or reception from the second UE; determining, based on the beam indication, a spatial transmission filter or a spatial reception filter; and determining a time T to apply the beam indication. The beam indication is associated with a reference signal from the first set of reference signals or the second set of reference signals. The method further includes transmitting, to the second UE, a first SL channel using the spatial transmission filter starting from the time T or receiving, from the second UE, a second SL channel using the spatial reception filter starting from the time T.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to the present disclosure;

FIG. 6A illustrates an example of wireless system beam according to various embodiments of the present disclosure;

FIG. 6B illustrates an example of multi-beam operation according to various embodiments of the present disclosure;

FIG. 7 illustrates an example of antenna structure according to various embodiments of the present disclosure;

FIG. 8 illustrates a flowchart for an example of layer-2 link establishment procedure for unicast mode of V2X communication over PC5 reference point according to various embodiments of the present disclosure;

FIG. 9 illustrates an example of MAC CE signaling according to various embodiments of the present disclosure; and

FIG. 10 illustrates an example of UE reference signal configuration according to various embodiments of the present disclosure;

FIG. 11 illustrates an example of RRC configuration, MAC CE activation, and L1 control indication of reference signals for beam identification according to various embodiments of the present disclosure;

FIG. 12 illustrates an example of RRC configuration and L1 control indication of reference signals for beam identification according to various embodiments of the present disclosure;

FIG. 13 illustrates an example of RRC configuration and MAC CE indication of TCI states/spatial relation information for beam identification according to various embodiments of the present disclosure;

FIG. 14 illustrates an example of TCI state or a spatial relation information according to various embodiments of the present disclosure;

FIG. 15 illustrates an example of RRC configuration, MAC CE activation, and L1 control indication of TCI states/spatial relation information for beam identification according to various embodiments of the present disclosure;

FIG. 16 illustrates an example of RRC configuration and L1 control indication of TCI states/spatial relation information for beam identification according to various embodiments of the present disclosure;

FIG. 17 illustrates an example of RRC configuration and MAC CE indication of TCI states/spatial relation information for beam identification according to various embodiments of the present disclosure; and

FIGS. 18-28 illustrate examples of a beam indication according to various embodiments of the present disclosure.

### DETAILED DESCRIPTION

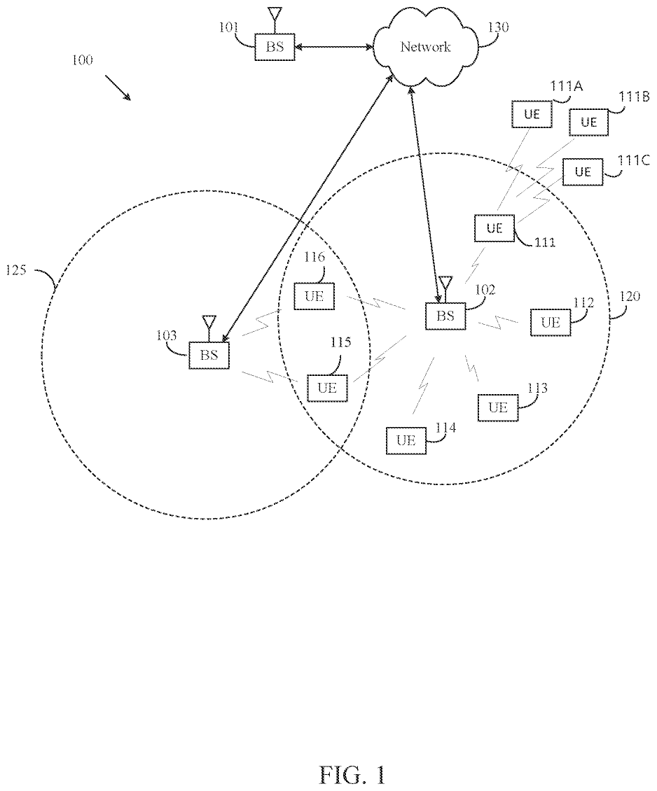

FIG. 1 through FIG. 28, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v17.6.0, “NR; Physical channels and modulation”; 3GPP TS 38.212 v17.6.0, “NR; Multiplexing and Channel coding”; 3GPP TS 38.213 v17.7.0, “NR; Physical Layer Procedures for Control”; 3GPP TS 38.214 v17.7.0, “NR; Physical Layer Procedures for Data”; 3GPP TS 38.321 v17.6.0, “NR; Medium Access Control (MAC) protocol specification”; 3GPP TS 38.331 v17.6.0, “NR; Radio Resource Control (RRC) Protocol Specification”; and 3GPP TS 36.213 v17.6.0, “Evolved Universal Terrestrial Radio Access (E-UTRA); Physical layer procedures.”

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of the present disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

In another example, the UE 116 may be within network coverage and the other UE may be outside network coverage (e.g., UEs 111A-111C). In yet another example, both UEs are outside network coverage. In some embodiments, one or more of the gNBs 101-103 may communicate with each other and with the UEs 111-116 using 5G/NR, LTE, LTE-A, WiMAX, WiFi, or other wireless communication techniques. In some embodiments, the UEs 111-116 may use a device to device (D2D) interface called PC5 (e.g., also known as sidelink at the physical layer) for communication.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for SL beam indication in FR2 in a wireless communication system. In certain embodiments, and one or more of the gNBs 101-103 includes circuitry, programing, or a combination thereof, for supporting a SL beam indication in FR2 in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

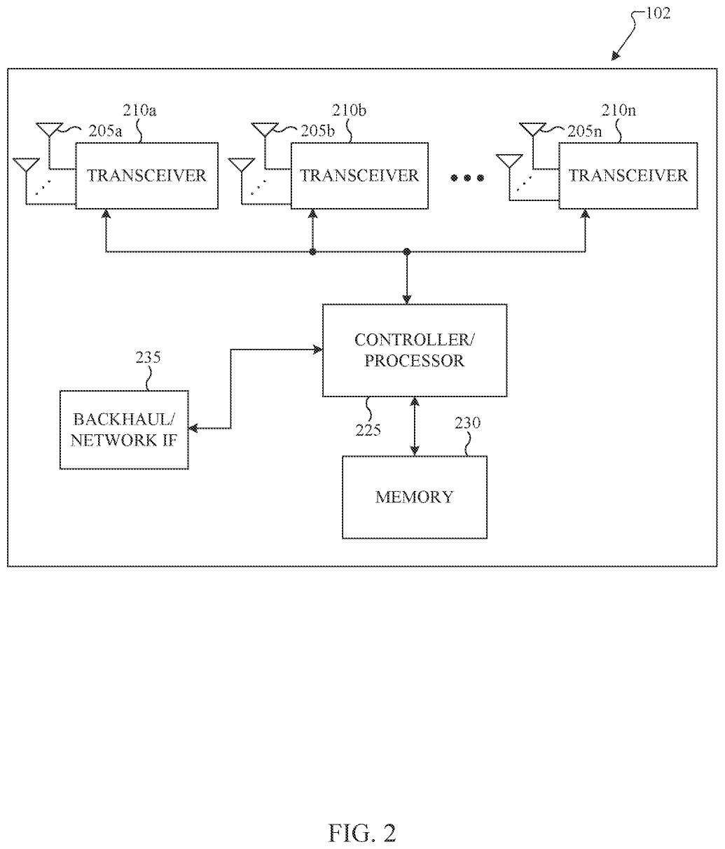

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channels and/or signals and the transmission of DL channels and/or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting a SL beam indication in FR2 in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

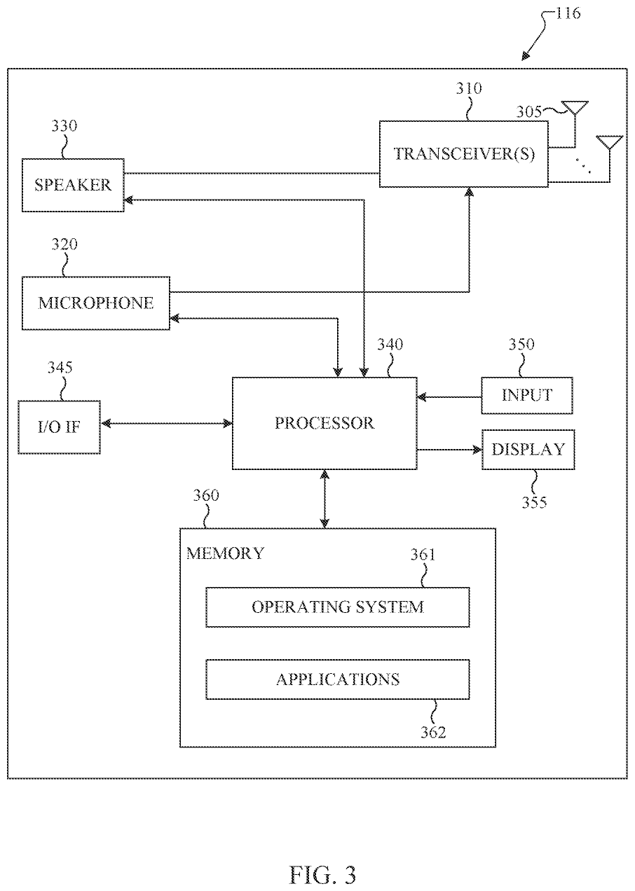

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100 or by other UEs (e.g., one or more of UEs 111-115) on a SL channel. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels and/or signals and SL channels and/or signals and the transmission of UL channels and/or signals and SL channels and/or signals by the transceiver(s) 310 in accordance with well-known principles. In some embodiments, the processor 340 includes at least one microprocessor or microcontroller.

The processor 340 is also capable of executing other processes and programs resident in the memory 360, such as processes for a SL beam indication in FR2 in a wireless communication system.

The processor 340 can move data into or out of the memory 360 as required by an executing process. In some embodiments, the processor 340 is configured to execute the applications 362 based on the OS 361 or in response to signals received from gNBs, another UE, or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

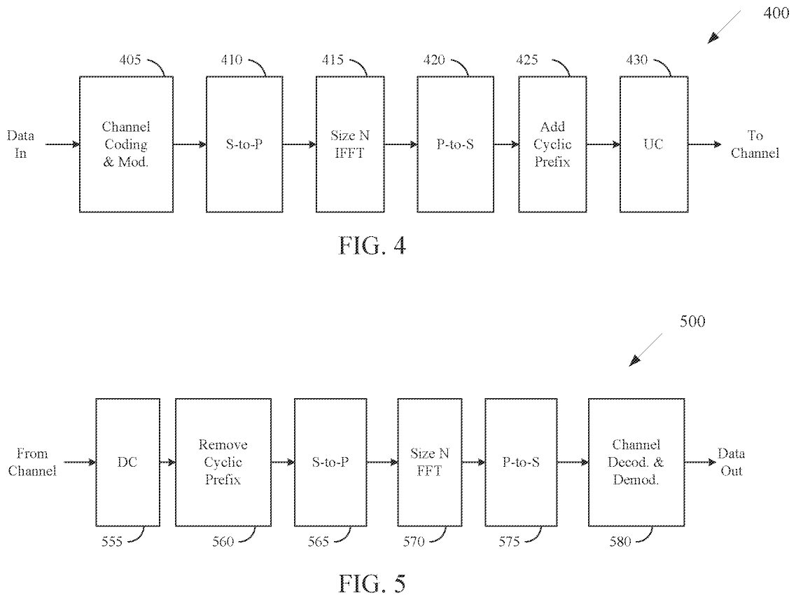

FIG. 4 and FIG. 5 illustrate example wireless transmit and receive paths according to the present disclosure. In the following description, a transmit path 400 may be described as being implemented in a first UE (such as the UE 111), while a receive path 500 may be described as being implemented in a second UE (such as a UE 111A). However, it may be understood that the receive path 500 can be implemented in the second UE 111A and that the transmit path 400 can be implemented in the first UE 111. In some embodiments, the transmit path 400 and the receive path 500 are configured to support SL beam indication in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 or another UE arrives at the UE 116 after passing through the wireless channel, and reverse operations to those at the gNB 102 or another UE are performed at the UE 116.

As illustrated in FIG. 5, the down converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 or transmitting in the sidelink to another UE and may implement the receive path 500 for receiving in the downlink from the gNBs 101-103 or receiving in the sidelink from another UE.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of the present disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

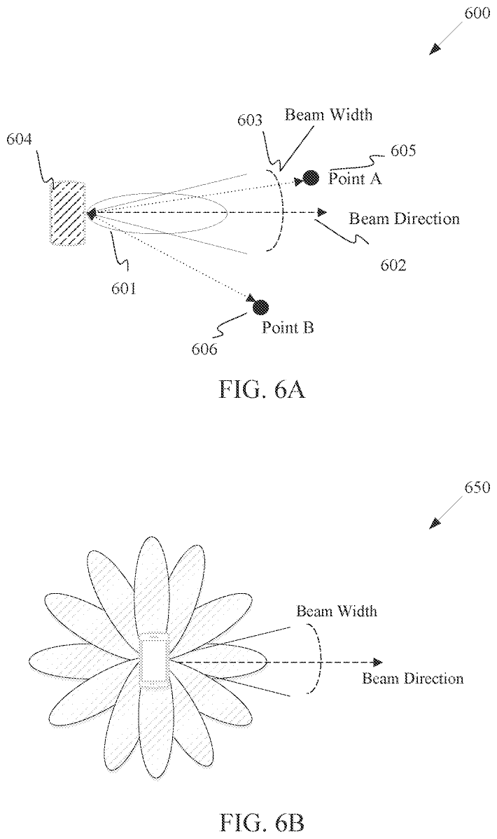

FIG. 6A illustrates an example wireless system beam 600 according to embodiments of the present disclosure. An embodiment of the wireless system beam 600 shown in FIG. 6A is for illustration only.

As illustrated in FIG. 6A, in a wireless system a beam 601, for a device 604, can be characterized by a beam direction 602 and a beam width 603. For example, a device 604 with a transmitter transmits radio frequency (RF) energy in a beam direction and within a beam width. The device 604 with a receiver receives RF energy coming towards the device in a beam direction and within a beam width. As illustrated in FIG. 6A, a device at point A 605 can receive from and transmit to the device 604 as point A is within a beam width of a beam traveling in a beam direction and coming from the device 604.

As illustrated in FIG. 6A, a device at point B 606 cannot receive from and transmit to the device 604 as point B is outside a beam width of a beam traveling in a beam direction and coming from the device 604. While FIG. 6A, for illustrative purposes, shows a beam in 2-dimensions (2D), it may be apparent to those skilled in the art, that a beam can be in 3-dimensions (3D), where the beam direction and beam width are defined in space.

FIG. 6B illustrates an example multi-beam operation 650 according to embodiments of the present disclosure. An embodiment of the multi-beam operation 650 shown in FIG. 6B is for illustration only.

In a wireless system, a device can transmit and/or receive on multiple beams. This is known as “multi-beam operation” and is illustrated in FIG. 6B. While FIG. 6B, for illustrative purposes, is in 2D, it may be apparent to those skilled in the art, that a beam can be 3D, where a beam can be transmitted to or received from any direction in space.

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 7.

FIG. 7 illustrates an example antenna structure 700 according to embodiments of the present disclosure. An embodiment of the antenna structure 700 shown in FIG. 7 is for illustration only.

In this case, one CSI-RS port is mapped onto a large number of antenna elements which can be controlled by a bank of analog phase shifters 701. One CSI-RS port can then correspond to one sub-array which produces a narrow analog beam through analog beamforming 705. This analog beam can be configured to sweep across a wider range of angles 720 by varying the phase shifter bank across symbols or subframes. The number of sub-arrays (equal to the number of RF chains) is the same as the number of CSI-RS ports NCS_{CSI-PORT}. A digital beamforming unit 710 performs a linear combination across NCS_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL, UL, or SL TX beam (also termed “beam indication”), measuring at least one reference signal for calculating and performing beam reporting (also termed “beam measurement” and “beam reporting,” respectively), and receiving a DL, UL, or SL transmission via a selection of a corresponding RX beam.

The aforementioned system is also applicable to higher frequency bands such as >52.6 GHz. In this case, the system can employ only analog beams. Due to the O2 absorption loss around 60 GHz frequency (˜10 dB additional loss @100 m distance), larger number of and sharper analog beams (hence larger number of radiators in the array) may be needed to compensate for the additional path loss.

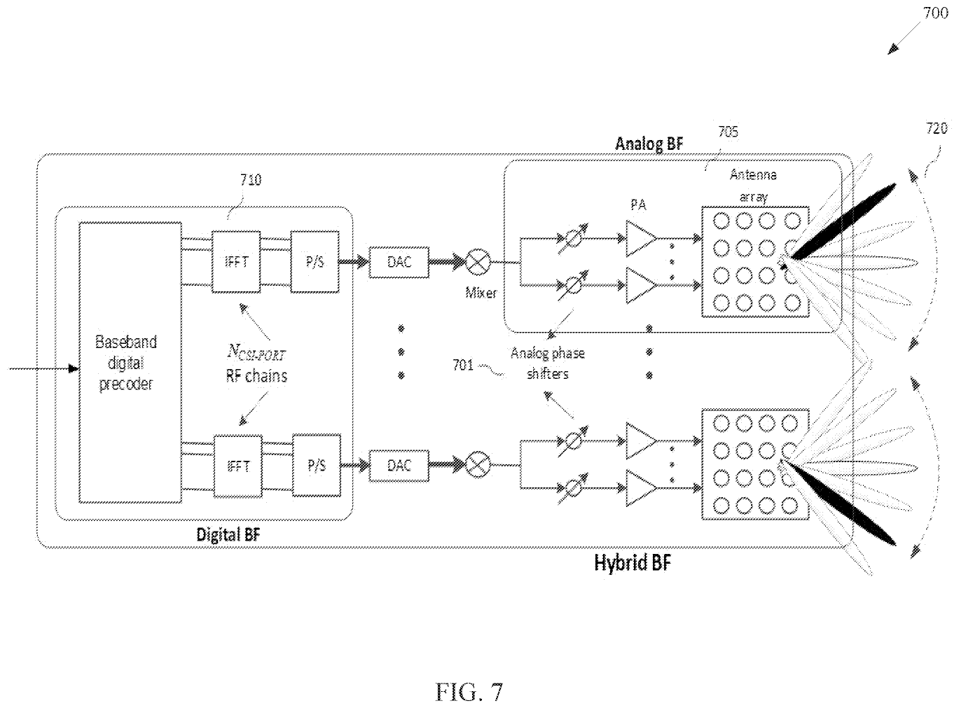

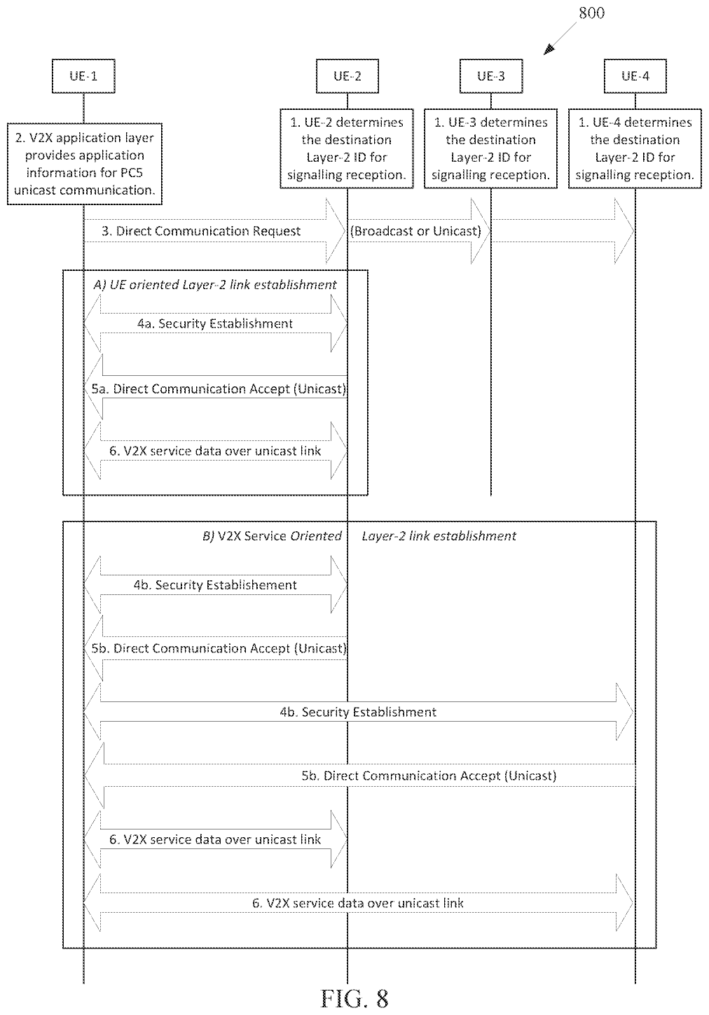

FIG. 8 illustrates an example of layer-2 link establishment procedure 800 for unicast mode of V2X communication over PC5 reference point according to embodiments of the present disclosure. The layer-2 link establishment procedure 800 as may be performed by a UE (e.g., 111-116 as illustrated in FIG. 1). An embodiment of the layer-2 link establishment procedure 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

As illustrated in FIG. 8, following steps are performed.

In one example of Step 1, the UE(s) determine the destination Layer-2 ID for signaling reception of PC5 unicast link establishment. This is determined as specified in 3GPP standard specification TS 23.387. The destination Layer-2 ID is configured with the UE(s) as specified in 3GPP standard specification TS 23.387.

In one example of Step 2, the V2X application layer in UE-1 provides application information for PC5 unicast communicating.

In one example of Step 3, a UE-1 sends a direct communication request (DCR) to initiate the unicast layer-2 link establishment procedure. UE-1 send the DCR message via PC5 broadcast or unicast using the source layer-2 ID and destination layer-2 ID.

In one example of Step 4 (Step 4a or Step 4b), the target UE or the UEs that are interested in using the announced V2X service type(s) over a PC5 unicast link with UE-1 respond establishing the security with UE-1.

In one example of Step 5 (Step 5a or Step 5b), a direct communication accept message is sent to UE-1 by the target UE(s) that has successfully established security with UE-1.

In one example of Step 6, V2X service data is transmitted over the established unicast link.

A time unit for DL signaling, for UL signaling, or for SL signaling on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. As another example, a slot can have a duration of 0.25 milliseconds and include 14 symbols and an RB can have a BW of 720 kHz and include 12 SCs with SC spacing of 60 kHz. An RB in one symbol of a slot is referred to as physical RB (PRB) and includes a number of resource elements (REs). A slot can be either full DL slot, or full UL slot, or hybrid slot similar to a special subframe in time division duplex (TDD) systems (see also REF 1). In addition, a slot can have symbols for SL communications. A UE can be configured one or more bandwidth parts (BWPs) of a system BW for transmissions or receptions of signals or channels.

SL signals and channels are transmitted and received on sub-channels within a resource pool, where a resource pool is a set of time-frequency resources used for SL transmission and reception within a SL BWP. SL channels include physical SL shared channels (PSSCHs) conveying data information and second stage/part SL control information (SCI), physical SL control channels (PSCCHs) conveying first stage/part SCI for scheduling transmissions/receptions of PSSCHs, physical SL feedback channels (PSFCHs) conveying hybrid automatic repeat request acknowledgement (HARQ-ACK) information in response to correct (ACK value) or incorrect (NACK value) transport block receptions in respective PSSCHs, PSFCHs can also convey conflict information, and physical SL Broadcast channel (PSBCH) conveying system information to assist in SL synchronization.

SL signals include demodulation reference signals DM-RS that are multiplexed in PSSCH or PSCCH transmissions to assist with data or SCI demodulation, channel state information reference signals (CSI-RS) for channel measurements, phase tracking reference signals (PT-RS) for tracking a carrier phase, SL primary synchronization signals (S-PSS) and SL secondary synchronization signals (S-SSS) for SL synchronization, and SL position reference signal (SL PRS) for SL positioning measurements. SCI can include two parts/stages corresponding to two respective SCI formats where, for example, the first SCI format is multiplexed on a PSCCH, and the second SCI format is multiplexed along with SL data on a PSSCH that is transmitted in physical resources indicated by the first SCI format.

A SL channel can operate in different cast modes. In a unicast mode, a PSCCH/PSSCH conveys SL information from one UE to only one other UE. In a groupcast mode, a PSCCH/PSSCH conveys SL information from one UE to a group of UEs within a (pre-)configured set. In a broadcast mode, a PSCCH/PSSCH conveys SL information from one UE to all surrounding UEs. In NR release 16, there are two resource allocation modes for a PSCCH/PSSCH transmission. In resource allocation mode 1, a gNB schedules a UE on the SL and conveys scheduling information to the UE transmitting on the SL through a DCI format (e.g., DCI Format 3_0) transmitted from the gNB on the DL. In resource allocation mode 2, a UE schedules a SL transmission. SL transmissions can operate within network coverage where each UE is within the communication range of a gNB, outside network coverage where all UEs have no communication with any gNB, or with partial network coverage, where only some UEs are within the communication range of a gNB.

In case of groupcast PSCCH/PSSCH transmission, a network can configure a UE one of two options for reporting of HARQ-ACK information by the UE: (1) HARQ-ACK reporting option 1: a UE can attempt to decode a transport block (TB) in a PSSCH reception if, for example, the UE detects a SCI format scheduling the TB reception through a corresponding PSSCH. If the UE fails to correctly decode the TB, the UE multiplexes a negative acknowledgement (NACK) in a PSFCH transmission. In this option, the UE does not transmit a PSFCH with a positive acknowledgment (ACK) when the UE correctly decodes the TB; and (2) HARQ-ACK reporting option 2: a UE can attempt to decode a TB if, for example, the UE detects a SCI format that schedules a corresponding PSSCH. If the UE correctly decodes the TB, the UE multiplexes an ACK in a PSFCH transmission; otherwise, if the UE does not correctly decode the TB, the UE multiplexes a NACK in a PSFCH transmission.

In a HARQ-ACK reporting option (1), when a UE that transmitted the PSSCH detects a NACK in a PSFCH reception, the UE can transmit another PSSCH with the TB (retransmission of the TB). In HARQ-ACK reporting option (2) when a UE that transmitted the PSSCH does not detect an ACK in a PSFCH reception, such as when the UE detects a NACK or does not detect a PSFCH reception, the UE can transmit another PSSCH with the TB.

A sidelink resource pool includes a set/pool of slots and a set/pool of RBs used for sidelink transmission and sidelink reception. A set of slots which belong to a sidelink resource pool can be denoted by {t′₀^{SL}, t′₁^{SL}, t′₂^{SL}, . . . , t′_{T′MAX-1}^{SL}} and can be configured, for example, at least using a bitmap. Where, T′_{MAX} is the number of SL slots in a resource pool within 1024 frames. Within each slot t′_{y}^{SL} of a sidelink resource pool, there are N_{subCH} contiguous sub-channels in the frequency domain for sidelink transmission, where N_{subCH} is provided by a higher-layer parameter. Subchannel m, where m is between 0 and N_{subCH}−1, is given by a set of n_{subCHsize} contiguous PRBs, given by n_{PRB}=n_{subCHstart}+m·n_{subCHsize}+j, where j=0, 1, . . . , n_{subCHsize}−1, n_{subCHstart} and n_{subCHsize} are provided by higher layer parameters.

For resource (re-)selection or re-evaluation in slot n, a UE can determine a set of available single-slot resources for transmission within a resource selection window [n+T₁, n+T₂], such that a single-slot resource for transmission, R_{x,y} is defined as a set of L_{subCH} contiguous subchannels x+i, where i 0, 1, . . . , L_{subCH}−1 in slot t_{y}^{SL}. T₁ is determined by the UE such that, 0≤T₁≤T_{proc,1}^{SL}, where T_{proc,1}^{SL} is a PSSCH processing time for example as defined in TS 38.214. T₂ is determined by the UE such that T₂ₘᵢₙ≤T₂≤Remaining Packet Delay Budget, as long as T₂ₘᵢₙ<Remaining Packet Delay Budget, else T₂ is equal to the Remaining Packet Delay Budget. T₂ₘᵢₙ is a configured by higher layers and depends on the priority of the SL transmission.

The slots of a SL resource pool are determined as follows in TABLE 1.

TABLE 1
SL resource pool determination

| 1. | Let set of slots that may belong to a resource be denoted by {t₀^{SL}, t₁^{SL}, t₂^{SL}, . . ., t_{T}_{_{MAX}}₋₁^{SL}}, where | | |
|---|---|---|---|
| | 0 ≤ tᵢ^{SL} < 10240 × 2^{μ}, and 0 ≤ i < Tₘₐₓ, μ is the sub-carrier spacing configuration. μ = | | |
| | 0 for a 15 kHz sub-carrier spacing. u = 1 for a 30 kHz sub-carrier spacing. u = 2 for a 60 | | |
| | kHz sub-carrier spacing. μ = 3 for a 120 kHz sub-carrier spacing. The slot index is relative | | |
| | to slot#0 of system frame number (SFN)#0 of the serving cell, or direct frame number | | |
| | (DFN)#0. The set of slots includes all slots except: | | |
| | a. | N_{S-SSB} slots that are configured for SL SS/PBCH Block (S-SSB). | |
| | b. | N_{nonSL} slots where at least one SL symbol is not semi-statically configured as UL | |
| | | symbol by higher layer parameter tdd-UL-DL-ConfigurationCommon or sl-TDD- | |
| | | Configuration. In a SL slot, OFDM symbols Y-th, (Y + 1)-th, . . . , (Y + X − 1)-th are SL | |
| | | symbols, where Y is determined by the higher layer parameter sl-StartSymbol and X | |
| | | is determined by higher layer parameter sl-LengthSymbols. | |
| | c. | N_{reserved} reserved slots. Reserved slots are determined such that the slots in the set | |
| | | {t₀^{SL}, t₁^{SL}, t₂^{SL}, . . ., t_{T}_{_{MAX}}₋₁^{SL}} is a multiple of the bitmap length (L_{bitmap}), where the | |
| | | bitmap (b₀, b₁, . . ., b_{L}_{_{bitmap}}₋₁) is configured by higer layers. The reserved slots are | |
| | | determined as follows: | |
| | | i. | Let {l₀, l₁, . . ., l₂_{^{μ}}_{×10240-N}_{_{S−SSB}}_{-N}_{_{nonSL}}₋₁} be the set of slots in range 0 . . . |
| | | | 2^{μ} × 10240 − 1, excluding S-SSB slots and non-SL slots. The slots are |
| | | | arranged in ascending order of the slot index. |
| | | ii. | The number of reserved slots is given by: Nreserved = (2^{μ} × 10240 − |
| | | | N_{S-SSB} − N_{nonSL}) mod L_{bitmap}. |
| | | iii. | $The reserved slot {l}_{r} are given by : r = ⌊ \frac{m \cdot ( {2}^{μ} \times 10240 - {N}_{S - SSB} - {N}_{n o n S L} )}{{N}_{r e s e r v e d}} ⌋ , where$ |
| | | | m = 0, 1, . . . , N_{reserved} − 1 |
| | | | Tₘₐₓ is given by: Tₘₐₓ = 24 × 10240 − N_{S-SSB} − N_{nonSL} − N_{reserved}. |

| 2. | The slots are arranged in ascending order of slot index. | |
|---|---|---|
| 3. | The set of slots belonging to the SL resource pool, {t'₀^{SL}, t'₁^{SL}, t'₂^{SL}, . . ., t'_{T'}_{_{MAX}}₋₁^{SL}}, are | |
| | determined as follows: | |
| | a. | Each resource pool has a corresponding bitmap (b₀, b₁, . . ., b_{L}_{_{bitmap}}₋₁) of length |
| | | L_{bitmap}· |
| | b. | A slot tₖ^{SL} belongs to the SL resource pool if b_{k mod L}_{_{bitmap}} = 1 |
| | c. | The remaining slots are indexed successively staring from 0, 1, . . . T'_{MAX} − 1. |
| | | Where, T'_{MAX} is the number of remaining slots in the set. |

Slots can be numbered (indexed) as physical slots or logical slots, wherein physical slots include all slots numbered sequential, while logical slots include only slots that are allocated to sidelink resource pool as described above numbered sequentially. The conversion from a physical duration, Pᵣₛᵥₚ, in milli-second to logical slots, P′ᵣₛᵥₚ, is given by

$${P}_{rsvp}^{′} = ⌈ \frac{T {′}_{max}}{10240 ms} \times {P}_{rsvp} ⌉$$

(see 3GPP standard specification TS 38.214).

For resource (re-)selection or re-evaluation in slot n, a UE can determine a set of available single-slot resources for transmission within a resource selection window [n+T₁, n+T₂], such that a single-slot resource for transmission, R_{x,y} is defined as a set of L_{subCH} contiguous subchannels x+i, where i=0, 1, . . . , L_{subCH}−1 in slot t_{y}^{SL}. T₁ is determined by the UE such that, 0≤T₁≤T_{proc,1}^{SL}, where T_{proc,1}^{SL} is a PSSCH processing time for example as defined in 3GPP standard specification, 3GPP standard specification TS 38.214. T₂ is determined by the UE such that T₂ₘᵢₙ≤T₂≤Remaining Packet Delay Budget, as long as T₂ₘᵢₙ<Remaining Packet Delay Budget, else T₂ is equal to the Remaining Packet Delay Budget. T₂ₘᵢₙ is configured by higher layers and depends on the priority of the SL transmission.

The resource (re-)selection is a two-step procedure as shown in TABLE 2.

TABLE 2
Resource selection procedures

| | |
|---|---|
| - | The first step (e.g., performed in the physical layer) is to identify the candidate resources |
| | within a resource selection window. Candidate resources are resources that belong to a |
| | resource pool, but exclude resources (e.g., resource exclusion) that were previously reserved, |
| | or potentially reserved by other UEs. The resources excluded are based on SCIs decoded in |
| | a sensing window and for which the UE measures a SL RSRP that exceeds a threshold. The |
| | threshold depends on the priority indicated in a SCI format and on the priority of the SL |
| | transmission. Therefore, sensing within a sensing window involves decoding the first stage |
| | SCI, and measuring the corresponding SL RSRP, wherein the SL RSRP can be based on |
| | PSCCH DMRS or PSSCH DMRS. Sensing is performed over slots where the UE does not |
| | transmit SL. The resources excluded are based on reserved transmissions or semi-persistent |
| | transmissions that can collide with the excluded resources or any of reserved or semi- |
| | persistent transmissions. The identified candidate resources after resource exclusion are |
| | provided to higher layers. |
| - | The second step (e.g., performed in the higher layers) is to select or re-select a resource from |
| | the identified candidate resources for PSSCH/PSCCH transmission. |

During the first step of the resource (re-)selection procedure, a UE can monitor slots in a sensing window [n−T₀, n−T_{proc,0}^{SL}), where the UE monitors slots belonging to a corresponding sidelink resource pool that are not used for the UE's own transmission. For example, T_{proc,0}^{SL} is the sensing processing latency time, for example as defined in 3GPP standard specification TS 38.214. To determine a candidate single-slot resource set to report to higher layers, a UE excludes (e.g., resource exclusion) from the set of available single-slot resources for SL transmission within a resource pool and within a resource selection window, the following, as shown in TABLE 3.

TABLE 3
Resource selection procedures

| 1. | Single slot resource R_{x,y}, such that for any slot t'ₘ^{SL} not monitored within the sensing | |
|---|---|---|
| | window with a hypothetical received SCI Format 1-0, with a “Resource reservation period” | |
| | set to any periodicity value allowed by a higher layer parameter reservationPeriodAllowed, | |
| | and indicating all sub-channels of the resource pool in this slot, satisfies condition 2.2. | |
| | below. | |
| 2. | Single slot resource R_{x,y}, such that for any received SCI within the sensing window: | |
| | 1. | The associated L1-RSRP measurement is above a (pre-)configured SL-RSRP |
| | | threshold, where the SL-RSRP threshold depends on the priority indicated in the |
| | | received SCI and that of the SL transmission for which resources are being selected. |
| | 2. | (Condition 2.2) The received SCI in slot t'ₘ^{SL}, or if “Resource reservation field” is |
| | | present in the received SCI the same SCI is assumed to be received in slot |
| | | t'_{m+q×P}_{ᵣₛᵥₚ}_RX_{'}^{SL}, indicates a set of resource blocks that overlaps R_{x,y+j×P}_{ᵣₛᵥₚ}_TX_{'}. |
| | | Where, |
| | | q = 1,2, . . . , Q, where, |
| | | $If {P}_{rsvp \_ RX} \leq {T}_{scal} and {n}^{′} - m < {P}_{rsvp \_ RX}^{′} \to Q = ⌈ \frac{{T}_{s c a l}}{{P}_{rsvp \_ RX}} ⌉ \cdot {T}_{s c a l}$ |
| | | is T₂ in units of milli-seconds. |
| | | Else Q = 1 |
| | | If n belongs to (t'₀^{SL}, t'₁^{SL}, . . ., t'_{T}_{ₘₐₓ}_{-1'}^{SL}), n' = n, else n' is the first |
| | | slot after slot n belonging to set (t'₀^{SL}, t'₁^{SL}, . . ., t'_{T}_{ₘₐₓ}_{-1'}^{SL}) |
| | | j = 0, 1, ... , Cᵣₑₛₑₗ − 1 |
| | | Pᵣₛᵥₚ_RX is the indicated resource reservation period in the received SCI in |
| | | physical slots, and P'ᵣₛᵥₚ_RX is that value converted to logical slots. |
| | | P'ᵣₛᵥₚ_Tx is the resource reservation period of the SL transmissions for which |
| | | resources are being reserved in logical slots. |

| | |
|---|---|
| 3. | If the candidate resources are less than a (pre-)configured percentage given by higher layer |
| | parameter sl_TxPrecentageList(prio_{TX}) that depends on the priority of the SL transmission |
| | prio_{TX}, such as 20%, of the total available resources within the resource selection window, |
| | the (pre-)configured SL-RSRP thresholds are increased by a predetermined amount, such as |
| | 3 dB. |

A NR sidelink introduced two new procedures for mode 2 resource allocation; re-evaluation and pre-emption.

Re-evaluation check occurs when a UE checks the availability of pre-selected SL resources before the resources are first signaled in an SCI Format, and if needed re-selects new SL resources. For a pre-selected resource to be first-time signaled in slot m, the UE performs a re-evaluation check at least in slot m−T₃.

The re-evaluation check includes: (1) performing the first step of the SL resource selection procedure as defined in the 3GPP specifications TS 38.214, which involves identifying a candidate (available) sidelink resource set in a resource selection window as previously described; (2) if the pre-selected resource is available in the candidate sidelink resource set, the resource is used/signaled for sidelink transmission; and (3) else, the pre-selected resource is not available in the candidate sidelink resource set, a new sidelink resource is re-selected from the candidate sidelink resource set.

A pre-emption check occurs when a UE checks the availability of pre-selected SL resources that have been previously signaled and reserved in an SCI Format, and if needed re-selects new SL resources. For a pre-selected and reserved resource to be signaled in slot m, the UE performs a pre-emption check at least in slot m−T₃.

When pre-emption check is enabled by higher layers, pre-emption check includes: (1) performing the first step of the SL resource selection procedure as defined in the 3GPP specifications TS 38.214, which involves identifying candidate (available) sidelink resource set in a resource selection window as previously described; (2) if the pre-selected and reserved resource is available in the candidate sidelink resource set, the resource is used/signaled for sidelink transmission; (3) else, the pre-selected and reserved resource is NOT available in the candidate sidelink resource set. The resource is excluded from the candidate resource set due to an SCI, associated with a priority value P_{RX}, having an RSRP exceeding a threshold. Let the priority value of the sidelink resource being checked for pre-emption be P_{TX}: (i) if the priority value P_{RX} is less than a higher-layer configured threshold and the priority value P_{RX} is less than the priority value P_{TX}. The pre-selected and reserved sidelink resource is pre-empted. A new sidelink resource is re-selected from the candidate sidelink resource set. Note that, a lower priority value indicates traffic of higher priority; and (ii) else, the resource is used/signaled for sidelink transmission.

In one example, a UE determines a power, P_{S-SSB}(i), in dBm, for an S-SS/PSBCH block (S-SSB) transmission occasion in slot i on an active SL BWP b of a carrier f, as: P_{S-SSB} min(P_{CMAX}, P_{O,S-SSB}+10 log₁₀(2^{μ}·M_{RB}^{S-SSB})+α_{S-SSB}·PL) where followings are determined as shown in TABLE 4.

TABLE 4
Parameters for S-SS/PBCH block power control

| - | P_{CMAX} is the configured maximum output power of the UE [TS 38.101]. | |
|---|---|---|
| - | P_{O,S-SSB} is the P0 value for DL pathloss based power control for PSBCH. If dl-P0-PSBCH- | |
| | r17 is configured and supported by the UE it is used for P_{O,S-SSB}, else if dl-P0-PSBCH-r16 | |
| | is configured it is used for P_{O,S-SSB}, else DL pathloss based power control for PSBCH is | |
| | disabled, i.e., P_{S-SSB} (i) = P_{CMAX}. | |
| | ◯ | dl-P0-PSBCH-r16 has a range of −16 ... 15 |
| | ◯ | dl-P0-PSBCH-r17 has a range of −202 ... 24 |
| - | μ is the sub-carrier spacing configuration as previously described. | |
| - | M_{RB}^{S-SSB} is the number of resource blocks for S-SS/PSBCH block transmission. M_{RB}^{S-SSB} = | |
| | 11. | |
| - | α_{S-SSB} is the alpha value for DL pathloss based power control for PSBCH. This is provided | |
| | by higher layer parameter dl-Alpha-PSBCH-r16, and is 1 if that parameter is not configured. | |
| | dl-Alpha-PSBCH-r16 is a value from the set {0, 0.4, 0.5,0.6,0.7,0.8,0.9,1}. | |
| - | PL is the pathloss, which is given by PL = PL_{b,f,c}(q_{d}) when the active SL BWP is on | |
| | serving cell c. The RS resource q_{d} for determining the pathloss is given by: | |
| | ◯ | When the UE is configured to monitor PDCCH for detection of DCI Format 0_0 in |
| | | serving cell c: RS resource used for determining the power of a PUSCH transmission |
| | | scheduled by DCI Format 0_0 in serving cell c. |
| | ◯ | When the UE is not configured to monitor PDCCH for detection of DCI Format 0_0 |
| | | in serving cell c: RS resource corresponding to SS/PBCH block used by the UE to |
| | | obtain the MIB. |

In one example, a UE determines a power, P_{PSSCH}(i), in dBm, for a PSSCH transmission occasion i of a resource pool, on an active SL BWP b of a carrier f, and in symbols where PSCCH is not transmitted as: P_{PSSCH}(U)=min (P_{CMAX}, P_{MAX,CBR}, min(P_{PSSCH,D}(i), P_{PSSCH,SL}(i))) where followings are determined as shown in TABLE 5.

TABLE 5
Parameters for PSSCH power control

| - | P_{CMAX} is the configured maximum output power of the UE (e.g., 3GPP standard | |
|---|---|---|
| | specification TS 38.101). | |
| - | P_{MAX,CBR} is determined based on the priority level and the CBR range for a CBR measured | |
| | in slot i − N. Where, N is the congestion control processing time (e.g., 3GPP standard | |
| | specification TS 38.214). | |
| - | P_{PSSCH,D}(i) is the component for DL pathloss based power control for PSSCH. Which is | |
| | given by: | |
| | ◯ | If dl-P0-PSSCH-PSCCH is provided: P_{PSSCH,D}(i) = P_{O,D} + 10 log₁₀ (2^{μ} · |
| | | M_{RB}^{PSSCH}(i)) + α_{D} · PL_{D} |
| | ◯ | If dl-P0-PSSCH-PSCCH is not provided: P_{PSSCH,D}(i) = min(P_{CMAX},P_{MAX,CBR}) |
| | ◯ | P_{O,D} is the P0 value for DL pathloss based power control for PSSCH/PSCCH. If dl- |
| | | P0-PSSCH-PSCCH-r17 is configured and supported by the UE it is used for P_{O,D}, |
| | | else if dl-P0-PSSCH-PSCCH-r16 is configured it is used for P_{O,D}, else DL pathloss |
| | | based power control for PSSCH/PSCCH is disabled. |

| | |
|---|---|
| ▪ | dl-P0-PSSCH-PSCCH-r16 has a range of −16 ... 15 |
| ▪ | dl-P0- PSSCH-PSCCH -r17 has a range of −202 ... 24 |

| | |
|---|---|
| ◯ | μ is the sub-carrier spacing configuration as previously described. |
| ◯ | M_{RB}^{PSSCH}(i) is the number of resource blocks for PSSCH transmission occasion i. |
| ◯ | α_{D} is the alpha value for DL pathloss based power control for PSSCH/PSCCH. This |
| | is provided by higher layer parameter dl-Alpha-PSSCH-PSCCH-r16, and is 1 if that |
| | parameter is not configured. dl-Alpha-PSSCH-PSCCH-r16 is a value from the set |
| | {0, 0.4, 0.5,0.6,0.7,0.8,0.9,1}. |
| ◯ | PL_{D} is the DL pathloss, which is given by PL_{D} = PL_{b,f,c}(q_{d}) when the active SL |
| | BWP is on serving cell c. The RS resource q_{d} for determining the pathloss is given |
| | by: |

| | |
|---|---|
| ▪ | When the UE is configured to monitor PDCCH for detection of DCI Format |
| | 0_0 in serving cell c: RS resource used for determining the power of a |
| | PUSCH transmission scheduled by DCI Format 0_0 in serving cell c. |
| ▪ | When the UE is not configured to monitor PDCCH for detection of DCI |
| | Format 0_0 in serving cell c: RS resource corresponding to SS/PBCH block |
| | used by the UE to obtain the MIB. |

| - | P_{PSSCH,SL}(i) is the component for SL pathloss based power control for PSSCH. Which is | |
|---|---|---|
| | given by: | |
| | ◯ | If sl-P0-PSSCH-PSCCH is provided: P_{PSSCH,SL}(i) = P_{O,SL} + 10 log₁₀ (2^{μ} · |
| | | M_{RB}^{PSSCH}(i)) + α_{SL} · PL_{SL} |
| | ◯ | If sl-P0-PSSCH-PSCCH is not provided: P_{PSSCH,SL}(i) = min (P_{CMAX},P_{PSSCH,D}(i)) |
| | ◯ | P_{O,SL} is the P0 value for SL pathloss based power control for PSSCH/PSCCH. If sl- |
| | | P0-PSSCH-PSCCH-r17 is configured and supported by the UE it is used for P_{O,SL}, |
| | | else if sl-P0-PBSCH-r16 is configured it is used for P_{O,SL}, else SL pathloss based |
| | | power control for PSSCH/PSCCH is disabled. |

| | |
|---|---|
| ▪ | sl-P0-PSSCH-PSCCH-r16 has a range of −16 ... 15 |
| ▪ | sl-P0- PSSCH-PSCCH -r17 has a range of −202 ... 24 |

| | |
|---|---|
| ◯ | μ is the sub-carrier spacing configuration as previously described. |
| ◯ | M_{RB}^{PSSCH}(i) is the number of resource blocks for PSSCH transmission occasion i. |
| ◯ | α_{SL} is the alpha value for SL pathloss based power control for PSSCH/PSCCH. This |
| | is provided by higher layer parameter sl-Alpha-PSSCH-PSCCH-r16, and is 1 if that |
| | parameter is not configured. sl-Alpha-PSSCH-PSCCH-r16 is a value from the set |
| | {0, 0.4, 0.5,0.6,0.7,0.8,0.9,1}. |
| ◯ | PL_{SL} is the SL pathloss, which is given by PL_{SL} = referenceSignalPower − |
| | higher layer filtered RSRP: |

| | |
|---|---|
| ▪ | referenceSignalPower is obtained by summing the PSSCH transmit power |
| | per RE over all antenna ports and higher layer filtered across PSSCH |
| | transmission occasions using filter configuration provided by sl- |
| | FilterCoefficient. |
| ▪ | “higher layer filtered RSRP” is the SL RSRP measured by the UE receiving |
| | the PSSCH/PSCCH transmissions and reported to the UE that transmitted |
| | PSSCH/PSCCH. The SL RSRP is measured on PSSCH DMRS and filtered |
| | across PSSCH transmission occasions using filter configuration provided by |
| | sl-FilterCoefficient. |

The UE splits its power equally among antenna ports that have non-zero power.

In one example, in symbols where PSSCH and PSCCH are transmitted, a UE determines a power, P_{PSSCH2}(i), in dBm, for a PSSCH transmission occasion i of a resource pool, on an active SL BWP b of a carrier f, and in symbols where PSSCH and PSCCH are transmitted as:

$${P}_{PSSCH 2} ( i ) = 10 {log}_{10} ( \frac{{M}_{RB}^{PSSCH} ( i ) - {M}_{RB}^{PSCCH} ( i )}{{M}_{RB}^{PSSCH} ( i )} ) + {P}_{PSSCH} ( i )$$

wherein parameters are determined as shown in TABLE 6.

TABLE 6
Parameters for PSSCH/PSCCH power control

| | |
|---|---|
| - | M_{RB}^{PSSCH}(i) is the number of resource blocks for PSSCH transmission occasion i. |
| - | M_{RB}^{PSCCH}(i) is the number of resource blocks for PSCCH transmission occasion i. |
| - | P_{PSSCH}(i) is the PSSCH power in symbols with no PSCCH. |

In one example, a U determines a power, P_{PSCCH}(i), in dBm, for a PSCCH transmission occasion i of a resource pool, on an active SL BWP b of a carrier f, as:

$${P}_{PSCCH} ( i ) = 10 {log}_{10} ( \frac{{M}_{RB}^{PSCCH} ( i )}{{M}_{RB}^{PSSCH} ( i )} ) + {P}_{PSSCH} ( i )$$

where parameters are determined as shown in TABLE 7.

TABLE 7
Parameters for PSSCH/PSCCH power control

| | |
|---|---|
| - | M_{RB}^{PSSCH}(i) is the number of resource blocks for PSSCH transmission occasion i. |
| - | M_{RB}^{PSCCH}(i) is the number of resource blocks for PSCCH transmission occasion i. |
| - | P_{PSSCH}(i) is the PSSCH power in symbols with no PSCCH. |

In one example, a UE has N_{sch,TX,PSFCH} scheduled with PSFCH transmissions for HARQ-ACK information and conflict information. The UE is capable of transmitting a maximum of N_{max,PSFCH}. The UE determines N_{TX,PSFCH} PSFCH to transmit, each with a power P_{PSFCH,k}(i), for 1≤k≤N_{TX,PSFCH}, for a PSFCH transmission occasion i of a resource pool, on an active SL BWP b of a carrier f. A U can be provided with higher layer parameter dl-P0-PSFCH for P0 for DL pathloss based power control for PSFCH. The UE calculates P_{PSFCH,one} in dBm: P_{PSFCH,one}=P_{O,PSFCH}+10 log₁₀(2^{μ})+α_{PSFCH}·PL where parameters are determined as shown in TABLE 8

TABLE 8
Parameters for PSFCH power control

| - | P_{O,PSFCH} is the P0 value for DL pathloss based power control for PSFCH. If dl-P0-PSFCH- | |
|---|---|---|
| | r17 is configured and supported by the UE it is used for P_{O,PSFCH}, else if dl-P0-PSFCH-r16 | |
| | is configured it is used for P_{O,PSFCH}, else DL pathloss based power control for PSFCH is | |
| | disabled, i.e., P_{PSFCH,k}(i) = P_{CMAX} − 10 log₁₀(N_{TX,PSFCH}), where P_{CMAX} is determined for | |
| | N_{TX,PSFCH} transmissions. | |
| | ∘ | dl-P0-PSFCH-r16 has a range of −16 ... 15 |
| | ∘ | dl-P0-PSFCH-r17 has a range of −202 ... 24 |
| - | μ is the sub-carrier spacing configuration as previously described. | |
| - | α_{PSFCH} is the alpha value for DL pathloss based power control for PSFCH. This is provided | |
| | by higher layer parameter dl-Alpha-PSFCH-r16, and is 1 if that parameter is not configured. | |
| | dl-Alpha-PSFCH-r16 is a value from the set {0, 0.4, 0.5,0.6,0.7,0.8,0.9,1}. | |
| - | PL is the pathloss, which is given by PL = PL_{b,f,c}(q_{d}) when the active SL BWP is on | |
| | serving cell c. The RS resource q_{d} for determining the pathloss is given by: | |
| | ∘ | When the UE is configured to monitor PDCCH for detection of DCI Format 0_0 in |
| | | serving cell c: RS resource used for determining the power of a PUSCH transmission |
| | | scheduled by DCI Format 0_0 in serving cell c. |
| | ∘ | When the UE is not configured to monitor PDCCH for detection of DCI Format 0_0 |
| | | in serving cell c: RS resource corresponding to SS/PBCH block used by the UE to |
| | | obtain the MIB. |

If the number of scheduled PSFCH transmissions (i.e., N_{sch,TX,PSFCH}) is less than or equal to the number of maximum number of PSFCH transmission the UE is capable to transmit (i.e., N_{max,PSFCH}):N_{sch,TX,PSFCH}≤N_{max,PSFCH}, and: (1) if the power to transmit the N_{sch,TX,PSFCH} scheduled PSFCH transmissions does not exceed the maximum configured output power P_{CMAX} determined for N_{sch,TX,PSFCH} PSFCH transmissions, i.e., P_{PSFCH,one}+10 log₁₀(N_{sch,TX,PSFCH}) P_{CMAX}, therefore: N_{TX,PSFCH}=N_{sch,TX,PSFCH} and P_{PSFCH,k}(i)=P_{PSFCH,one}; and (2) if the power to transmit the N_{sch,TX,PSFCH} scheduled PSFCH transmissions exceeds the maximum configured output power P_{CMAX}, i.e., P_{PSFCH,one}+10 log₁₀(N_{sch,TX,PSFCH})>P_{CMAX}, the UE determines N_{TX,PSFCH} PSFCH transmissions, first with ascending order of priority field for PSFCH transmissions that carry HARQ-ACK information, then with ascending order of priority field for PSFCH transmissions that carry conflict information, such that N_{TX,PSFCH} max(1, Σᵢ₌₁^{K}Mᵢ). Where, for 1≤i≤8, Mᵢ is the number of PSFCH transmissions carrying HARQ-ACK information with priority level i, and for i>8, Mᵢ is the number of PSFCH transmissions carrying conflict information with priority level i−8. K is the largest value satisfying P_{PSFCH,one}+10 log₁₀(max(1, Σᵢ₌₁^{K}Mᵢ))≤P_{CMAX}, if any, otherwise K=0. The PSFCH power is given by: P_{PSFCH,k}(i)=min(P_{CMAX}−10 log₁₀(N_{TX,PSFCH}), P_{PSFCH,one}), where P_{CMAX} is determined for N_{TX,PSFCH} transmissions.

If the number of scheduled PSFCH transmissions (i.e., N_{sch,TX,PSFCH}) exceeds the number of maximum number of PSFCH transmission the UE is capable to transmit (i.e., N_{max,PSFCH}) N_{sch,TX,PSFCH}>N_{max,PSFCH}, the UE selects N_{max,PSFCH} PSFCH transmission based on the priority of the PSFCH transmissions as described later: (1) if the power to transmit the N_{max,PSFCH} PSFCH transmissions does not exceed the maximum configured output power P_{CMAX} determined for N_{max,PSFCH} PSFCH transmissions, i.e., P_{PSFCH,one}+10 log₁₀(N_{max,PSFCH}) P_{CMAX}, therefore: N_{TX,PSFCH}=N_{max,PSFCH} and P_{PSFCH,k}(i)=P_{PSFCH,one}; and (2) if the power to transmit the N_{max,PSFCH} PSFCH transmissions exceeds the maximum configured output power P_{CMAX}, i.e., P_{PSFCH,one}+10 log₁₀(N_{max,PSFCH})>P_{CMAX}, the UE determines N_{TX,PSFCH} PSFCH transmissions, first with ascending order of priority field for PSFCH transmissions that carry HARQ-ACK information, then with ascending order of priority field for PSFCH transmissions that carry conflict information, such that N_{TX,PSFCH}≥max(1, Σᵢ₌₁^{K}Mᵢ). Where, for 1≤i≤8, Mᵢ is the number of PSFCH transmissions carrying HARQ-ACK information with priority level i, and for i>8, Mᵢ is the number of PSFCH transmissions carrying conflict information with priority level i−8. K is the largest value satisfying P_{PSFCH,one}+10 log₁₀(max(1, Σᵢ₌₁^{K}Mᵢ))≤P_{CMAX}, if any, otherwise K=0. The PSFCH power is given by: P_{PSFCH,k}(i) min(P_{CMAX}−10 log₁₀(N_{TX,PSFCH}) P_{PSFCH,one}), where P_{CMAX} is determined for N_{TX,PSFCH} transmissions.

The priority of PSFCH transmissions and receptions are determined as follows: (1) for a PSFCH transmission or reception with HARQ-ACK information, a priority value for the PSFCH is equal to the priority value indicated by SCI format 1-A associated with the PSFCH; (2) for a PSFCH transmission with conflict information, a priority value for the PSFCH is equal to the smallest priority value determined by the corresponding SCI format(s) 1-A for the conflicting resource(s); and (3) for a PSFCH reception with conflict information, a priority value for the PSFCH is equal to the priority value determined by corresponding SCI format 1-A for the conflicting resource.

In one example, for PSFCH transmissions in a slot, the PSFCH transmissions have a priority value equal to the smallest priority value of PSFCH transmissions with HARQ-ACK information and PSFCH transmissions with conflict information in the slot.

In one example, for PSFCH receptions in a slot, the PSFCH receptions have a priority value equal to the smallest priority value of PSFCH receptions with HARQ-ACK information and PSFCH receptions with conflict information in the slot.

In one example, if (1) a UE may transmit a first channel or signal using the E-UTRA radio access, and transmit second channels and/or signals using NR radio access, (2) a transmission of the first channel or signal overlaps in time with a transmission of the second channels and/or signals, and (3) the priories of the channels and signals are known to the UE at least T msec before the earliest transmission, where T≤4 up to the UEs implementation; the UE transmits the channels or signals of the radio access technology with the highest priority. The priority is determined based on (1) the SCI formats scheduling the transmissions, (2) as indicated by higher layers for S-SSB (provided by higher layer parameter sl-SSB-Priority NR) and E-UTRA SL synchronization signal, (3) for PSFCH as described earlier.

In one example, if (1) a UE may transmit or receive a first channel or signal using the E-UTRA radio access, and receive a second channel or signal or transmit second channels and/or signals using NR radio access, (2) a transmission or reception of the first channel or signal overlaps in time with a reception of the second channel or signal or a transmission of the second channels and/or signals, and (3) the priories of the channels and signals are known to the UE at least T msec before the earliest transmission, where T≤4 Up to the UEs implementation; the UE transmits or receives the channels or signals of the radio access technology with the highest priority. The priority is determined based on (1) the SCI formats scheduling the transmissions, (2) as indicated by higher layers for S-SSB (provided by higher layer parameter sl-SSB-Priority NR) and E-UTRA SL synchronization signal, (3) for PSFCH as described earlier.

In one example, if (1) a UE may transmit N_{sch,TX,PSFCH} PSFCHs and receive N_{sch,RX,PSFCH} PSFCHs, and (2) the transmissions of the N_{sch,TX,PSFCH} PSFCHs overlap in time with the receptions of the N_{sch,RX,PSFCH} PSFCHs, the UE transmits or receives only a set of PSFCHs corresponding to the smallest priority field value (highest priority) as follows: (1) first determined by PSFCHs with HARQ-ACK information; and (2) if no PSFCHs have HARQ-ACK information, then determined by PSFCHs with conflict information.

In one example, if a UE may transmit N_{sch,TX,PSFCH} PSFCHs in a PSFCH transmission occasion and the UE transmits N_{TX,PSFCH} PSFCHs in the transmission occasion: (1) the UE first transmits PSFCHs with HARQ-ACK information from N_{TX,PSFCH} PSFCHs with the smallest priority field values (highest priority); and (2) subsequently the UE transmits the remaining PSFCHs with conflict information from N_{TX,PSFCH} PSFCHs with the smallest priority field values (highest priority).

In one example, if a UE indicates a capability to receive N_{RX,PSFCH} PSFCHs in a PSFCH reception occasion: (1) the UE first receives PSFCHs with HARQ-ACK information in ascending order of priority value (descending order of priority); and (2) subsequently the UE receive PSFCHs with conflict information in ascending order of priority value (descending order of priority).

In one example, if (1) a UE may simultaneously transmit on UL and on SL in a carrier or in two respective carriers, and (2) the UE is not capable of simultaneous transmissions on UL and on SL in a carrier or in two respective carriers; the UE only transmits on the link (UL or SL) with the higher priority.

In one example, if (1) a UE may simultaneously transmit on UL and receive on SL in a carrier, or (2) the UE may simultaneously transmit on UL and receive on SL in two respective carriers and the UE is not capable of simultaneous transmissions on UL and reception on SL in two respective carriers; the UE only transmits on UL or receives on SL with the higher priority.

In one example, if (1) a UE is capable of simultaneous transmission on UL and SL in two respective carriers, (2) may transmit on UL and on SL in two respective carriers, (3) the transmissions on UL and SL may over in a time period, and (4) the total UE transmit power exceeds Pc MAX over the time period: (1) if the SL transmission has a higher priority than the UL transmission: the UE reduces the power of the UL transmission power prior to the start of the UL transmission such that the total UE transmission power over the time period does not exceed P_{CMAX}; and (2) if the UL transmission has a higher priority than the SL transmission: the UE reduces the power of the SL transmission power prior to the start of the SL transmission such that the total UE transmission power over the time period does not exceed P_{CMAX}.

One type of UL transmission can include, denote this as UL transmission TypeX: (1) a PRACH transmission; (2) a PUSCH scheduled by an UL grant in a RAR or its retransmission; (3) a PUSCH for Type-2 random access procedure and its retransmission; (4) a PUCCH with HARQ-ACK information in response to a success RAR; and (5) a PUCCH indicated by a DCI format 1_0 with CRC scrambled by a TC-RNTI.

In one example, if an UL transmission of TypeX, as previously described, overlaps with a SL transmission, the UL transmission has a higher priority.

In one example, if an UL transmission other than that of TypeX, as previously described, overlaps with a SL transmission, the priority of UL and SL transmissions are determined as follows in TABLE 9.

TABLE 9
Determination of priority of UL and SL transmissions

| - | If the UL transmission is a PUSCH or a PUCCH with priority index 1: | |
|---|---|---|
| | ◯ | If the priority value of the SL transmission or reception is smaller than sl- |
| | | PriorityThreshold-UL-URLLC, the SL transmission has a higher priority, |
| | ◯ | If the priority value of the SL transmission or reception is not smaller than sl- |
| | | PriorityThreshold-UL-URLLC, the UL transmission has a higher priority, |
| | ◯ | If higher layer parameter is not provided (configured), the UL transmission has a |
| | | higher priority, |
| - | Otherwise (UL transmission does not have priority index 1: | |
| | ◯ | If the priority value of the SL transmission or reception is smaller than sl- |
| | | PriorityThreshold, the SL transmission has a higher priority, |
| | ◯ | If the priority value of the SL transmission or reception is not smaller than sl- |
| | | PriorityThreshold, the UL transmission has a higher priority. |

In one example, a PUCCH transmission with SL HARQ-ACK information has a higher priority than a SL transmission, if the priority value of the PUCCH is smaller than the priority value of the SL transmission. A SL transmission has a higher priority than a PUCCH transmission with SL HARQ-ACK information, if the priority value of the PUCCH is larger than the priority value of the SL transmission.

In one example, a PUCCH transmission with SL HARQ-ACK information has a higher priority than a PSFCH/S-SSB reception, if the priority value of the PUCCH is smaller than the priority value of the PSFCH/S-SSB reception. A PSFCH/S-SSB reception has a higher priority than a PUCCH transmission with SL HARQ-ACK information, if the priority value of the PUCCH is larger than the priority value of the PSFCH/S-SSB reception.

In one example, if one or more SL transmissions from a UE overlap with multiple non-overlapping UL transmissions from the UE, the UE performs SL transmission if at least one SL transmission is prioritized over all UL transmissions from the UE subject to the UE processing timeline with respect to the first SL transmission and the first UL transmission.

In one example, if one or more UL transmissions from a UE overlap with multiple non-overlapping SL transmissions from the UE, the UE performs UL transmission if at least one UL transmission is prioritized over all SL transmissions from the UE subject to the UE processing timeline with respect to the first SL transmission and the first UL transmission.

In one example, if one SL transmission from a UE overlap with one or more overlapping UL transmissions from the UE, the UE performs SL transmission if the SL transmission is prioritized over all UL transmissions from the UE subject to the UE multiplexing and processing timelines with respect to the first SL transmission and the first UL transmission.

In one example, if one SL transmission from a UE overlap with one or more overlapping UL transmissions from the UE, the UE performs UL transmission if at least one UL transmission from the UE is prioritized over the SL transmission subject to the UE multiplexing and processing timelines with respect to the first SL transmission and the first UL transmission.

As mentioned in the present disclosure, the monitoring procedure for resource (re)selection during the sensing window requires sensing which includes reception and decoding of a SCI format during the sensing window as well as measuring the SL RSRP. This reception and decoding process and measuring the SL RSRP increases a processing complexity and power consumption of a UE for sidelink communication and requires the UE to have receive circuitry on the SL for sensing even if the UE only transmits and does not receive on the sidelink. The aforementioned sensing procedure is referred to as full sensing.

Rel-17 introduced low-power resource allocation. Low-power resource allocation schemes include partial sensing and random resource selection. If a SL transmission from a UE is periodic, partial sensing can be based on periodic-based partial sensing (PBPS), and/or contiguous partial sensing (CPS). If a SL transmission from a UE is aperiodic, partial sensing can be based on CPS and PBPS if the resource pool supports periodic reservations (i.e., sl_multiReserveResource is enabled). When a UE performs PBPS, the UE selects a set of Y slots (Y≥Yₘᵢₙ) within a resource selection window corresponding to PBPS, where Yₘᵢₙ is provided by higher layer parameter minNumCandidateSlotsPeriodic. The UE monitors slots at t′_{y-k×P}_{ᵣₑₛₑᵣᵥₑ}^{SL}, where t′_{y}^{SL} is a slot of the Y selected candidate slots.

The periodicity value for sensing for PBPS, i.e., Pᵣₑₛₑᵣᵥₑ is a subset of the resource reservation periods allowed in a resource pool provided by higher layer parameter sl-ResourceReservePeriodList. Pᵣₑₛₑᵣᵥₑ is provided by higher layer parameter periodicSensingOccasionReservePeriodList, if not configured, Pᵣₑₛₑᵣᵥₑ includes all periodicities in sl-ResourceReservePeriodList. The UE monitors k sensing occasions determined by additionalPeriodicSensingOccasion, as previously described, and not earlier than n−T₀. For a given periodicity Pᵣₑₛₑᵣᵥₑ, the values of k correspond to the most recent sensing occasion earlier than t′−(T_{proc,0}^{SL}+T_{proc,1}^{SL}) if additionalPeriodicSensingOccasion is not (pre-)configured, and additionally includes the value of k corresponding to the last periodic sensing occasion prior to the most recent one if additionalPeriodicSensingOccasion is (pre-)configured. t′_{y0}^{SL} is the first slot of the selected Y candidate slots of PBPS. When a UE performs CPS, the UE selects a set of Y′ slots (Y′≥Y′ₘᵢₙ) within a resource selection window corresponding to CPS, where Y′ₘᵢₙ is provided by higher layer parameter minNumCandidateSlotsAperiodic. The sensing window for CPS starts at least M logical slots before t′_{y0}^{SL} (the first of the Y′ candidate slots) and ends at t′_{y0}^{SL}−(T_{proc,0}^{SL}+T_{proc,1}^{SL}).

Rel-17 introduced inter-UE co-ordination (IUC) to enhance the reliability and reduce the latency for resource allocation, where SL UEs exchange information with one another over sidelink to aid the resource allocation mode 2 (re-)selection procedure. A UE-A provides information to a UE-B, and a UE-B uses the provided information for its resource allocation mode 2 (re-)selection procedure. IUC is designed to address issues with distributed resource allocation such as: (1) Hidden node problem, where a UE-B is transmitting to a UE-A and a UE-B cannot sense or detect transmissions from a UE-C that interfere with its transmission to a UE-A, (2) Exposed node problem, where a UE-B is transmitting to a UE-A, and a UE-B senses or detects transmissions from a UE-C and avoids the resources used or reserved by a UE-C, but a UE-C does not cause interference at a UE-A, (3) Persistent collision problem, and (4) Half-duplex problem, where a UE-B is transmitting to a UE-A in the same slot that a UE-A is transmitting in. The UE-A may miss the transmission from a UE-B as the UE-A cannot receive and transmit in the same slot.

There are two schemes for inter-UE co-ordination, as described herein.

In one example, in scheme 1, a UE-A can provide to another UE-B indications of resources that are preferred to be included in a UE-B's (re-)selected resources or non-preferred resources to be excluded for a UE-B's (re-) selected resources. When given preferred resources, a UE-B may use only those resources for its resource (re-)selection, or the UE-B may combine them with resources identified by its own sensing procedure, by finding the intersection of the two sets of resources, for its resource (re-)selection. When given non-preferred resources, a UE-B may exclude these resources from resources identified by its own sensing procedure for its resource (re-)selection. Transmissions of co-ordination information (e.g., IUC messages) sent by a UE-A to a UE-B, and co-ordination information requests for (e.g., IUC requests) sent by a UE-B to a UE-A, are sent in a MAC-CE message and may also, if the supported by the UE, be sent in a 2^{nd}-stage SCI Format (SCI Format 2-C).

The benefit of using the 2nd stage SCI is to reduce latency. IUC messages from a UE-A to a UE-B can be sent standalone or can be combined with other SL data. Coordination information (IUC messages) can be in response to a request from a UE-B, or due to a condition at a UE-A. An IUC request is unicast from a UE-B to a UE-A, in response a UE-A sends an IUC message in unicast mode to a UE-B. An IUC message transmitted as a result of an internal condition at a UE-A can be unicast to a UE-B, when the message includes preferred resources, or can be unicast, groupcast or broadcast to a UE-B when the message includes non-preferred resources. A UE-A can determine preferred or non-preferred resources for a UE-B based on its own sensing taking into account the SL-RSRP measurement of the sensed data and the priority of the sensed data, i.e., the priority field of the decoded PSCCH during sensing as well as the priority the traffic transmitted by a UE-B in case of request-based IUC or a configured priority in case of condition-based IUC. Non-preferred resource to a UE-B can also be determined to avoid the half-duplex problem, where a UE-A cannot receive data from a UE-B in the same slot a UE-A is transmitting.

In another example, in scheme 2, a UE-A can provide to another UE-B an indication that resources reserved for a UE-B's transmission, whether or not a UE-A is the destination UE, are subject to conflict with a transmission from another UE. A UE-A determines the conflicting resources based on the priority and RSRP of the transmissions involved in the conflict. A UE-A can also determine a presence of a conflict due to the half-duplex problem, where a UE-A cannot receive a reserved resource from a UE-B at the same time a UE-A is transmitting. When a UE-B receives a conflict indication for a reserved resource, the UE-B can re-select new resources to replace them. The conflict information from a UE-A is sent in a PSFCH channel separately (pre-)configured from the PSFCH of SL-HARQ operation. The timing of the PSFCH channel carrying conflict information can be based on the SCI indicating reserved resource, or based on the reserved resource.

In both schemes, a UE-A can identify resources according to a number of conditions which are based on the SL-RSRP of the resources in question as a function of the traffic priority, and/or whether a UE-A may be unable to receive a transmission from a UE-B, due to performing its own transmission, i.e., a half-duplex problem. The purpose of this exchange of information is to give a UE-B information about resource occupancy acquired by a UE-A which UE-B may not be able to determine on its own due to hidden nodes, exposed nodes, persistent collisions, etc.

3GPP Release 16 is the first NR release to include sidelink through work item “5G V2X with NR sidelink,” the mechanisms introduced focused mainly on vehicle-to-everything (V2X) and can be used for public safety when the service requirement can be met. Release 17 extends sidelink support to more use cases through work item “NR Sidelink enhancement” (RP-201385). The objectives of Rel-17 SL include: (1) resource allocation enhancements that reduce power consumption. (2) enhanced reliability and reduced latency.

Release 18 considers further evolution of the NR SL air interface for operation in unlicensed bands, beam-based operation in FR2, SL carrier aggregation and co-channel co-existence between LTE SL and NR SL.

On the Uu interface a beam is determined by either of: (1) a TCI state, that establishes a quasi-colocation (QCL) relationship between a source reference signal (e.g., SSB and/or CSI-RS) and a target reference signal; or (2) a spatial relation information that establishes an association to a source reference signal, such as SSB or CSI-RS or SRS.

In either case, the ID of the source reference signal identifies the beam.

Terminology such as TCI, TCI states, SpatialRelationInfo, target RS, reference RS, and other terms is used for illustrative purposes and is therefore not normative. Other terms that refer to same functions can also be used.

Rel-17 introduced the unified TCI framework, where a unified or master or main or indicated TCI state is signaled or indicated to the UE. The unified or master or main or indicated TCI state can be one of: (1) in case of joint TCI state indication, wherein a same beam is used for DL and UL channels, a joint TCI state that can be used at least for UE-dedicated DL channels and UE-dedicated UL channels; (2) in case of separate TCI state indication, wherein different beams are used for DL and UL channels, a DL TCI state that can be used at least for UE-dedicated DL channels; and (3) in case of separate TCI state indication, wherein different beams are used for DL and UL channels, a UL TCI state that can be used at least for UE-dedicated UL channels.

The unified (master or main or indicated) TCI state is a DL or a Joint TCI state of UE-dedicated reception on PDSCH/PDCCH and the CSI-RS applying the indicated TCI state and/or an UL or a Joint TCI state for dynamic-grant/configured-grant based PUSCH, PUCCH, and SRS applying the indicated TCI state.

The unified TCI framework applies to intra-cell beam management, wherein, the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB of cell that has a physical cell identity (PCI) different from the PCI of the serving cell (e.g., the TCI state is associated with a TRP of a cell having a PCI different from the PCI of the serving cell). In Rel-17, UE-dedicated channels can be received and/or transmitted using a TCI state associated with a cell having a PCI different from the PCI of the serving cell. While the common channels can be received and/or transmitted using a TCI state associated with the serving cell (e.g., not associated with a cell having a PCI different from the PCI of the serving cell).

Common channels can include: (1) channels carrying system information (e.g., SIB) with a DL assignment carried by a DCI in PDCCH having a CRC scrambled by SI-RNTI and transmitted in Type0-PDCCH CSS set; (2) channels carrying other system information with a DL assignment carried by a DCI in PDCCH having a CRC scrambled by SI-RNTI and transmitted in Type0A-PDCCH CSS set; (3) channels carrying paging or short messages with a DL assignment carried by a DCI in PDCCH having a CRC scrambled by P-RNTI and transmitted in Type2-PDCCH CSS set; and (4) channels carrying RACH related channels with a DL assignment or UL grant carried by a DCI in PDCCH having a CRC scrambled by RA-RNTI or TC-RNTI and transmitted in Type1-PDCCH CSS set.

A DL-related DCI Format (e.g., DCI Format 1_1 or DCI Format 1_2), with or without DL assignment, can indicate to a UE through a field “transmission configuration indication” a TCI state code point, wherein, the TCI state codepoint can be one of (1) a DL TCI state; (2) an UL TCI state; (3) a joint TCI state; or (4) a pair of DL TCI state and UL TCI state. TCI state code points are activated by MAC CE signaling.

Quasi-co-location (QCL) relation, can be quasi-location with respect to one or more of the following relations (e.g., 3GPP standard specification TS 38.214): (1) Type A, {Doppler shift, Doppler spread, average delay, delay spread}; (2) Type B, {Doppler shift, Doppler spread}; (3) Type C, {Doppler shift, average delay}; and (4) Type D, {Spatial Rx parameter}.

In addition, quasi-co-location relation can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main or indicated) TCI can also apply to other DL and/or UL channels and/or signals e.g., non-UE dedicated channel and sounding reference signal (SRS).

A “reference RS” corresponds to a set of characteristics of a DL beam or an UL TX beam, such as a direction, a precoding/beamforming, a number of ports, and so on.

On a Uu interface, a TCI state can be used for a beam indication. It can refer to a DL TCI state for downlink channels (e.g., PDCCH and PDSCH), an uplink TCI state for uplink channels (e.g., PUSCH or PUCCH), a joint TCI state for downlink and uplink channels, or separate TCI states for uplink and downlink channels. A TCI state can be common across multiple component carriers or can be a separate TCI state for a component carrier or a set of component carriers. A TCI state can be a gNB or UE panel specific or common across panels. In some examples, the uplink TCI state can be replaced by SRS resource indicator (SRI).

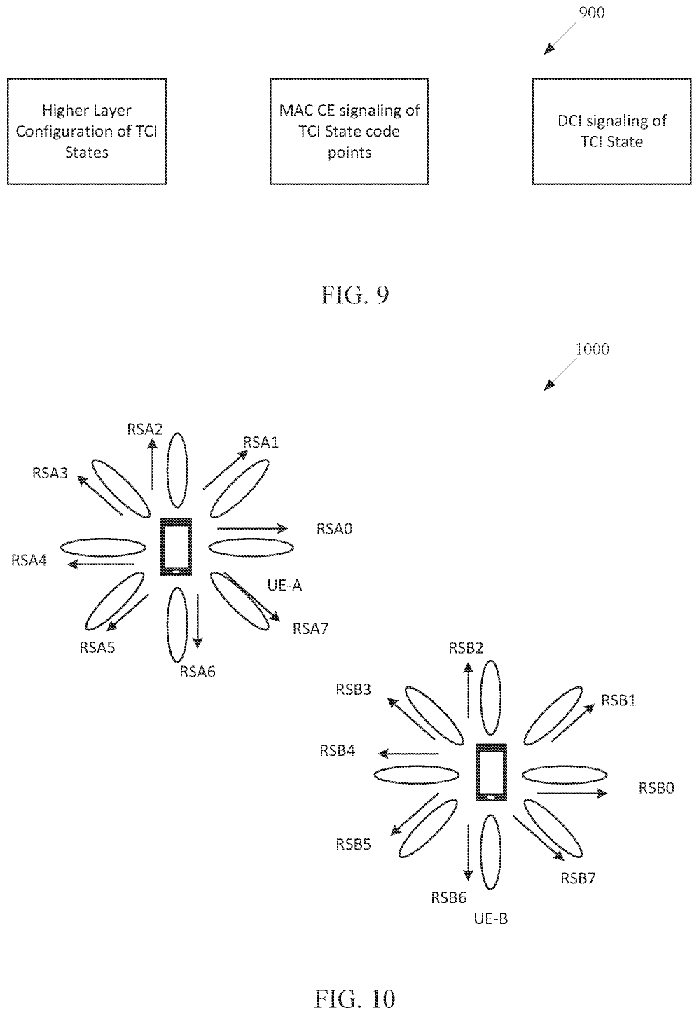

FIG. 9 illustrates examples of MAC CE signaling 900 according to embodiments of the present disclosure. An embodiment of the MAC CE signaling 900 shown in FIG. 9 is for illustration only.

A UE can be configured/updated through higher layer RRC signaling (as illustrated in FIG. 9) a set of TCI States with N elements. In one example, DL and joint TCI states are configured by higher layer parameter DLorJoint-TCIState, wherein, the number of DL and Joint TCI state is N_{DJ}. UL TCI state are configured by higher layer parameter UL-TCIState, wherein the number of UL TCI state is N_{U}·N=N_{DJ}+N_{U}. The DLorJoint-TCIState can include DL or Joint TCI states that belong to a serving cell, e.g., the source RS of the TCI state is associated with the serving cell (the PCI of the serving cell), additionally, the DL or Joint TCI states can be associated with a cell having a PCI different from the PCI of the serving cell, e.g., the source RS of the TCI state is associated with a cell having a PCI different from the PCI of the serving cell. The UL-TCIState can include UL TCI states that belong to a serving cell, e.g., the source RS of the TCI state is associated with the serving cell (the PCI of the serving cell), additionally, the UL TCI states can be associated with a cell having a PCI different from the PCI of the serving cell, e.g., the source RS of the TCI state is associated with a cell having a PCI different from the PCI of the serving cell.

A MAC CE signaling (as illustrated in FIG. 9) includes activating a subset of M (M≤N) TCI states or TCI state code points from the set of N TCI states, wherein a code point is signaled in the “transmission configuration indication” field a DCI used for indication of the TCI state. A codepoint can include one TCI state (e.g., DL TCI state or UL TCI state or Joint (DL and UL) TCI state). Alternatively, a codepoint can include two TCI states (e.g., a DL TCI state and an UL TCI state). L1 control signaling (i.e., Downlink Control Information (DCI)) updates the UE's TCI state, wherein the DCI includes a “transmission configuration indication” (a beam indication) field e.g., with m bits (such that M≤2^{m}), the TCI state corresponds to a code point signaled by MAC CE. A DCI used for indication of the TCI state can be DL related DCI Format (e.g., DCI Format 1_1 or DCI Format 1_2), with a DL assignment or without a DL assignment.

The present disclosure considers a beam indication for SL in FR2 for a link between two SL UEs. A first SL UE can transmit a set of reference signals, wherein a reference signal is associated with a transmit beam or a spatial domain transmission filter from the first SL UE. A second UE can transmit a set of reference signals, wherein a reference signal is associated with a transmit beam or a spatial domain transmission filter from the second SL UE. The first UE can signal a beam ID for a SL transmission between the first UE and the second UE. The beam ID can be based on a reference signal transmitted by the first SL UE and/or a reference signal transmitted by the second SL UE. In the present disclosure, signaling aspects of a beam indication for a SL PC5 interface are provided.

3GPP Release 16 is the first NR release to include sidelink through work item “5G V2X with NR sidelink,” the mechanisms introduced focused mainly on vehicle-to-everything (V2X), and can be used for public safety when the service requirement can be met. Release 17 extends sidelink support to more use cases through work item “NR Sidelink enhancement.” Release 18 considers further evolution of the NR SL air interface for operation in unlicensed bands, beam-based operation in FR2, SL carrier aggregation and co-channel co-existence between LTE SL and NR SL.

One of the key features of NR is its ability to support beam-based operation. This is especially important for operation in FR2 which suffers a higher propagation loss. In Rel-16 and Rel-17 the main focus of developing SL was FR1. Indeed, the frequency bands supported for SL in Rel-16 and Rel-17 are all sub-6 GHz frequencies (bands n14, n38, n47, and n79). One of the objectives of Rel-18 is to expand SL to FR2, while SL supports SL phase tracking reference signal (PTRS), an important feature to support operation in FR2, i.e., beam management, is missing.

In the present disclosure, aspects related to beam management in a beam-based SL (e.g., PC5) interface in FR2 are provided. Beam indication is an essential component of beam management. In one example a first SL UE with a SL transmission indicates to a second SL UE, receiving the SL transmission, the beam (e.g., beam ID or spatial domain transmit filter ID) on which the first SL UE transmits the SL transmission and/or the second UE receives the SL transmission. In another example, a first SL UE receiving a SL transmission from a second SL UE indicates to the second SL UE the beam (e.g., beam ID or spatial domain transmit filter ID) on which the second SL UE transmits the SL transmission and/or the first UE transmits the SL transmission. The beam indication can be based on reference signal wherein the reference signal is associated with a beam (e.g., spatial domain filter) for a SL UE.

Alternatively, the beam indication can be based on a spatial relation information, or a transmission configuration indicator (TCI) state associated with a reference signal wherein the reference signal is associated with a beam (e.g., spatial domain filter) for a SL UE.

The present disclosure relates to a 5G/NR communication system.

The present disclosure considers aspects related to SL beam indication for beam management on a SL interface: (1) association of beams with reference signals; (2) an indication of beam IDs by indicating a reference signal ID; and (3) configuration and activation of spatial relation information for SL or transmission configuration indicator (TCI) state for SL and indication of a beam ID by indicating a spatial relation ID or a TCI state ID associated with the beam.

In SL, “reference RS” can correspond to a set of characteristics for SL beam, such as a direction, a precoding/beamforming, a number of ports, and so on. This can correspond to a SL receive beam or to a SL transmit beam. At least two UEs are involved in a SL communication. In the present disclosure, a first UE is referred as a UE-A and a second UE is referred as a UE-B. In one example, a UE-A is transmitting SL data on PSSCH/PSCCH, and a UE-B is receiving the SL data on PSSCH/PSCCH, however the roles of UE-A and UE-B can be reversed such that UE-B is transmitting SL data and UE-A is receiving SL data, and other SL channels or signals can be transmitted or received.

For mmWave bands (or FR2) or for higher frequency bands (such as >52.6 GHz) where multi-beam operation is especially relevant, a transmission-reception process includes beam-based operation and beam management. Wherein, a first SL UE, e.g., a UE-A, is communicating with a second SL UE, e.g., a UE-B. A UE-A uses a transmit beam (e.g., spatial domain transmission filter) to transmit a SL transmission to a UE-B, and a UE-B uses a receive beam (e.g., spatial domain reception filter) to receive a SL transmission from a UE-A. A UE-B uses a transmit beam (e.g., spatial domain transmission filter) to transmit a SL transmission to a UE-A, and a UE-A uses a receive beam (e.g., spatial domain reception filter) to receive the SL transmission from a UE-B. During the initiation of a communication session between a UE-A and a UE-B a beam pair is determined for communication from a UE-A to a UE-B, i.e., a transmit beam from a UE-A is paired with a receive beam from a UE-B. A beam pair is also determined for communication from a UE-B to a UE-A, i.e., a transmit beam from a UE-B is paired with a receive beam from a UE-A.

During a communication session between a UE-A and a UE-B, the beam pairs are updated as the UEs move around, or the radio environment changes, and new beams are used for communication between a UE-A and a UE-B. This may require a UE-A to indicate to a UE-B or vice versa, a new beam, or it may require a gNB (network) to indicate a new beam, or it may require a third SL UE (e.g., other than a UE-A and a UE-B) to indicate a new beam. The new beam can be indicated from the UE transmitting the SL transmission or from the UE receiving the SL transmission or from the gNB or from a third UE.

FIG. 10 illustrates an example of UE reference signal configuration 1000 according to embodiments of the present disclosure. An embodiment of the UE reference signal configuration 1000 shown in FIG. 10 is for illustration only.

In one example, a UE-A can be configured with a group or a set or a list of reference signals, wherein a reference signal is transmitted on a beam (e.g., spatial domain transmission filter), illustrated in FIG. 10. For example, reference signal RSA0 is transmitted on beam0 of a UE-A, reference signal RSA1 is transmitted on beam1 of a UE-A, and so on. As described in U.S. patent application Ser. No. 18/340,688 filed Jun. 23, 2023, which is incorporated by reference in its entirety, based on measurement reports reported from a UE-B, a UE-A can determine or select a beam to use for a SL transmission to a UE-B. A UE-A can indicate the selected beam to a UE-B.

In one example, a UE-B can be configured with a group or a set or a list of reference signals, wherein a reference signal is transmitted on a beam (e.g., spatial domain transmission filter), illustrated in FIG. 10. For example, reference signal RSB0 is transmitted on beam0 of a UE-B, reference signal RSB1 is transmitted on beam1 of a UE-B, and so on . . . . Based on the measurements performed by a UE-A (as disclosed in U.S. patent application Ser. No. 18/340,688), a UE-A can determine or select a preferred beam to use for a SL transmission from a UE-B. A UE-A can indicate the selected beam to a UE-B.

In one example, a UE is preconfigured or configured by network (e.g., gNB) RRC configuration or configured by PC5 RRC configuration, with a set or list or group of reference signals to be transmitted from a first SL UE (e.g., a UE-A).

In one example, the preconfigured or configured reference signals are periodic reference signals. In one example, network (or gNB) configures the reference signals. In one example, a UE-A configures the reference signals. In one example, a second SL UE (e.g., a UE-B) configures the reference signals. In one example, a SL UE, other than the SL UE transmitting or the SL UE receiving configures the reference signals.

In one example, the preconfigured or configured reference signals are semi-persistent reference signals. The reference signals can be activated for transmission, from a UE-A, by network (e.g., gNB) MAC CE signaling or L1 control signaling or by PC5 MAC CE signaling or SL L1 control signaling. In one example, network (or gNB) activates the semi-persistent reference signals. In one example, a UE-A activates the semi-persistent reference signals. In one example, a second SL UE (e.g., a UE-B) activates the semi-persistent reference signals. In one example, a SL UE, other than the SL UE transmitting or the SL UE receiving activates the semi-persistent reference signals. In one example, all semi-persistent reference signals are activated for transmission from a UE-A. In one example, a subset of semi-persistent reference signals is activated for transmission from a UE-A. In one example, one semi-persistent reference signal is activated for transmission from a UE-A.

In one example, the preconfigured or configured reference signals are aperiodic reference signals. The reference signals can be triggered for transmission, from a UE-A, by network (e.g., gNB) MAC CE signaling or L1 control signaling or by PC5 MAC CE signaling or SL L1 control signaling. In one example, network (or gNB) triggers the aperiodic reference signals. In one example, a UE-A triggers the aperiodic reference signals. In one example, a second SL UE (e.g., a UE-B) triggers the aperiodic reference signals. In one example, a SL UE, other than the SL UE transmitting or the SL UE receiving triggers the aperiodic reference signals. In one example, all aperiodic reference signals are triggered for transmission from a UE-A. In one example, a subset of aperiodic reference signals is triggered for transmission from a UE-A. In one example, one aperiodic reference signal is triggered for transmission from a UE-A.

In one example, a UE is preconfigured or configured by network (e.g., gNB) RRC configuration or configured by PC5 RRC configuration, with a set or list or group of reference signals to be transmitted from a second SL UE (e.g., a UE-B).

In one example, the preconfigured or configured reference signals are periodic reference signals. In one example, a network (or gNB) configures the reference signals. In one example, a UE-B configures the reference signals. In one example, a first SL UE (e.g., a UE-A) configures the reference signals. In one example, a SL UE, other than the SL UE transmitting or the SL UE receiving configures the reference signals.

In one example, the preconfigured or configured reference signals are semi-persistent reference signals. The reference signals can be activated for transmission, from a UE-B, by network (e.g., gNB) MAC CE signaling or L1 control signaling or by PC5 MAC CE signaling or SL L1 control signaling. In one example, a network (or a gNB) activates the semi-persistent reference signals. In one example, a UE-B activates the semi-persistent reference signals. In one example, a first SL UE (e.g., a UE-A) activates the semi-persistent reference signals. In one example, a SL UE, other than the SL UE transmitting or the SL UE receiving activates the semi-persistent reference signals. In one example, all semi-persistent reference signals are activated for transmission from a UE-B. In one example, a subset of semi-persistent reference signals is activated for transmission from a UE-B. In one example, one semi-persistent reference signal is activated for transmission from a UE-B.

In one example, the preconfigured or configured reference signals are aperiodic reference signals. The reference signals can be triggered for transmission, from a UE-B, by a network (e.g., gNB) MAC CE signaling or L1 control signaling or by PC5 MAC CE signaling or SL L1 control signaling. In one example, a network (or a gNB) triggers the aperiodic reference signals. In one example, a UE-B triggers the aperiodic reference signals. In one example, a first SL UE (e.g., a UE-A) triggers the aperiodic reference signals. In one example, a SL UE, other than the SL UE transmitting or the SL UE receiving triggers the aperiodic reference signals. In one example, all aperiodic reference signals are triggered for transmission from a UE-B. In one example, a subset of aperiodic reference signals is triggered for transmission from a UE-B. In one example, one aperiodic reference signal is triggered for transmission from a UE-B.

In one example, a UE is preconfigured or configured by network (e.g., gNB) RRC configuration or configured by PC5 RRC configuration, with a first set or list or group of reference signals to be transmitted from a first SL UE (e.g., a UE-A) and a second set or list or group of reference signals to be transmitted from a second SL UE (e.g., a UE-B).

In one example, the preconfigured or configured reference signals are periodic reference signals. In one example, a network (or gNB) configures the reference signals. In one example, a UE-A configures the reference signals. In one example, a UE-B configures the reference signals reference signals. In one example, a SL UE, other than the SL UE transmitting or the SL UE receiving configures the reference signals.

In one example, the preconfigured or configured reference signals are semi-persistent reference signals. The reference signals can be activated for transmission, from a UE-A and/or a UE-B, by network (e.g., gNB) MAC CE signaling or L1 control signaling or by PC5 MAC CE signaling or SL L1 control signaling. In one example, a network (or a gNB) activates the semi-persistent reference signals. In one example, a UE-A activates the semi-persistent reference signals. In one example, a UE-B activates the semi-persistent reference signals. In one example, a UE-A and a UE-B activate the semi-persistent reference signals. In one example, a SL UE, other than the SL UE transmitting or the SL UE receiving activates the semi-persistent reference signals. In one example, all semi-persistent reference signals are activated for transmission from a UE-A and/or a UE-B. In one example, a subset of semi-persistent reference signals is activated for transmission from a UE-A and/or a UE-B. In one example, one semi-persistent reference signal is activated for transmission from a UE-A or a UE-B. In one example, one semi-persistent reference signal is activated for transmission from a UE-A and one semi-persistent reference signal is activated for transmission from a UE-B.

In one example, the preconfigured or configured reference signals are aperiodic reference signals. The reference signals can be triggered for transmission, from a UE-A and/or a UE-B, by network (e.g., gNB) MAC CE signaling or L1 control signaling or by PC5 MAC CE signaling or SL L1 control signaling. In one example, network (or gNB) triggers the aperiodic reference signals. In one example, a UE-A triggers the aperiodic reference signals. In one example, a UE-B triggers the aperiodic reference signals. In one example, a UE-A and a UE-B trigger the aperiodic reference signals. In one example, a SL UE, other than the SL UE transmitting or the SL UE receiving triggers the aperiodic reference signals. In one example, all aperiodic reference signals are triggered for transmission from a UE-A and/or a UE-B. In one example, a subset of aperiodic reference signals is triggered for transmission from a UE-A and/or a UE-B. In one example, one aperiodic reference signal is triggered for transmission from a UE-A or a UE-B. In one example, one aperiodic reference signal is triggered for transmission from a UE-A and one aperiodic reference signal is triggered for transmission from a UE-B.

In one example, one or two sets of reference signals can be pre-configured or configured or activated or triggered, wherein the reference signals are transmitted from a first SL UE (e.g., a UE-A) and/or from a second SL UE (e.g., a UE-B).

In one example, one or two sets of reference signals can be pre-configured or configured, wherein the reference signals are transmitted from a first SL UE (e.g., a UE-A) and/or from a second SL UE (e.g., a UE-B).

In one example, one set of reference signals is pre-configured or configured, wherein the reference signal is transmitted by a UE-A.

In one example, one set of reference signals is pre-configured or configured, wherein the reference signal is transmitted by a UE-B.

In one example, a first set of reference signals is pre-configured or configured, wherein the reference signal is transmitted by a UE-A, and a second set of reference signals is pre-configured or configured, wherein the reference signal is transmitted by a UE-B.

In one example, one set of reference signals is pre-configured or configured including reference signals transmitted from a UE-A and reference signals transmitted from a UE-B.

In one example, one or two sets of reference signals can be activated, wherein the reference signals are transmitted from a first SL UE (e.g., a UE-A) and/or from a second SL UE (e.g., a UE-B).

In one example, one set of reference signals is activated, wherein the reference signal is transmitted by a UE-A.

In one example, one set of reference signals is activated, wherein the reference signal is transmitted by a UE-B.

In one example, a first set of reference signals is activated, wherein the reference signal is transmitted by a UE-A, and a second set of reference signals is activated, wherein the reference signal is transmitted by a UE-B.

In one example, one set of reference signals is activated including reference signals transmitted from a UE-A and reference signals transmitted from a UE-B.

In one example, one or two sets of reference signals can be triggered, wherein the reference signals are transmitted from a first SL UE (e.g., a UE-A) and/or from a second SL UE (e.g., a UE-B).

In one example, one set of reference signals is triggered, wherein the reference signal is transmitted by a UE-A.

In one example, one set of reference signals is triggered, wherein the reference signal is transmitted by a UE-B.

In one example, a first set of reference signals is triggered, wherein the reference signal is transmitted by a UE-A, and a second set of reference signals is triggered, wherein the reference signal is transmitted by a UE-B.

In one example, one set of reference signals is triggered including reference signals transmitted from a UE-A and reference signals transmitted from a UE-B.

In one example, a set of reference signals can be configured, a set (or subset) of codepoints of the reference signals can be activated and a codepoint or reference signal or reference signal ID can be indicated for a beam identification.

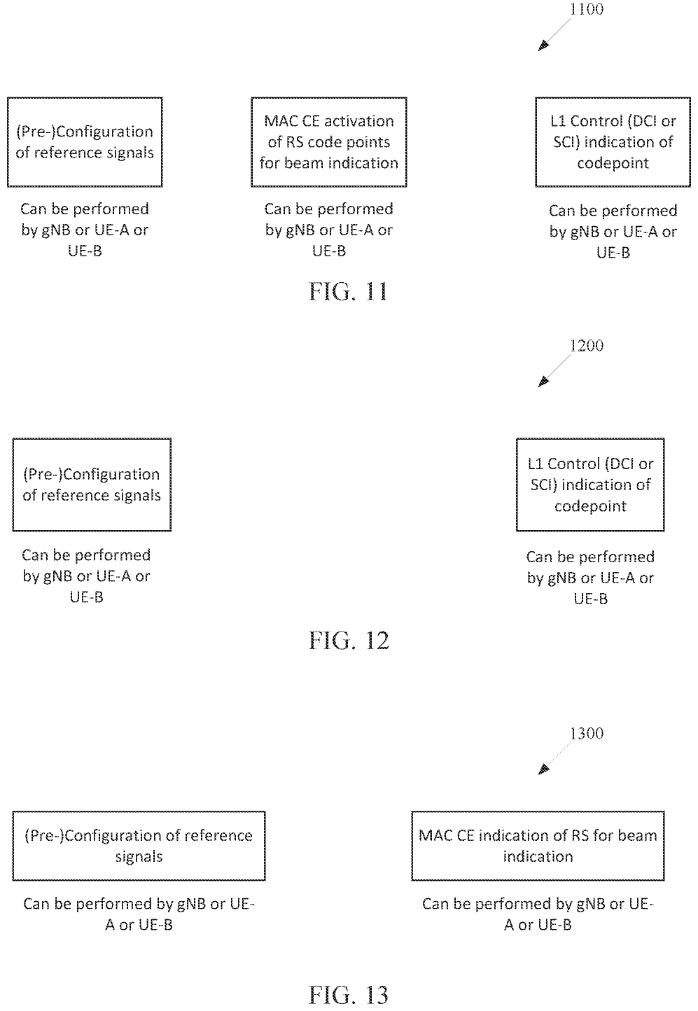

FIG. 11 illustrates an example of RRC configuration, MAC CE activation, and L1 control indication of reference signals for beam identification 1100 according to embodiments of the present disclosure. An embodiment of the RRC configuration, MAC CE activation, and L1 control indication of reference signals for beam identification 1100 shown in FIG. 11 is for illustration only.

In one example (RRC configuration+MAC CE activation+L1 control indication of reference signals for beam identification as illustrated in FIG. 11), a network (e.g., gNB)-MAC CE signaling or PC5-MAC CE signaling activates a subset of (1) RRC configured reference signals or (2) activated semi-persistent reference signals or (3) triggered aperiodic reference signals for a beam indication. For example, the activated sub-set can correspond to codepoints that can be further indicated from the gNB or the first SL UE or the second SL UE by L1 control signaling (e.g., DCI or using a first stage SL control information (SCI) or a second stage SCI or PSFCH). In one example, a network (or gNB) activates the codepoints (or reference signal IDs or reference signals) for a beam indication. In one example, a UE-A activates the codepoints (or reference signal IDs or reference signals) for a beam indication. In one example, a second SL UE (e.g., a UE-B) activates the codepoints (or reference signal IDs or reference signals) for a beam indication.

In one example, a third SL UE other than the SL transmitting UE and the SL receiving UE activates the codepoints (or reference signal IDs or reference signals) for a beam indication. In one example, a codepoint includes a reference signal ID or reference signal transmitted by a UE-A. In one example, a codepoint includes a reference signal ID or reference signal transmitted by a UE-B. In one example, a codepoint includes a pair of reference signals or reference signal IDs; (1) a reference signal ID or reference signal transmitted by a UE-A and (2) a reference signal ID or reference signal transmitted by a UE-B. In one example, a codepoint includes a pair of reference signals or reference signal IDs transmitted from the same UE (UE-A or UE-B).

In one example, the indicated reference signal codepoint by L1 control signaling is used for a beam or spatial domain transmission filter for a SL transmission from the first SL UE (e.g., a UE-A) to the second SL UE (e.g., a UE-B). In one example, the indicated reference signal codepoint by L1 control signaling is used for a beam or spatial domain transmission filter for a SL transmission from the second SL UE (e.g., a UE-B) to the first SL UE (e.g., a UE-A). In one example, the indicated reference signal codepoint by L1 control signaling is used for a beam or spatial domain transmission filter for a SL transmission from the first SL UE (e.g., a UE-A) to the second SL UE (e.g., a UE-B), and is used for a beam or spatial domain transmission filter for a SL transmission from the second SL UE (e.g., a UE-B) to the first SL UE (e.g., a UE-A).

In one example, a network (or gNB) indicates a codepoint (or reference signal ID or reference signal) by L1 control (e.g., DCI) signaling. In one example, a UE-A indicates a codepoint (or reference signal ID or reference signal) by L1 control (e.g., first stage SCI or second stage SCI or PSFCH) signaling. In one example, a UE-B indicates a codepoint (or reference signal ID or reference signal) by L1 control (e.g., first stage SCI or second stage SCI or PSFCH) signaling. In one example, a third SL UE other than the SL transmitting UE and the SL receiving UE indicates a codepoint (or reference signal ID or reference signal) by L1 control (e.g., first stage SCI or second stage SCI or PSFCH) signaling.

In one example, two codepoints are indicated by L1 control signaling, a first codepoint for a beam or spatial domain transmission filter for a SL transmission from a UE-A to a UE-B, and a second codepoint for a beam or spatial domain transmission filter for a SL transmission from a UE-B to a UE-A. In one example, a network (or gNB) indicates two codepoints (or reference signal IDs or reference signals) by L1 control (e.g., DCI) signaling, e.g., the DCI Format can include two codepoints. In one example, a UE-A indicates two codepoints (or reference signal IDs or reference signals) by L1 control (e.g., first stage SCI or second stage SCI or PSFCH) signaling, e.g., the first stage SCI Format or the second stage SCI Format or the PSFCH can include two codepoints. In one example, a UE-B indicates two codepoints (or reference signal IDs or reference signals) by L1 control (e.g., first stage SCI or second stage SCI or PSFCH) signaling, e.g., the first stage SCI Format or the second stage SCI Format or the PSFCH can include two codepoints. In one example, a third SL UE other than the SL transmitting UE and the SL receiving UE indicates two codepoints (or reference signal IDs or reference signals) by L1 control (e.g., first stage SCI or second stage SCI or PSFCH) signaling, e.g., the first stage SCI Format or the second stage SCI Format or the PSFCH can include two codepoints.

In one example, the L1 control indication of reference signal codepoint for beam identification can be performed by MAC CE indication instead of L1 control indication.

FIG. 12 illustrates an example of RRC configuration and L1 control indication of reference signals for beam identification 1200 according to embodiments of the present disclosure. An embodiment of the RRC configuration and L1 control indication of reference signals for beam identification 1200 shown in FIG. 12 is for illustration only.

In one example (RRC configuration+L1 control indication of reference signals for beam identification as illustrated in FIG. 12), (1) the pre-configured or configured reference signals, or (2) activated semi-persistent reference signals, or (3) triggered aperiodic reference signals can correspond to codepoints that can be further indicated from the first SL UE or the second SL UE by L1 control signaling (e.g., using a first stage SL control information (SCI) or a second stage SCI or PSFCH) or from the network (e.g., gNB) by DCI signaling. In one example, a network (or gNB) configures reference signals used as codepoints (or reference signal IDs or reference signals) for a beam indication. In one example, a UE-A configures reference signals used as codepoints (or reference signal IDs or reference signals) for a beam indication. In one example, a second SL UE (e.g., a UE-B) configures reference signals used as codepoints (or reference signal IDs or reference signals) for a beam indication. In one example, a third SL UE other than the SL transmitting UE and the SL receiving UE configures reference signals used as codepoints (or reference signal IDs or reference signals) for a beam indication. In one example, a codepoint includes a reference signal ID or reference signal transmitted by a UE-A. In one example, a codepoint includes a reference signal ID or reference signal transmitted by a UE-B. In one example, a codepoint includes a pair of reference signals or reference signal IDs; (1) a reference signal ID or reference signal transmitted by a UE-A and (2) a reference signal ID or reference signal transmitted by a UE-B. In one example, a codepoint includes a pair of reference signals or reference signal IDs transmitted from the same UE (UE-A or UE-B).

In one example, the indicated reference signal codepoint by L1 control signaling is used for a beam or spatial domain transmission filter for a SL transmission from the first SL UE (e.g., a UE-A) to the second SL UE (e.g., a UE-B). In one example, the indicated reference signal codepoint by L1 control signaling is used for a beam or spatial domain transmission filter for a SL transmission from the second SL UE (e.g., a UE-B) to the first SL UE (e.g., a UE-A). In one example, the indicated reference signal codepoint by L1 control signaling is used for a beam or spatial domain transmission filter for a SL transmission from the first SL UE (e.g., a UE-A) to the second SL UE (e.g., a UE-B), and is used for a beam or spatial domain transmission filter for a SL transmission from the second SL UE (e.g., a UE-B) to the first SL UE (e.g., a UE-A).

In one example, a network (or gNB) indicates a codepoint (or reference signal ID or reference signal) by L1 control (e.g., DCI) signaling. In one example, a UE-A indicates a codepoint (or reference signal ID or reference signal) by L1 control (e.g., first stage SCI or second stage SCI or PSFCH) signaling. In one example, a UE-B indicates a codepoint (or reference signal ID or reference signal) by L1 control (e.g., first stage SCI or second stage SCI or PSFCH) signaling. In one example, a third SL UE other than the SL transmitting UE and the SL receiving UE indicates a codepoint (or reference signal ID or reference signal) by L1 control (e.g., first stage SCI or second stage SCI or PSFCH) signaling.

In one example, two codepoints (or reference signals or reference signal IDs) are indicated by L1 control signaling, a first codepoint (or reference signal or reference signal ID) for a beam or spatial domain transmission filter for a SL transmission from a UE-A to a UE-B, and a second codepoint (or reference signal or reference signal ID) for a beam or spatial domain transmission filter for a SL transmission from a UE-B to a UE-A. In one example, a network (or gNB) indicates two codepoints (or reference signal IDs or reference signals) by L1 control (e.g., DCI) signaling, e.g., the DCI Format can include two codepoints. In one example, a UE-A indicates two codepoints (or reference signal IDs or reference signals) by L1 control (e.g., first stage SCI or second stage SCI or PSFCH) signaling, e.g., the first stage SCI Format or the second stage SCI Format or the PSFCH can include two codepoints. In one example, a UE-B indicates two codepoints (or reference signal IDs or reference signals) by L1 control (e.g., first stage SCI or second stage SCI or PSFCH) signaling, e.g., the first stage SCI Format or the second stage SCI Format or the PSFCH can include two codepoints. In one example, a third SL UE other than the SL transmitting UE and the SL receiving UE indicates two codepoints (or reference signal IDs or reference signals) by L1 control (e.g., first stage SCI or second stage SCI or PSFCH) signaling, e.g., the first stage SCI Format or the second stage SCI Format or the PSFCH can include two codepoints.

FIG. 13 illustrates an example of RRC configuration and MAC CE indication of TCI states/spatial relation information for beam identification 1300 according to embodiments of the present disclosure. An embodiment of the RRC configuration and MAC CE indication of TCI states/spatial relation information for beam identification 1300 shown in FIG. 13 is for illustration only.

In one example (RRC configuration+MAC CE indication of reference signals for beam identification as illustrated in FIG. 13), network (e.g., gNB)-MAC CE signaling or PC5-MAC CE signaling indicates (1) an RRC configured reference signal or (2) activated semi-persistent reference signal or (3) triggered aperiodic reference signal for a beam indication. In one example, MAC CE includes a reference signal ID or reference signal transmitted by a UE-A. In one example, MAC CE includes a reference signal ID or reference signal transmitted by a UE-B. In one example, MAC CE includes a pair of reference signals or reference signal IDs; (1) a reference signal ID or reference signal transmitted by a UE-A and (2) a reference signal ID or reference signal transmitted by a UE-B. In one example, a MAC-CE includes a pair of reference signals or reference signal IDs transmitted from the same UE (UE-A or UE-B).

In one example, the indicated reference signal by MAC CE signaling is used for a beam or spatial domain transmission filter for a SL transmission from the first SL UE (e.g., a UE-A) to the second SL UE (e.g., a UE-B). In one example, the indicated reference signal by MAC CE signaling is used for a beam or spatial domain transmission filter for a SL transmission from the second SL UE (e.g., a UE-B) to the first SL UE (e.g., a UE-A). In one example, the indicated reference signal by MAC CE signaling is used for a beam or spatial domain transmission filter for a SL transmission from the first SL UE (e.g., a UE-A) to the second SL UE (e.g., a UE-B), and is used for a beam or spatial domain transmission filter for a SL transmission from the second SL UE (e.g., a UE-B) to the first SL UE (e.g., a UE-A).

In one example, network (or gNB) indicates a reference signal ID or reference signal by MAC CE signaling. In one example, a UE-A indicates a reference signal ID or reference signal by MAC CE signaling. In one example, a UE-B indicates a reference signal ID or reference signal by MAC CE signaling. In one example, a third SL UE other than the SL transmitting UE and the SL receiving UE indicates a reference signal ID or reference signal by MAC CE signaling.

In one example, two reference signals or reference signal IDs are indicated by MAC CE signaling, a first reference signal or reference signal ID for a beam or spatial domain transmission filter for a SL transmission from a UE-A to a UE-B, and a second reference signal or reference signal ID for a beam or spatial domain transmission filter for a SL transmission from a UE-B to a UE-A. In one example, a network (or gNB) indicates two reference signal IDs or reference signals by MAC CE signaling, e.g., MAC CE can include two reference signals or reference signal IDs. In one example, a UE-A indicates two reference signal IDs or reference signals by MAC CE signaling, e.g., MAC CE can include two reference signals or reference signal IDs. In one example, a UE-B indicates two reference signal IDs or reference signals by MAC CE signaling, i.e., MAC CE can include two reference signals or reference signal IDs. In one example, a third SL UE other than the SL transmitting UE and the SL receiving UE indicates two reference signal IDs or reference signals by MAC CE signaling, i.e., MAC CE can include two reference signals or reference signal IDs.

In one example, one or two sets of reference signal codepoints for a beam indication can be activated, wherein the reference signals are transmitted from a first SL UE (e.g., a UE-A) and/or from a second SL UE (e.g., a UE-B).

In one example, one set of reference signal codepoints for a beam indication is activated, wherein the reference signals are transmitted from a UE-A.

In one example, one set of reference signal codepoints for a beam indication is activated, wherein the reference signals are transmitted from a UE-B.

In one example, a first set of reference signal codepoints for a beam indication is activated, wherein the reference signals are transmitted from a UE-A and a second set of reference signal codepoints for a beam indication is activated, wherein the reference signals are transmitted from a UE-B.

In one example, one set of reference signal codepoints for a beam indication is activated, including reference signals transmitted from a UE-A and reference signals transmitted from a UE-B. In one example, there is a first set of reference signals transmitted from a UE-A and a second set of reference signals transmitted from a UE-B. In another example, there is one set of reference signals including reference signals transmitted from a UE-A and reference signals transmitted from a UE-B.

In one example, a beam indication can be RRC signaling and/or MAC CE signaling and/or L1 control signaling (e.g., DCI signaling and/or first stage SCI signaling and/or second stage SCI signaling or PSFCH).

In one example, a beam indication can be signaled by a network (e.g., gNB).

In one example, a beam indication can be signaled by a SL UE. In one example, the SL UE is the UE transmitting the SL transmission. In one example, the SL UE is the UE receiving the SL transmission. In one example, the SL UE is a third UE other than the SL transmitting UE and the SL receiving UE.

In one example, a sidelink can be established between a UE-A and a UE-B, there can be a SL transmission from a UE-A to a UE-B, and there can a SL transmission from a UE-B to a UE-A.

In one example, a beam indication can be a codepoint or reference signal ID associated with a reference signal transmitted from a UE-A. In one example, the beam indication is for a beam or spatial domain transmission filter used for a SL transmission from a UE-A to a UE-B. In one example, the beam indication is for a beam or spatial domain transmission filter used for a SL transmission from a UE-B to a UE-A. In one example, the beam indication is for a beam or spatial domain transmission filter used for a SL transmission from a UE-A to a UE-B and for a beam or spatial domain transmission filter used for a SL transmission from a UE-B to a UE-A.

In one example, the beam indication is for a beam or spatial domain transmission filter used for SL transmission from a UE-A. In one example, the beam indication is for a beam or spatial domain transmission filter used for SL transmission from a UE-B. In one example, the beam indication is for a beam or spatial domain transmission filter used for SL transmission at a UE-A and for a beam or spatial domain transmission filter SL used for SL transmission at a UE-B.

In one example, the beam indication is for a beam or spatial domain reception filter used for SL reception at a UE-A. In one example, the beam indication is for a beam or spatial domain reception filter used for SL reception at a UE-B. In one example, the beam indication is for a beam or spatial domain reception filter used for SL reception at a UE-A and for a beam or spatial domain reception filter used for SL reception at a UE-B.

In one example, a beam indication can be a codepoint or reference signal ID associated with a reference signal transmitted from a UE-B. In one example, the beam indication is for a beam or spatial domain transmission filter used for a SL transmission from a UE-B to a UE-A. In one example, the beam indication is for a beam or spatial domain transmission filter used for a SL transmission from a UE-A to a UE-B. In one example, the beam indication is for a beam or spatial domain transmission filter used for a SL transmission from a UE-B to a UE-A and for a beam or spatial domain transmission filter used for a SL transmission from a UE-A to a UE-B.

In one example, the beam indication is for a beam or spatial domain transmission filter used for SL transmission from a UE-B. In one example, the beam indication is for a beam or spatial domain transmission filter used for SL transmission from a UE-A. In one example, the beam indication is for a beam or spatial domain transmission filter used for SL transmission at a UE-B and for a beam or spatial domain transmission filter SL used for SL transmission at a UE-A.

In one example, the beam indication is for a beam or spatial domain reception filter used for SL reception at a UE-B. In one example, the beam indication is for a beam or spatial domain reception filter used for SL reception at a UE-A. In one example, the beam indication is for a beam or spatial domain reception filter used for SL reception at a UE-B and for a beam or spatial domain reception filter used for SL reception at a UE-A.

In one example, a beam indication can be a codepoint with (1) a first reference signal ID associated with a first reference signal transmitted from a UE-A, and (2) a second reference signal ID associated with a second reference signal transmitted from a UE-B. In a variant example, the first and the second reference signal IDs are associated with a first and a second reference signals transmitted from a same UE (e.g., UE-A or UE-B). In one example, the first reference signal is for a beam indication for a beam or spatial domain transmission filter used for a SL transmission from a UE-A to a UE-B. In one example, the first reference signal is for a beam indication for a beam or spatial domain transmission filter used for a SL transmission from a UE-B to a UE-A. In one example, the second reference signal is for a beam indication for a beam or spatial domain transmission filter used for a SL transmission from a UE-B to a UE-A. In one example, the second reference signal is for a beam indication for a beam or spatial domain transmission filter used for a SL transmission from a UE-A to a UE-B.

In one example, the first reference signal is for a beam indication for a beam or spatial domain transmission filter used for SL transmission from a UE-A. In one example, the first reference signal is for a beam indication for a beam or spatial domain transmission filter used for SL transmission from a UE-B. In one example, the second reference signal is for a beam indication for a beam or spatial domain transmission filter used for SL transmission from a UE-B. In one example, the second reference signal is for a beam indication for a beam or spatial domain transmission filter used for SL transmission from a UE-A.

In one example, the first reference signal is for a beam indication for a beam or spatial domain reception filter used for SL reception at a UE-A. In one example, the first reference signal is for a beam indication for a beam or spatial domain reception filter used for SL reception at a UE-B. In one example, the second reference signal is for a beam indication for a beam or spatial domain reception filter used for SL reception at a UE-B. In one example, the second reference signal is for a beam indication for a beam or spatial domain reception filter used for SL reception at a UE-A.

In one example, a beam indication can have two codepoints with (1) a first codepoint or a first reference signal ID associated with a first reference signal transmitted from a UE-A, and (2) a second codepoint or a second reference signal ID associated with a second reference signal transmitted from a UE-B. In a variant example, the first and the second codepoints are associated with a first and a second reference signals transmitted from a same UE (e.g., UE-A or UE-B). In one example, the first reference signal is for a beam indication for a beam or spatial domain transmission filter used for a SL transmission from a UE-A to a UE-B. In one example, the first reference signal is for a beam indication for a beam or spatial domain transmission filter used for a SL transmission from a UE-B to a UE-A. In one example, the second reference signal is for a beam indication for a beam or spatial domain transmission filter used for a SL transmission from a UE-B to a UE-A. In one example, the second reference signal is for a beam indication for a beam or spatial domain transmission filter used for a SL transmission from a UE-A to a UE-B.

In one example, the first reference signal is for a beam indication for a beam or spatial domain transmission filter used for SL transmission from a UE-A. In one example, the first reference signal is for a beam indication for a beam or spatial domain transmission filter used for SL transmission from a UE-B. In one example, the second reference signal is for a beam indication for a beam or spatial domain transmission filter used for SL transmission from a UE-B. In one example, the second reference signal is for a beam indication for a beam or spatial domain transmission filter used for SL transmission from a UE-A.

In one example, the first reference signal is for a beam indication for a beam or spatial domain reception filter used for SL reception at a UE-A. In one example, the first reference signal is for a beam indication for a beam or spatial domain reception filter used for SL reception at a UE-B. In one example, the second reference signal is for a beam indication for a beam or spatial domain reception filter used for SL reception at a UE-B. In one example, the second reference signal is for a beam indication for a beam or spatial domain reception filter used for SL reception at a UE-A.

In one example, a beam indication can be a codepoint with (1) a first reference signal ID associated with a first reference signal for indicating a beam or spatial domain filter from a UE-A to a UE-B, and/or (2) a second reference signal ID associated with a second reference signal for indicating a beam or spatial domain filter from a UE-B to a UE-A.

In one example, a DCI format for SL (e.g., DCI Format 3-0 or DCI Format 3-x) can include one field (e.g., codepoint) for a beam indication.

In one example, a first stage SCI format can include one field (e.g., codepoint) for a beam indication.

In one example, a second stage SCI format can include one field (e.g., codepoint) for a beam indication. In one example, a PSFCH can include one field (e.g., codepoint) for a beam indication.

In one example, a MAC CE (on Uu interface or PC5 interface) for a beam indication can include one field for a beam indication.

In one example, a beam indication can have two codepoints with (1) a first codepoint or a first reference signal ID associated with a first reference signal for indicating a beam or spatial domain filter from a UE-A to a UE-B, and (2) a second codepoint or a second reference signal ID associated with a second reference signal for indicating a beam or spatial domain filter from a UE-B to a UE-A.

In one example, a DCI format for SL (e.g., DCI Format 3-0 or DCI Format 3-x) can include two fields (e.g., codepoints) for a beam indication.

In one example, a first stage SCI format can include two fields (e.g., codepoints) for a beam indication.

In one example, a second stage SCI format can include two fields (e.g., codepoints) for a beam indication. In one example, a PSFCH can include two fields (e.g., codepoints) for a beam indication.

In one example, a MAC CE (on Uu interface or PC5 interface) for a beam indication can include two fields for a beam indication.

In one example, a TCI state configuration or a spatial relation information configuration can associate a TCI state ID with one or more source RS.

In one example, a TCI state configuration or a spatial relation information configuration can include at least: (1) a TCI state ID or spatial relation information ID and (2) a reference signal ID, wherein the reference signal (e.g., source reference signal) determines the beam or spatial domain filter of a SL transmission or quasi-co-location information for a SL transmission. In one example, the reference signal can be periodic reference signal. In one example, the reference signal can be a semi-persistent reference signal. In one example, the reference signal can be an aperiodic reference signal.

In one example, a TCI state configuration or a spatial relation information configuration can additionally include: a UE index or ID from which the reference signal is transmitted. In one example, the UE index or ID can be a one-bit field, with “0” for the first SL UE of a PC5-link, and “1” for the second SL UE of a PC5-link or vice versa.

In one example, a TCI state configuration or a spatial relation information configuration can additionally include: a quasi-co-location type. In one example, the quasi-co-location type can be one or more of the following QCL Types: (1) Type A, {Doppler shift, Doppler spread, average delay, delay spread}, or (2)—Type B, {Doppler shift, Doppler spread}, or (3) Type C, {Doppler shift, average delay}, or (4) Type D, {Spatial domain (e.g., spatial Rx and/or spatial Tx) parameter}.

In one example, a TCI state configuration or a spatial relation information configuration can additionally include: a pathloss reference signal ID or index. Can also include the UE ID or index of the pathloss reference signal.

In one example, a TCI state configuration or a spatial relation information configuration can additionally include: power control parameters (e.g., P0 for SL pathloss-based power control or for DL pathloss-based power control and/or alpha for SL pathloss-based power control or for DL pathloss-based power control and/or closed loop power control index for SL pathloss-based power control or for DL pathloss-based power control).

In one example, a TCI state configuration or a spatial relation information configuration can additionally include: a bandwidth part ID (e.g., SL bandwidth part ID).

In one example, a TCI state configuration or a spatial relation information configuration can additionally include: a serving cell index.

In one example, a TCI state configuration or a spatial relation information configuration can include a quasi-co-location information field, wherein the quasi-co-location information field includes one or more of the aforementioned parameters.

In one example, a TCI state configuration or a spatial relation information configuration includes more than one instance of the aforementioned parameters. For example, a TCI state configuration or a spatial relation information configuration can include more than one reference signal ID and more than one associated QCL-Type and more than one associated UE index or ID.

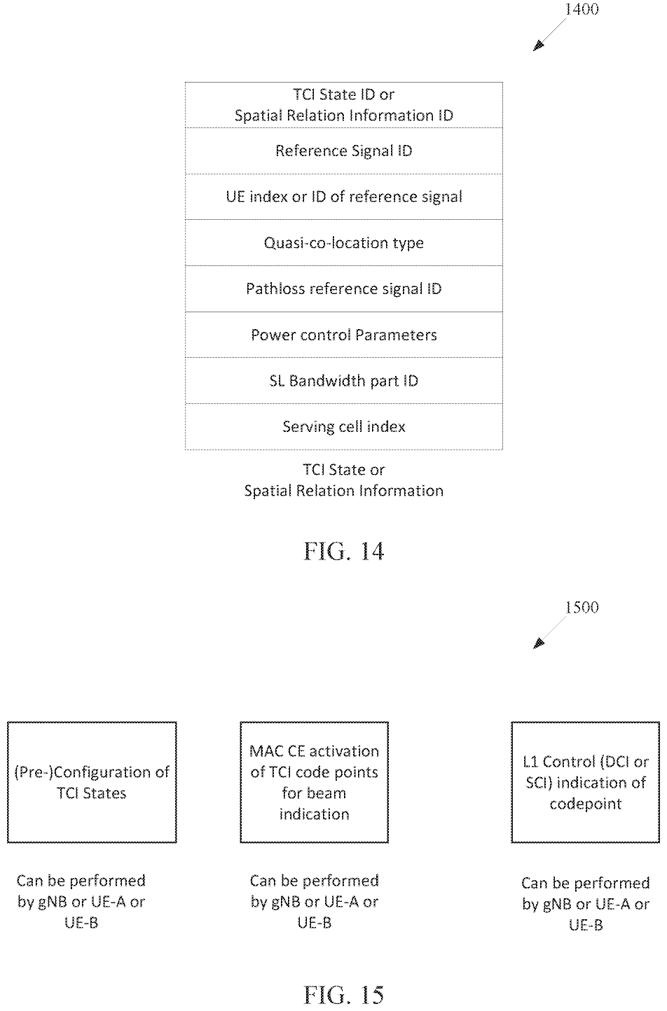

FIG. 14 illustrates an example of TCI state or a spatial relation information 1400 according to embodiments of the present disclosure. An embodiment of the TCI state or a spatial relation information 1400 shown in FIG. 14 is for illustration only.

In one example a TCI state or a spatial relation information is as shown FIG. 14. In some examples, some fields are omitted. In some examples some fields are repeated multiple times. In some examples, some fields are present once. In some examples, additional fields, not shown, can be included in the state or the spatial relation information.

In one example, a UE can be preconfigured or configured by a network (e.g., gNB) RRC configuration or configured by PC5 RRC configuration, with a set or list or group of TCI states or spatial relation information elements.

In one example, a first list of preconfigured or configured TCI states or spatial relation information elements are for a first SL UE (e.g., a UE-A). In one example, a TCI state or spatial relation information in the list can indicate a beam for SL transmission from a UE-A to a UE-B (e.g., a UE-A-to-UE-B TCI state or a UE-A-to-UE-B spatial relation information element).

In one example, a second list of preconfigured or configured TCI states or spatial relation information elements are for a second SL UE (e.g., a UE-B). In one example, a TCI state or spatial relation information in the list can indicate a beam for SL transmission from a UE-B to a UE-A (e.g., a UE-B-to-UE-A TCI state or a UE-B-to-UE-A spatial relation information element).

In one example, a list of preconfigured or configured TCI states or spatial relation information elements are for a UE-A and a UE-B. In one example, a TCI state or a spatial relation information element in the list can indicate a beam for SL transmission from a UE-A to a UE-B (e.g., a UE-A-to-UE-B TCI state or a UE-A-to-UE-B spatial relation information element). In one example, a TCI state or a spatial relation information element in the list can indicate a beam for SL transmission from a UE-B to a UE-A (e.g., a UE-B-to-UE-A TCI state or a UE-A-to-UE-B spatial relation information element). In one example, a TCI state or a spatial relation information element in the list can indicate (1) a beam for SL transmission from a UE-A to a UE-B and (2) a beam for SL transmission from a UE-A to a UE-B (e.g., a joint TCI state or a joint spatial relation information element).

In one example, the reference signal of a UE-A-to-UE-B TCI state or a UE-A-to-UE-B spatial relation information element is a reference signal transmitted from a UE-A.

In one example, the reference signal of a UE-A-to-UE-B TCI state or a UE-A-to-UE-B spatial relation information element is a reference signal transmitted from a UE-B.

In one example, a UE-A-to-UE-B TCI state or a UE-A-to-UE-B spatial relation information element includes multiple reference signals with different quasi-co-location types. In one example, the multiple reference signals are transmitted from the same UE. In another example, the multiple reference signals can be transmitted from different UEs.

In one example, the reference signal of a UE-B-to-UE-A TCI state or a UE-B-to-UE-A spatial relation information element is a reference signal transmitted from a UE-B.

In one example, the reference signal of a UE-B-to-UE-A TCI state or a UE-B-to-UE-A spatial relation information element is a reference signal transmitted from a UE-A.

In one example, a UE-B-to-UE-A TCI state or a UE-B-to-UE-A spatial relation information element includes multiple reference signals with different quasi-co-location types. In one example, the multiple reference signals are transmitted from the same UE. In another example, the multiple reference signals can be transmitted from different UEs.

In one example, the reference signal of a joint TCI state or a joint spatial relation (joint indicating that it can be used for both UE-A to UE-B transmissions and UE-B to UE-A transmissions) information element is a reference signal transmitted from a UE-A.

In one example, the reference signal of a joint TCI state or a joint spatial relation information element is a reference signal transmitted from a UE-B.

In one example, a joint TCI state or a joint spatial relation information element includes multiple reference signals with different quasi-co-location types. In one example, the multiple reference signals are transmitted from the same UE. In another example, the multiple reference signals can be transmitted from different UEs.

In one example, a joint TCI state or a joint spatial relation information element includes a first reference signal for beam identification transmitted from a UE-A and a second reference for beam identification transmitted from a UE-B.

In one example, a set of TCI states or spatial relation information elements can be configured, a set (or subset) of codepoints of the TCI states or spatial relation information elements can be activated and a codepoint or TCI state or TCI state ID or spatial relation information element or spatial relation information element ID can be indicated for a beam identification.

FIG. 15 illustrates an example of RRC configuration, MAC CE activation, and L1 control indication of TCI states/spatial relation information for beam identification 1500 according to embodiments of the present disclosure. An embodiment of the RRC configuration, MAC CE activation, and L1 control indication of TCI states/spatial relation information for beam identification 1500 shown in FIG. 15 is for illustration only.

In one example (RRC configuration+MAC CE activation+L1 control indication of TCI states/spatial relation information for beam identification as illustrated in FIG. 15), a network (e.g., gNB)-MAC CE signaling or PC5-MAC CE signaling activates a subset of RRC configured TCI states or spatial relation information elements. For example, the activated sub-set can correspond to codepoints that can be further indicated from the gNB or the first SL UE or the second SL UE by L1 control signaling (e.g., DCI or using a first stage SL control information (SCI) or a second stage SCI or PSFCH). In one example, a network (or gNB) activates the codepoints (or TCI state IDs or TCI states or spatial relation information IDs or spatial relation information elements) for a beam indication. In one example, a UE-A activates the codepoints (or TCI state IDs or TCI states or spatial relation information IDs or spatial relation information elements) for a beam indication. In one example, a second SL UE (e.g., a UE-B) activates the codepoints (or TCI state IDs or TCI states or spatial relation information IDs or spatial relation information elements) for a beam indication. In one example, a third SL UE other than the SL transmitting UE and the SL receiving UE activates the codepoints (or TCI state IDs or TCI states or spatial relation information IDs or spatial relation information elements) for a beam indication. In one example, a codepoint includes a UE-A-to-UE-B TCI state or a UE-A-to-UE-B spatial relation information element.

In one example, a codepoint includes a UE-B-to-UE-A TCI state or a UE-B-to-UE-A spatial relation information element. In one example, a codepoint includes a joint TCI state or a joint spatial relation information element. In one example, a codepoint includes a pair of TCI states or spatial relation information elements; (1) a UE-A-to-UE-B TCI state or a UE-A-to-UE-B spatial relation information element and (2) a UE-B-to-UE-A TCI state or a UE-B-to-UE-A spatial relation information element.

In one example, the indicated codepoint by L1 control signaling is used for a beam or spatial domain transmission filter for a SL transmission from a UE-A to a UE-B. In one example, the indicated codepoint by L1 control signaling is used for a beam or spatial domain transmission filter for a SL transmission from a UE-B to a UE-A. In one example, the indicated codepoint (e.g., comprising of a joint TCI state or pair of (1) UE-A-to-UE-B TCI state and (2) UE-B-to-UE-A TCI state) by L1 control signaling is used for a beam or spatial domain transmission filter for a SL transmission from a UE-A to a UE-B, and is used for a beam or spatial domain transmission filter for a SL transmission from a UE-B to a UE-A.

In one example, a network (or gNB) indicates a codepoint (or TCI state ID or TCI state or spatial relation information ID or spatial relation information element) by L1 control (e.g., DCI) signaling. In one example, a UE-A indicates a codepoint (or TCI state ID or TCI state or spatial relation information ID or spatial relation information element) by L1 control (e.g., first stage SCI or second stage SCI or PSFCH) signaling. In one example, a UE-B indicates a codepoint (or TCI state ID or TCI state or spatial relation information ID or spatial relation information element) by L1 control (e.g., first stage SCI or second stage SCI or PSFCH) signaling. In one example, a third SL UE other than the SL transmitting UE and the SL receiving UE indicates a codepoint (or TCI state ID or TCI state or spatial relation information ID or spatial relation information element) by L1 control (e.g., first stage SCI or second stage SCI or PSFCH) signaling.

In one example, two codepoints are indicated by L1 control signaling, a first codepoint for a beam or spatial domain transmission filter for a SL transmission from a UE-A to a UE-B, and a second codepoint for a beam or spatial domain transmission filter for a SL transmission from a UE-B to a UE-A. In one example, a network (or gNB) indicates two codepoints (or TCI state IDs or TCI states or spatial relation information IDs or spatial relation information elements) by L1 control (e.g., DCI) signaling, e.g., the DCI Format can include two codepoints. In one example, a UE-A indicates two codepoints (or TCI state IDs or TCI states or spatial relation information IDs or spatial relation information elements) by L1 control (e.g., first stage SCI or second stage SCI or PSFCH) signaling, e.g., the first stage SCI Format or the second stage SCI Format or the PSFCH can include two codepoints. In one example, a UE-B indicates two codepoints (or TCI state IDs or TCI states or spatial relation information IDs or spatial relation information elements) by L1 control (e.g., first stage SCI or second stage SCI or PSFCH) signaling, e.g., the first stage SCI Format or the second stage SCI Format or the PSFCH can include two codepoints. In one example, a third SL UE other than the SL transmitting UE and the SL receiving UE indicates two codepoints (or TCI state IDs or TCI states or spatial relation information IDs or spatial relation information elements) by L1 control (e.g., first stage SCI or second stage SCI or PSFCH) signaling, e.g., the first stage SCI Format or the second stage SCI Format or the PSFCH can include two codepoints.

In one example, the L1 control indication of reference signal codepoint for beam identification can be performed by MAC CE indication instead of L1 control indication.

FIG. 16 illustrates an example of RRC configuration and L1 control indication of TCI states/spatial relation information for beam identification 1600 according to embodiments of the present disclosure. An embodiment of the RRC configuration and L1 control indication of TCI states/spatial relation information for beam identification 1600 shown in FIG. 16 is for illustration only.

In one example (RRC configuration+L1 control indication of TCI states/spatial relation information for beam identification as illustrated in FIG. 16), the pre-configured or configured TCI states or spatial relation information can correspond to codepoints that can be further indicated from the first SL UE or the second UE by L1 control signaling (e.g., using a first stage SL control information (SCI) or a second stage SCI or PSFCH) or from the network (e.g., gNB) by DCI signaling. In one example, a network (or gNB) configures TCI states or spatial relation information used as codepoints (or TCI state IDs or TCI states or spatial relation information IDs or spatial relation information elements) for a beam indication. In one example, a UE-A configures TCI states or spatial relation information used as codepoints (or TCI state IDs or TCI states or spatial relation information IDs or spatial relation information elements) for a beam indication. In one example, a second SL UE (e.g., a UE-B) configures TCI states or spatial relation information used as codepoints (or TCI state IDs or TCI states or spatial relation information IDs or spatial relation information elements) for a beam indication. In one example, a codepoint includes a UE-A-to-UE-B TCI state or a UE-A-to-UE-B spatial relation information element. In one example, a codepoint includes a UE-B-to-UE-A TCI state or a UE-B-to-UE-A spatial relation information element. In one example, a codepoint includes a joint TCI state or a joint spatial relation information element. In one example, a codepoint includes a pair of TCI states or spatial relation information elements; (1) a UE-A-to-UE-B TCI state or a UE-A-to-UE-B spatial relation information element and (2) a UE-B-to-UE-A TCI state or a UE-B-to-UE-A spatial relation information element.

In one example, the indicated codepoint by L1 control signaling is used for a beam or spatial domain transmission filter for a SL transmission from a UE-A to a UE-B. In one example, the indicated codepoint by L1 control signaling is used for a beam or spatial domain transmission filter for a SL transmission from a UE-B to a UE-A. In one example, the indicated codepoint (e.g., comprising of a joint TCI state or pair of (1) UE-A-to-UE-B TCI state and (2) a UE-B-to-UE-A TCI state) by L1 control signaling is used for a beam or spatial domain transmission filter for a SL transmission from a UE-A to a UE-B, and is used for a beam or spatial domain transmission filter for a SL transmission from a UE-B to a UE-A.

In one example, a network (or a gNB) indicates a codepoint (or TCI state IDs or TCI states or spatial relation information IDs or spatial relation information elements) by L1 control (e.g., DCI) signaling. In one example, a UE-A indicates a codepoint (or TCI state IDs or TCI states or spatial relation information IDs or spatial relation information elements) by L1 control (e.g., first stage SCI or second stage SCI or PSFCH) signaling. In one example, a UE-B indicates a codepoint (or TCI state IDs or TCI states or spatial relation information IDs or spatial relation information elements) by L1 control (e.g., first stage SCI or second stage SCI or PSFCH) signaling. In one example, a third SL UE other than the SL transmitting UE and the SL receiving UE indicates a codepoint (or TCI state ID or TCI state or spatial relation information ID or spatial relation information element) by L1 control (e.g., first stage SCI or second stage SCI or PSFCH) signaling.

In one example, two codepoints (or TCI state IDs or TCI states or spatial relation information IDs or spatial relation information elements) are indicated by L1 control signaling, a first codepoint (or TCI state ID or TCI state or spatial relation information ID or spatial relation information element) for a beam or spatial domain transmission filter for a SL transmission from a UE-A to a UE-B, and a second codepoint (or TCI state ID or TCI state or spatial relation information ID or spatial relation information element) for a beam or spatial domain transmission filter for a SL transmission from a UE-B to a UE-A. In one example, a network (or a gNB) indicates two codepoints (or TCI state IDs or TCI states or spatial relation information IDs or spatial relation information elements) by L1 control (e.g., DCI) signaling, e.g., the DCI Format can include two codepoints. In one example, a UE-A indicates two codepoints (or TCI state IDs or TCI states or spatial relation information IDs or spatial relation information elements) by L1 control (e.g., first stage SCI or second stage SCI or PSFCH) signaling, e.g., the first stage SCI Format or the second stage SCI Format or the PSFCH can include two codepoints. In one example, a UE-B indicates two codepoints (or TCI state IDs or TCI states or spatial relation information IDs or spatial relation information elements) by L1 control (e.g., first stage SCI or second stage SCI or PSFCH) signaling, e.g., the first stage SCI Format or the second stage SCI Format can include two codepoints. In one example, a third SL UE other than the SL transmitting UE and the SL receiving UE indicates two codepoints (or TCI state IDs or TCI states or spatial relation information IDs or spatial relation information elements) by L1 control (e.g., first stage SCI or second stage SCI or PSFCH) signaling, e.g., the first stage SCI Format or the second stage SCI Format or the PSFCH can include two codepoints.

FIG. 17 illustrates an example of RRC configuration and MAC CE indication of TCI states/spatial relation information for beam identification 1700 according to embodiments of the present disclosure. An embodiment of the RRC configuration and MAC CE indication of TCI states/spatial relation information for beam identification 1700 shown in FIG. 17 is for illustration only.

In one example (RRC configuration+MAC CE indication of TCI states/spatial relation information for beam identification as illustrated in FIG. 17), a network (e.g., a gNB)-MAC CE signaling or PC5-MAC CE signaling indicates an RRC configured TCI state or spatial relation information for a beam indication. In one example, MAC CE includes a UE-A-to-UE-B TCI state or a UE-A-to-UE-B spatial relation information element. In one example, MAC CE includes a UE-B-to-UE-A TCI state or a UE-B-to-UE-A spatial relation information element. In one example, MAC CE includes a joint TCI state or a joint spatial relation information element. In one example, MAC CE includes a pair of TCI states or spatial relation information elements; (1) a UE-A-to-UE-B TCI state or a UE-A-to-UE-B spatial relation information element and (2) a UE-B-to-UE-A TCI state or a UE-B-to-UE-A spatial relation information element.

In one example, the indicated TCI state or spatial relation information by MAC CE signaling is used for a beam or spatial domain transmission filter for a SL transmission from a UE-A to a UE-B. In one example, the indicated TCI state or spatial relation information by MAC CE signaling is used for a beam or spatial domain transmission filter for a SL transmission from a UE-B to a UE-A. In one example, the indicated TCI state or spatial relation information by MAC CE signaling (e.g., comprising of a joint TCI state or pair of (1) a UE-A-to-UE-B TCI state and (2) a UE-B-to-UE-A TCI state) is used for a beam or spatial domain transmission filter for a SL transmission from a UE-A to a UE-B, and is used for a beam or spatial domain transmission filter for a SL transmission from a UE-B to a UE-A.

In one example, a network (or a gNB) indicates a TCI state ID or a TCI state or a spatial relation information ID or a spatial relation information element by MAC CE signaling. In one example, a UE-A indicates a TCI state ID or a TCI state or a spatial relation information ID or a spatial relation information element by MAC CE signaling. In one example, a UE-B indicates a TCI state ID or a TCI state or a spatial relation information ID or a spatial relation information element by MAC CE signaling. In one example, a third UE other than the SL transmitting UE and the SL receiving UE indicates a TCI state ID or a TCI state or a spatial relation information ID or a spatial relation information element by MAC CE signaling.

In one example, two TCI state IDs or TCI states or spatial relation information IDs or spatial relation information elements are indicated by MAC CE signaling, a first TCI state ID or TCI state or spatial relation information ID or spatial relation information element for a beam or spatial domain transmission filter for a SL transmission from a UE-A to a UE-B, and a second or TCI state ID or TCI state or spatial relation information ID or spatial relation information element for a beam or spatial domain transmission filter for a SL transmission from a UE-B to a UE-A. In one example, a network (or a gNB) indicates two TCI state IDs or TCI states or spatial relation information IDs or spatial relation information elements by MAC CE signaling, e.g., MAC CE can include two TCI state IDs or TCI states or spatial relation information IDs or spatial relation information elements. In one example, a UE-A indicates two TCI state IDs or TCI states or spatial relation information IDs or spatial relation information elements by MAC CE signaling, e.g., MAC CE can include two TCI state IDs or TCI states or spatial relation information IDs or spatial relation information elements. In one example, a UE-B indicates two TCI state IDs or TCI states or spatial relation information IDs or spatial relation information elements by MAC CE signaling, i.e., MAC CE can include two TCI state IDs or TCI states or spatial relation information IDs or spatial relation information elements. In one example, a third UE other than the SL transmitting UE and the SL receiving UE indicates two TCI state IDs or TCI states or spatial relation information IDs or spatial relation information elements by MAC CE signaling, i.e., MAC CE can include two TCI state IDs or TCI states or spatial relation information IDs or spatial relation information elements.

In one example, one or two sets of TCI states or spatial relation information codepoints for a beam indication can be activated, wherein the TCI states or spatial relation information are for a SL transmission transmitted between a UE-A and a UE-B.

In one example, one set of TCI states or spatial relation information codepoints for a beam indication is activated, wherein the TCI states or spatial relation information are for a SL transmission transmitted from a UE-A to a UE-B (a UE-A-to-UE-B TCI state).

In one example, one set of TCI states or spatial relation information codepoints for a beam indication is activated, wherein the TCI states or spatial relation information are for a SL transmission transmitted from a UE-B to a UE-A (a UE-B-to-UE-1 TCI state).

In one example, a first set of TCI states or spatial relation information codepoints for a beam indication is activated, wherein the TCI states or spatial relation information are for a SL transmission transmitted from a UE-A to a UE-B (a UE-A-to-UE-B TCI state), and a second set of TCI states or spatial relation information codepoints for a beam indication is activated, wherein the TCI states or spatial relation information are for a SL transmission transmitted from a UE-B to a UE-A (a UE-B-to-UE-A TCI state).

In one example, one set of TCI state or spatial relation information codepoints for a beam indication is activated, including TCI states or spatial relation information are for a SL transmission transmitted from a UE-A to a UE-B (a UE-A-to-UE-B TCI state) and TCI states or spatial relation information are for a SL transmission transmitted from a UE-B to a UE-A (a UE-B-to-UE-A TCI state). In one example, there is a sub-set of TCI states or spatial relation information for a SL transmission transmitted from a UE-A to a UE-B (a UE-A-to-UE-B TCI state). In one example, there is a sub-set of TCI states or spatial relation information for a SL transmission transmitted from a UE-B to a UE-A (a UE-B-to-UE-A TCI state). In one example, there is a sub-set of joint TCI states or joint spatial relation information for a SL transmission transmitted from a UE-A to a UE-B and a UE-B to a UE-A. In the aforementioned examples, a subset can be the full set.

In one example, a beam indication can be RRC signaling and/or MAC CE signaling and/or L1 control signaling (e.g., DCI signaling and/or first stage SCI signaling and/or second stage SCI signaling or PSFCH signaling).

In one example, a beam indication can be signaled by a network (e.g., a gNB).

In one example, a beam indication can be signaled by a SL UE. In one example, the SL UE is the UE transmitting the SL transmission. In one example, the SL UE is the UE receiving the SL transmission. In one example, the SL UE is a third UE.

In one example, a sidelink can be established between a UE-A and a UE-B, there can be a SL transmission from a UE-A to a UE-B, and there can a SL transmission from a UE-B to a UE-A.

In one example, a beam indication can be a codepoint or TCI state ID or spatial relation information ID associated with a reference signal transmitted from a UE-A. In one example, the beam indication is for a beam or spatial domain transmission filter used for a SL transmission from a UE-A to a UE-B. In one example, the beam indication is for a beam or spatial domain transmission filter used for a SL transmission from a UE-B to a UE-A. In one example, the beam indication is for a beam or spatial domain transmission filter used for a SL transmission from a UE-A to a UE-B and for a beam or spatial domain transmission filter used for a SL transmission from a UE-B to a UE-A.

In one example, the beam indication is for a beam or spatial domain transmission filter used for SL transmission from a UE-A. In one example, the beam indication is for a beam or spatial domain transmission filter used for SL transmission from a UE-B. In one example, the beam indication is for a beam or spatial domain transmission filter used for SL transmission from a UE-A and for a beam or spatial domain transmission filter SL used for SL transmission from a UE-B.

In one example, the beam indication is for a beam or spatial domain reception filter used for SL reception at a UE-A. In one example, the beam indication is for a beam or spatial domain reception filter used for SL reception at a UE-B. In one example, the beam indication is for a beam or spatial domain reception filter used for SL reception at a UE-A and for a beam or spatial domain reception filter used for SL reception at a UE-B.

In one example, a beam indication can be a codepoint or TCI state ID or spatial relation information ID associated with a reference signal transmitted from a UE-B. In one example, the beam indication is for a beam or spatial domain transmission filter used for a SL transmission from a UE-B to a UE-A. In one example, the beam indication is for a beam or spatial domain transmission filter used for a SL transmission from a UE-A to a UE-B. In one example, the beam indication is for a beam or spatial domain transmission filter used for a SL transmission from a UE-B to a UE-A and for a beam or spatial domain transmission filter used for a SL transmission from a UE-A to a UE-B.

In one example, the beam indication is for a beam or spatial domain transmission filter used for SL transmission from a UE-B. In one example, the beam indication is for a beam or spatial domain transmission filter used for SL transmission from a UE-A. In one example, the beam indication is for a beam or spatial domain transmission filter used for SL transmission from a UE-B and for a beam or spatial domain transmission filter SL used for SL transmission from a UE-A.

In one example, the beam indication is for a beam or spatial domain reception filter used for SL reception at a UE-B. In one example, the beam indication is for a beam or spatial domain reception filter used for SL reception at a UE-A. In one example, the beam indication is for a beam or spatial domain reception filter used for SL reception at a UE-B and for a beam or spatial domain reception filter used for SL reception at a UE-A.

In one example, a beam indication can be a codepoint with (1) a first TCI state ID or spatial relation information ID associated with a first reference signal transmitted from a UE-A, and (2) a second TCI state ID or spatial relation information ID associated with a second reference signal transmitted from a UE-B. In a variant example, the first TCI state ID or spatial relation information ID and the second TCI state ID or spatial relation information ID are associated respectively with a first and a second reference signals transmitted from a same UE (e.g., UE-A or UE-B). In one example, the first reference signal (or TCI state or spatial relation information) is for a beam indication for a beam or spatial domain transmission filter used for a SL transmission from a UE-A to a UE-B. In one example, the first reference signal (or TCI state or spatial relation information) is for a beam indication for a beam or spatial domain transmission filter used for a SL transmission from a UE-B to a UE-A. In one example, the second reference signal (or TCI state or spatial relation information) is for a beam indication for a beam or spatial domain transmission filter used for a SL transmission from a UE-B to a UE-A. In one example, the second reference signal (or TCI state or spatial relation information) is for a beam indication for a beam or spatial domain transmission filter used for a SL transmission from a UE-A to a UE-B.

In one example, the first reference signal (or TCI state or spatial relation information) is for a beam indication for a beam or spatial domain transmission filter used for SL transmission from a UE-A. In one example, the first reference signal (or TCI state or spatial relation information) is for a beam indication for a beam or spatial domain transmission filter used for SL transmission from a UE-B. In one example, the second reference signal (or TCI state or spatial relation information) is for a beam indication for a beam or spatial domain transmission filter used for SL transmission from a UE-B. In one example, the second reference signal (or TCI state or spatial relation information) is for a beam indication for a beam or spatial domain transmission filter used for SL transmission from a UE-A.

In one example, the first reference signal (or TCI state or spatial relation information) is for a beam indication for a beam or spatial domain reception filter used for SL reception at a UE-A. In one example, the first reference signal (or TCI state or spatial relation information) is for a beam indication for a beam or spatial domain reception filter used for SL reception at a UE-B. In one example, the second reference signal (or TCI state or spatial relation information) is for a beam indication for a beam or spatial domain reception filter used for SL reception at a UE-B. In one example, the second reference signal (or TCI state or spatial relation information) is for a beam indication for a beam or spatial domain reception filter used for SL reception at a UE-A.

In one example, a beam indication can have two codepoints with (1) a first codepoint or a first TCI state ID or spatial relation information ID associated with a first reference signal transmitted from a UE-A, and (2) a second codepoint or a second TCI state ID or spatial relation information ID associated with a second reference signal transmitted from a UE-B. In a variant example, the first codepoint or TCI state ID or spatial relation information ID and the second codepoint or TCI state ID or spatial relation information ID are associated respectively with a first and a second reference signals transmitted from a same UE (e.g., UE-A or UE-B). In one example, the first reference signal (or TCI state code point or TCI state or spatial relation information) is for a beam indication for a beam or spatial domain transmission filter used for a SL transmission from a UE-A to a UE-B. In one example, the first reference signal (or TCI state code point or TCI state or spatial relation information) is for a beam indication for a beam or spatial domain transmission filter used for a SL transmission from a UE-B to a UE-A. In one example, the second reference signal (or TCI state code point or TCI state or spatial relation information) is for a beam indication for a beam or spatial domain transmission filter used for a SL transmission from a UE-B to a UE-A. In one example, the second reference signal (or TCI state code point or TCI state or spatial relation information) is for a beam indication for a beam or spatial domain transmission filter used for a SL transmission from a UE-A to a UE-B.

In one example, the first reference signal (or TCI state code point or TCI state or spatial relation information) is for a beam indication for a beam or spatial domain transmission filter used for SL transmission from a UE-A. In one example, the first reference signal (or TCI state code point or TCI state or spatial relation information) is for a beam indication for a beam or spatial domain transmission filter used for SL transmission from a UE-B. In one example, the second reference signal (or TCI state code point or TCI state or spatial relation information) is for a beam indication for a beam or spatial domain transmission filter used for SL transmission from a UE-B. In one example, the second reference signal (or TCI state code point or TCI state or spatial relation information) is for a beam indication for a beam or spatial domain transmission filter used for SL transmission from a UE-A.

In one example, the first reference signal (or TCI state code point or TCI state or spatial relation information) is for a beam indication for a beam or spatial domain reception filter used for SL reception at a UE-A. In one example, the first reference signal (or TCI state code point or TCI state or spatial relation information) is for a beam indication for a beam or spatial domain reception filter used for SL reception at a UE-B. In one example, the second reference signal (or TCI state code point or TCI state or spatial relation information) is for a beam indication for a beam or spatial domain reception filter used for SL reception at a UE-B. In one example, the second reference signal (or TCI state code point or TCI state or spatial relation information) is for a beam indication for a beam or spatial domain reception filter used for SL reception at a UE-A.

In one example, a beam indication can be a codepoint with (1) a TCI state ID or spatial relation information ID indicating a beam or spatial domain filter for a SL transmission from a UE-A to a UE-B, and/or (2) a TCI state ID or spatial relation information ID indicating a beam or spatial domain filter for a SL transmission from a UE-B to a UE-A, and/or (3) a TCI state ID or spatial relation information ID indicating a beam or spatial domain filter for a SL transmission from a UE-A to a UE-B and a beam or spatial domain filter for a SL transmission from a UE-B to a UE-A, and/or (4) a pair of TCI state IDs or spatial relation information IDs a first of which indicating a beam or spatial domain filter for a SL transmission from a UE-A to a UE-B and a second of which indicating a beam or spatial domain filter for a SL transmission from a UE-B to a UE-A.

In one example, a DCI format for SL (e.g., DCI Format 3-0 or DCI Format 3-x) can include one field (e.g., codepoint) for a beam indication.

In one example, a first stage SCI format can include one field (e.g., codepoint) for a beam indication.

In one example, a second stage SCI format can include one field (e.g., codepoint) for a beam indication. In one example, a PSFCH can include one field (e.g., codepoint) for a beam indication.

In one example, a MAC CE (on Uu interface or PC5 interface) for a beam indication can include one field for a beam indication.

In one example, a beam indication can have two codepoints with (1) a first codepoint indicating a beam or spatial domain filter for a SL transmission from a UE-A to a UE-B, and (2) a second codepoint indicating a beam or spatial domain filter for a SL transmission from a UE-B to a UE-A.

In one example, a DCI format for SL (e.g., DCI Format 3-0 or DCI Format 3-x) can include two fields (e.g., codepoints) for a beam indication.

In one example, a first stage SCI format can include two fields (e.g., codepoints) for a beam indication.

In one example, a second stage SCI format can include two fields (e.g., codepoints) for a beam indication. In one example, a PSFCH can include two fields (e.g., codepoints) for a beam indication.

In one example, a MAC CE (on Uu interface or PC5 interface) for a beam indication can include two fields for a beam indication.

The present disclosure provides: (1) a beam indication signaling using reference signal ID or reference signal code point; (2) a beam indication signaling using TCI state ID or TCI state code point; (3) TCI state codepoint can have a UE-A-to-UE-B TCI state or a UE-B-to-UE-A TCI state or a joint TCI state or a pair of a UE-A-to-UE-B TCI state or a UE-B-to-UE-A TCI state.

The present disclosure considers a beam indication for SL in FR2 for a link between two SL UEs. In one example, a network transmits a beam indication to a SL UE. The SL UE applies the beam indication after a beam application time. In another example, a first SL UE transmits a beam indication to a second SL UL. The beam indication is applied after a beam application time. In the present disclosure, signaling and timing aspects are provided for application of the beam indication on the SL interface (i.e., PC5 interface).

In one example, a first SL UE is transmitting a SL transmission to a second SL UE, and a third SL UE indicates the beam to use between the first SL UE and the second SL UE, in one sub-example, the third UE indicates the beam to the first SL UE, in another sub-example, the third UE indicates the beam to the second SL UE, in yet another sub-example, the third UE indicates the beam to the first SL UE and to the second SL UE. In yet another example, a first SL UE is transmitting a SL transmission to a second SL UE, and a gNB (or a network) indicates the beam to use between the first SL UE and the second SL UE, in one sub-example, the gNB indicates the beam to the first SL UE, in another sub-example, the gNB indicates the beam to the second SL UE, in yet another sub-example, the gNB indicates the beam to the first SL UE and to the second SL UE.

A beam indication is determined based on a beam indication transmitted by RRC signaling and/or MAC CE signaling and/or L1 control (e.g., DCI or SCI or PSFCH) signaling. One aspect of signaling of a beam indication is when to apply the beam indication signaling. In one instance for a link between two SL UEs, the beam indication can be applied at the same time at the SL transmitting UE and the SL receiving UE, as this can help in maintaining beam alignment between the two UEs. In another instance, a UE transmitting a SL transmission can get an indication from another device to change the SL transmit beam and determine a time for applying the new beam. In another instance, a UE receiving a SL transmission can get an indication from another device to change the SL receive beam and determine a time for applying the new beam.

The present disclosure provides aspects related to SL beam indication for beam management on a SL interface: (1) a beam indication from a network device, a UE transmitting a SL transmission, a UE receiving a SL transmission, or a third UE and (2) application time of a beam indication, based on a pre-configured or configured beam application time, or a time indicated with the beam indication, the time indicated time can be a relative time or an absolute time.

A new beam can be indicated from the UE transmitting the SL transmission or from the UE receiving the SL transmission or from the gNB or from a third UE as illustrated in FIG. 9. In the present disclosure, a gNB can be replaced by eNB or TRP or other network device or element transmitting messages to a UE. A third UE can be a platoon leader, a group leader, a radio side unit (RSU), or any other UE.

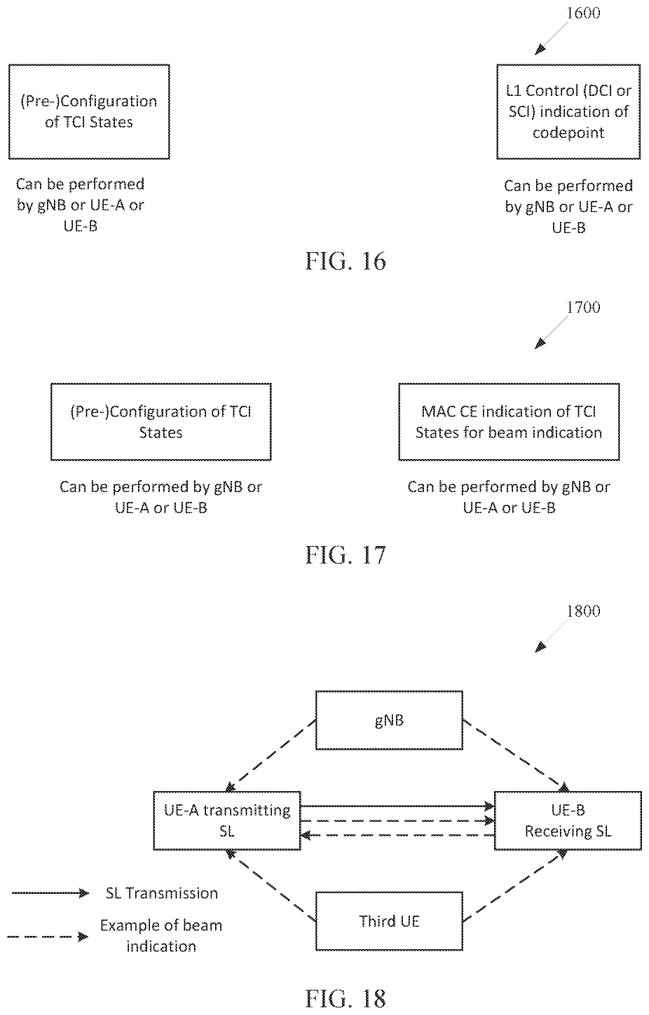

FIGS. 18-28 illustrate examples of a beam indication 1800-2800 according to embodiments of the present disclosure. An embodiment of the beam indication 1800-2800 shown in FIGS. 18-28 are for illustration only.

In one example, a UE-A can be configured with a group or a set or a list of reference signals, wherein a reference signal is transmitted on a beam (e.g., spatial domain transmission filter), illustrated in FIG. 10. For example, reference signal RSA0 is transmitted on beam0 of a UE-A, reference signal RSA1 is transmitted on beam1 of a UE-A, and so on as disclosed in U.S. patent application Ser. No. 18/340,688, based on measurement reports reported from a UE-B, a UE-A can determine or select a beam to use for a SL transmission to a UE-B. A UE-A can indicate the determined or selected beam to a UE-B.

In one example, a UE-B can be configured with a group or a set or a list of reference signals, wherein a reference signal is transmitted on a beam (e.g., spatial domain transmission filter), illustrated in FIG. 10. For example, reference signal RSB0 is transmitted on beam0 of a UE-B, reference signal RSB1 is transmitted on beam1 of a UE-B, and so on . . . . Based on the measurements performed by a UE-A (as disclosed in U.S. patent application Ser. No. 18/340,688), a UE-A can determine or select a preferred beam to use for a SL transmission from a UE-B. A UE-A can indicate the determined or selected beam to a UE-B.

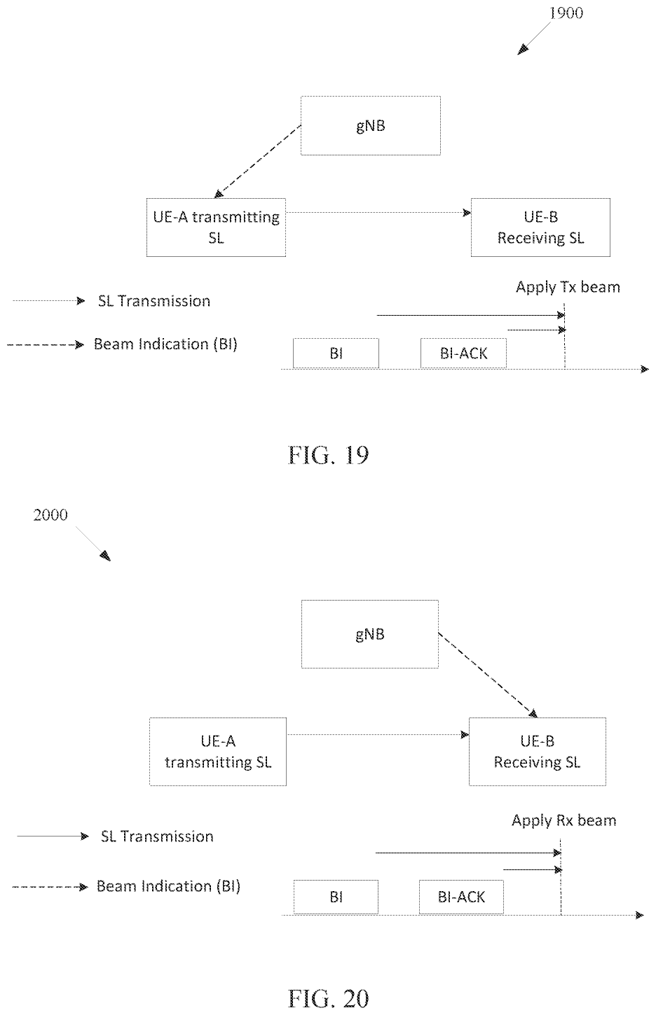

In one example, a gNB can signal a beam indication, e.g., by RRC signaling and/or by MAC CE signaling and/or by L1 control (e.g., DCI) signaling to a UE transmitting a SL transmission as illustrated in FIG. 19. As described in this discourse a beam indication can be applied: (1) after a beam application time from the channel or signal carrying the beam indication; (2) after a beam application time from the channel or signal acknowledging the channel or signal carrying the beam indication; and (3) at a time indicated in the channel or signal carrying the beam indication or the beam indication acknowledgement or a third channel or signal.

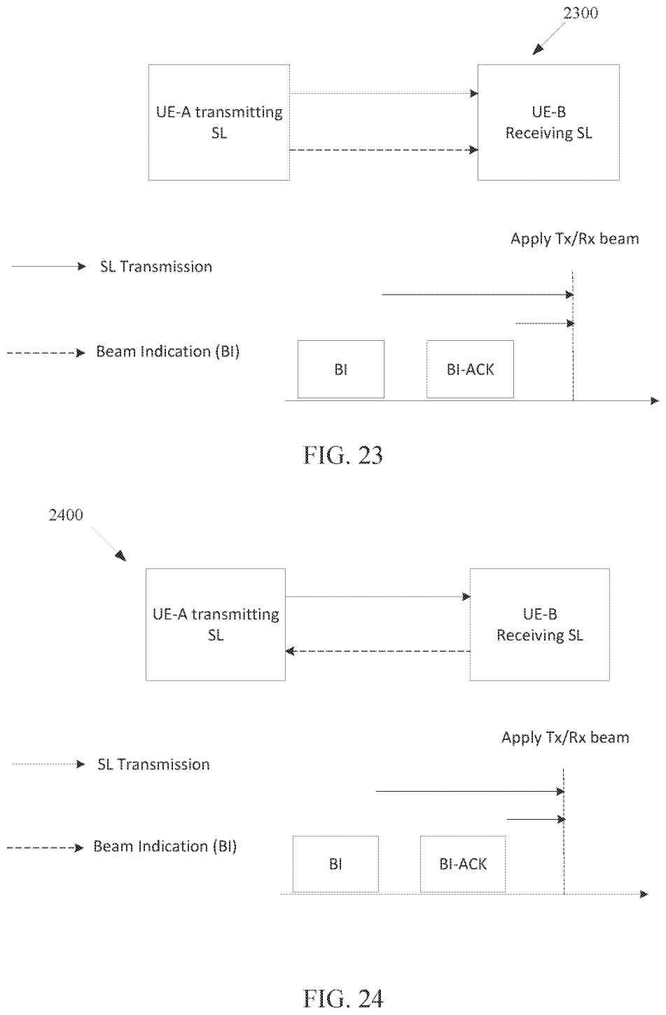

In one example, a gNB can signal a beam indication, e.g., by RRC signaling and/or by MAC CE signaling and/or by L1 control (e.g., DCI) signaling to a UE transmitting a SL transmission. The UE transmitting the SL transmission indicates the beam to the UE receiving the SL transmission e.g., by RRC signaling and/or by MAC CE signaling and/or by L1 control (e.g., first stage SCI or second stage SCI or PSFCH) signaling. The beam indication is applied after a beam indication signaling as described in FIG. 23 and the accompanying text.

In one example, a gNB can signal a beam indication, e.g., by RRC signaling and/or by MAC CE signaling and/or by L1 control (e.g., DCI) signaling to a UE receiving a SL transmission as illustrated in FIG. 20. As described in this discourse a beam indication can be applied: (1) after a beam application time from the channel or signal carrying the beam indication; (2) after a beam application time from the channel or signal acknowledging the channel or signal carrying the beam indication; and (3) at a time indicated in the channel or signal carrying the beam indication or the beam indication acknowledgement or a third channel or signal.

In one example, a gNB can signal a beam indication, e.g., by RRC signaling and/or by MAC CE signaling and/or by L1 control (e.g., DCI) signaling to a UE receiving a SL transmission. The UE receiving the SL transmission indicates the beam to the UE transmitting the SL transmission e.g., by RRC signaling and/or by MAC CE signaling and/or by L1 control (e.g., first stage SCI or second stage SCI or PSFCH) signaling. The beam indication is applied after a beam indication signaling as described in FIG. 24 and the accompanying text.

In one example, a gNB can signal a beam indication, e.g., by RRC signaling and/or by MAC CE signaling and/or by L1 control (e.g., DCI) signaling to a UE transmitting a SL transmission, and the gNB can signal a beam indication, e.g., by RRC signaling and/or by MAC CE signaling and/or by L1 control (e.g., DCI) signaling to a UE receiving the SL transmission. The beam indication is applied after a beam indication signaling as described in FIG. 19 and the accompanying text and in FIG. 20 and the accompanying text. In one example, it can be up to the implementation of the gNB to make the beam application time the same in the UE transmitting a SL transmission and, in the UE, receiving the SL transmission. In one example, the gNB can indicate the same time for application of the beam indication in the transmitting and receiving UEs.

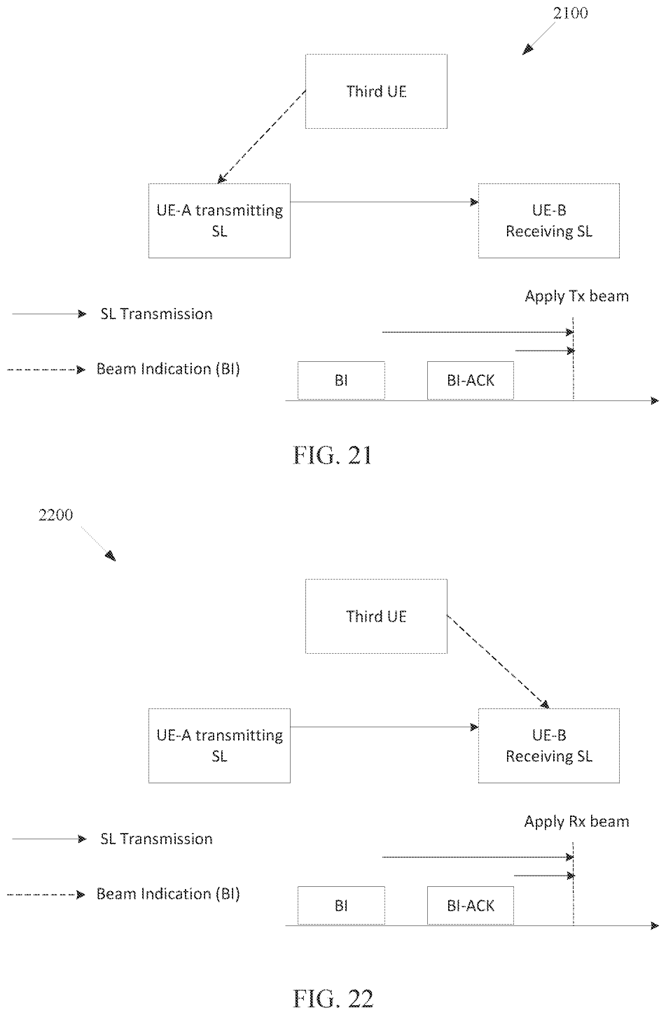

In one example, a third UE can signal a beam indication, e.g., by RRC signaling and/or by MAC CE signaling and/or by L1 control (e.g., first stage SCI or second stage SCI or PSFCH) signaling to a UE transmitting a SL transmission as illustrated in FIG. 21. As described in this discourse a beam indication can be applied: (1) after a beam application time from the channel or signal carrying the beam indication; (2) after a beam application time from the channel or signal acknowledging the channel or signal carrying the beam indication; and (3) at a time indicated in the channel or signal carrying the beam indication or the beam indication acknowledgement or a third channel or signal.

In one example, a third UE can signal a beam indication, e.g., by RRC signaling and/or by MAC CE signaling and/or by L1 control (e.g., first stage SCI or second stage SCI or PSFCH) signaling to a UE transmitting a SL transmission. The UE transmitting the SL transmission indicates the beam to the UE receiving the SL transmission e.g., by RRC signaling and/or by MAC CE signaling and/or by L1 control (e.g., first stage SCI or second stage SCI or PSFCH) signaling. The beam indication is applied after a beam indication signaling as described in FIG. 23 and the accompanying text.

In one example, a third can signal a beam indication, e.g., by RRC signaling and/or by MAC CE signaling and/or by L1 control (e.g., first stage SCI or second stage SCI or PSFCH) signaling to a UE receiving a SL transmission as illustrated in FIG. 22. As described in this discourse a beam indication can be applied: (1) after a beam application time from the channel or signal carrying the beam indication; (2) after a beam application time from the channel or signal acknowledging the channel or signal carrying the beam indication; and (3) at a time indicated in the channel or signal carrying the beam indication or the beam indication acknowledgement or a third channel or signal.

In one example, a third UE can signal a beam indication, e.g., by RRC signaling and/or by MAC CE signaling and/or by L1 control (e.g., first stage SCI or second stage SCI or PSFCH) signaling to a UE receiving a SL transmission. The UE receiving the SL transmission indicates the beam to the UE transmitting the SL transmission e.g., by RRC signaling and/or by MAC CE signaling and/or by L1 control (e.g., first stage SCI or second stage SCI or PSFCH) signaling. The beam indication is applied after a beam indication signaling as described in FIG. 24 and the accompanying text.

In one example, a third UE can signal a beam indication, e.g., by RRC signaling and/or by MAC CE signaling and/or by L1 control (e.g., first stage SCI or second stage SCI or PSFCH) signaling to a UE transmitting a SL transmission, and the third UE can signal a beam indication, e.g., by RRC signaling and/or by MAC CE signaling and/or by L1 control (e.g., first stage SCI or second stage SCI or PSFCH) signaling to a UE receiving the SL transmission. The beam indication is applied after a beam indication signaling as described in FIG. 21 and the accompanying text and in FIG. 22 and the accompanying text. In one example, it can be up to the implementation of the third UE to make the beam application time the same in the UE transmitting a SL transmission and, in the UE, receiving the SL transmission. In one example, the third UE can indicate the same time for application of the beam indication in the transmitting and receiving UEs.

In one example, a UE transmitting a SL transmission can signal a beam indication, e.g., by RRC signaling and/or by MAC CE signaling and/or by L1 control (e.g., first stage SCI or second stage SCI or PSFCH) signaling to a UE receiving the SL transmission as illustrated in FIG. 23. As described in this discourse a beam indication can be applied: (1) after a beam application time from the channel or signal carrying the beam indication; (2) after a beam application time from the channel or signal acknowledging the channel or signal carrying the beam indication; and (3) at a time indicated in the channel or signal carrying the beam indication or the beam indication acknowledgement or a third channel or signal.

In one example, a UE receiving a SL transmission can signal a beam indication, e.g., by RRC signaling and/or by MAC CE signaling and/or by L1 control (e.g., first stage SCI or second stage SCI or PSFCH) signaling to a UE receiving the SL transmission as illustrated in FIG. 24. As described in this discourse a beam indication can be applied: (1) after a beam application time from the channel or signal carrying the beam indication; (2) after a beam application time from the channel or signal acknowledging the channel or signal carrying the beam indication; and (3) at a time indicated in the channel or signal carrying the beam indication or the beam indication acknowledgement or a third channel or signal.

In one example, a UE-A can be a UE (1) transmitting a first SL transmission to a UE-B and (2) receiving a second SL transmission from a UE-B. In one example, a UE-A can indicate a beam to be use for the first SL transmission and the second SL transmission. In one example, a UE-A can indicate two beams, one for the first SL transmission and one for the second SL transmission, in one sub-example, both beams are indicated together (e.g., in the same channel or signal), in another sub-example, each beam is indicated separately (e.g., in a separate channel or signal). In one example, a UE-A can indicate a first beam and a UE-B can indicate a second beam, in one sub-example, the first beam is for the first SL transmission and the second beam is for the second SL transmission, in another sub-example, the first beam is for the second SL transmission and the second beam is for the first SL transmission.

A network element (e.g., a gNB) can send a beam indication (e.g., TCI state codepoint, or TCI state ID or spatial relation information codepoint, or spatial relation information ID, or reference signal codepoint or reference signal ID) to (1) a UE transmitting a SL transmission, (2) a UE receiving a SL transmission, or (3) to a UE transmitting a SL transmission and to a UE receiving the SL transmission; wherein the beam indication is used for the corresponding SL transmission.

In one example, a beam indication (e.g., TCI state codepoint, or TCI state ID or spatial relation information codepoint, or spatial relation information ID, or reference signal codepoint or reference signal ID) is from a network element (e.g., a gNB) to a SL UE by RRC signaling or MAC CE signaling on the Uu interface or by L1 control signaling (e.g., DCI signaling).

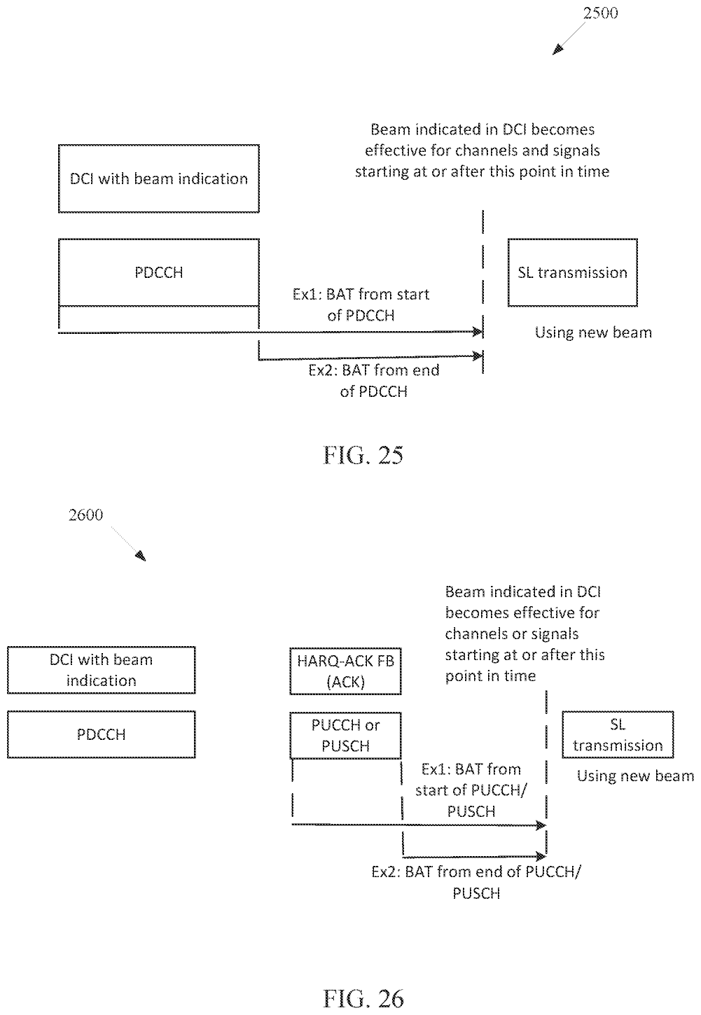

In one example, the beam indication is applied after a time T (e.g., beam application time (BAT)) from the start (e.g., first symbol) of the PDCCH channel carrying the DCI with a beam indication as illustrated in Ex1 of FIG. 25.

In one example, the beam indication is applied after a time T (e.g., beam application time (BAT)) from the end (e.g., last symbol) of the PDCCH channel carrying the DCI with a beam indication as illustrated in Ex2 of FIG. 25.

In one example, the beam indication is applied after a time T (e.g., beam application time (BAT)) from the start (e.g., first symbol) of the PDCCH channel scheduling a PDSCH channel with RRC signaling or MAC CE carrying a beam indication.

In one example, the beam indication is applied after a time T (e.g., beam application time (BAT)) from the end (e.g., last symbol) of the PDCCH channel scheduling a PDSCH channel with RRC signaling or MAC CE carrying a beam indication.

In one example, the beam indication is applied after a time T (e.g., beam application time (BAT)) from the start (e.g., first symbol) of the PDSCH channel with RRC signaling or MAC CE carrying a beam indication.

In one example, the beam indication is applied after a time T (e.g., beam application time (BAT)) from the end (e.g., last symbol) of the PDSCH channel with RRC signaling or MAC CE carrying a beam indication.

In one example, the beam indication is applied at the first slot boundary after a time T (e.g., beam application time (BAT)) from the start (e.g., first symbol) of the PDCCH channel carrying the DCI with a beam indication.

In one example, the beam indication is applied at the first slot boundary after a time T (e.g., beam application time (BAT)) from the end (e.g., last symbol) of the PDCCH channel carrying the DCI with a beam indication.

In one example, the beam indication is applied at the first slot boundary after a time T (e.g., beam application time (BAT)) from the start (e.g., first symbol) of the PDCCH channel scheduling a PDSCH channel with RRC signaling or MAC CE carrying a beam indication.

In one example, the beam indication is applied at the first slot boundary after a time T (e.g., beam application time (BAT)) from the end (e.g., last symbol) of the PDCCH channel scheduling a PDSCH channel with RRC signaling or MAC CE carrying a beam indication.

In one example, the beam indication is applied at the first slot boundary after a time T (e.g., beam application time (BAT)) from the start (e.g., first symbol) of the PDSCH channel with RRC signaling or MAC CE carrying a beam indication.

In one example, the beam indication is applied at the first slot boundary after a time T (e.g., beam application time (BAT)) from the end (e.g., last symbol) of the PDSCH channel with RRC signaling or MAC CE carrying a beam indication.

In one example, the beam indication is applied after a time T (e.g., beam application time (BAT)) from the start (e.g., first symbol) of the UL channel (e.g., PUCCH or PUSCH) carrying an acknowledgment of the DCI or MAC CE or RRC signaling with a beam indication as illustrated in Ex1 of FIG. 26.

In one example, the beam indication is applied after a time T (e.g., beam application time (BAT)) from the end (e.g., last symbol) of the UL channel (e.g., PUCCH or PUSCH) carrying an acknowledgment of the DCI or MAC CE or RRC signaling with a beam indication as illustrated in Ex2 of FIG. 26.

In one example, the beam indication is applied at the first slot boundary after a time T (e.g., beam application time (BAT)) from the start (e.g., first symbol) of the UL channel (e.g., PUCCH or PUSCH) carrying an acknowledgment of the DCI or MAC CE or RRC signaling with a beam indication.

In one example, the beam indication is applied at the first slot boundary after a time T (e.g., beam application time (BAT)) from the end (e.g., last symbol) of the UL channel (e.g., PUCCH or PUSCH) carrying an acknowledgment of the DCI or MAC CE or RRC signaling with a beam indication.

In examples of the present disclosure, T (e.g., beam application time (BAT)) can be determined based on a sub-carrier spacing of one of: (1) the SL BWP; (2) the active DL BWP (e.g., BWP of DCI or MAC CE or RRC signaling with a beam indication) of the Uu interface (between the gNB and the UE); (3) the active UL BWP (e.g., BWP of HARQ-ACK of DCI or MAC CE or RRC signaling with a beam indication) of the Uu interface (between the gNB and the UE); (4) the smallest sub-carrier spacing among the active DL BWP and the active UL BWP; (5) the smallest sub-carrier spacing among the active DL BWP, the active UL BWP and the SL BWP; (6) the smallest sub-carrier spacing among the active DL BWP and the SL BWP; (7) the smallest sub-carrier spacing among the active UL BWP and the SL BWP; (8) the largest sub-carrier spacing among the active DL BWP and the active UL BWP; (9) the largest sub-carrier spacing among the active DL BWP, the active UL BWP and the SL BWP; (10) the largest sub-carrier spacing among the active DL BWP and the SL BWP; and (11) the largest sub-carrier spacing among the active UL BWP and the SL BWP.

In one example time T can depend on a UE capability.

In one example time T can be pre-configured or configured by a network RRC signaling or configured by PC5 RRC signaling. In one example, if no value is configured or pre-configured, a default value is used as specified in the system specification.

In one example time T can be in units of symbols and/or slots and/or sub-frames and/or frames or units of time e.g., ms or seconds. In one example, slots can be physical slots. In one example, slots can be logical slots.

In the aforementioned examples, a slot boundary can be determined based on a slot of one of: (1) the SL BWP; (2) the active DL BWP (e.g., BWP of DCI or MAC CE or RRC signaling with a beam indication) of the Uu interface (between the gNB and the UE); (3) the active UL BWP (e.g., BWP of HARQ-ACK of DCI or MAC CE or RRC signaling with a beam indication) of the Uu interface (between the gNB and the UE); (4) the BWP with the smallest sub-carrier spacing among the active DL BWP and the active UL BWP; (5) the BWP with the smallest sub-carrier spacing among the active DL BWP, the active UL BWP and the SL BWP; (6) the BWP with the smallest sub-carrier spacing among the active DL BWP and the SL BWP; (7) the BWP with the smallest sub-carrier spacing among the active UL BWP and the SL BWP; (8) the BWP with the largest sub-carrier spacing among the active DL BWP and the active UL BWP; (9) the BWP with the largest sub-carrier spacing among the active DL BWP, the active UL BWP and the SL BWP; (10) the BWP with the largest sub-carrier spacing among the active DL BWP and the SL BWP; and (11) the BWP with the largest sub-carrier spacing among the active UL BWP and the SL BWP.

In one example, a beam indication channel or signal (e.g., by RRC or MAC CE or L1 control) or channel or signal acknowledging a beam indication (e.g., by RRC or MAC CE or L1 control) or a third channel or signal can indicate the time of application of the beam indication.

In one example, the indicated beam application time is an absolute time, e.g., as a symbol index and/or slot index and/or sub-frame index and/or frame (e.g., SFN or DFN index). For example, if the indicated slot index is slot S, the beam can be applied at the next slot S boundary, wherein slot S can be a slot index within a frame. In another example, if the indicated slot index is slot S, the beam can be applied at the next slot S boundary, wherein slot S can be a logical slot index. In another example, if the indicated sub-frame index is sub-frame SF, the beam can be applied at the next sub-frame SF boundary, wherein sub-frame SF can be a sub-frame index within a frame. In another example, if the indicated frame index is frame F, the beam can be applied at the next frame F boundary, F can be an SFN number or a DFN number. In another example, if the indicated slot index is slot S and frame index is F, the beam can be applied at the next slot S in frame F boundary, wherein slot S can be a slot index within a frame, and F can be an SFN number or a DFN number. In one example, a slot index can be a physical slot index. In one example, a slot index can be a logical slot index.

In one example, the indicated beam application time is a relative time. In one example, the indicated beam application time is relative to the start of the channel/signal conveying the beam indication or beam indication acknowledgement or a third channel or the start of the DCI scheduling the channel/signal conveying the beam indication or beam indication acknowledgement or a third channel. In one example, the indicated beam application time is relative to the end of the channel/signal conveying the beam indication or beam indication acknowledgement or a third channel or the end of the DCI scheduling the channel/signal conveying the beam indication or beam indication acknowledgement or a third channel. In one example, the indicated beam application time is relative to the start of the channel conveying HARQ-ACK of the channel/signal conveying the beam indication. In one example, the indicated beam application time is relative to the end of the channel conveying HARQ-ACK of the channel/signal conveying the beam indication.

In one example, the indicated beam application time can be in units of symbols and/or slots and/or sub-frames and/or frames or units of time e.g., ms or seconds. In one example, slots can be physical slots. In one example, slots can be logical slots.

In one example, a set or list or group of beam application times is specified in the systems specification and/or pre-configured and/or configured by Uu-RRC signaling and/or PC5-RRC signaling. The indicated beam application time is an index of an element in the set or list or group of beam application times. Each beam application time in the list or group of beam application times can be in units of symbols and/or slots and/or sub-frames and/or frames or unit of time e.g., ms or seconds. In one example, slots can be physical slots. In one example, slots can be logical slots.

For the aforementioned examples, the symbol index or the symbol duration or the slot index or the slot duration can be determined based on the sub-carrier spacing of one of: (1) the SL BWP; (2) the active DL BWP (e.g., BWP of DCI or MAC CE or RRC signaling with a beam indication) of the Uu interface (between the gNB and the UE); (3) the active UL BWP (e.g., BWP of HARQ-ACK of DCI or MAC CE or RRC signaling with a beam indication) of the Uu interface (between the gNB and the UE); (4) the BWP with the smallest sub-carrier spacing among the active DL BWP and the active UL BWP; (5) the BWP with the smallest sub-carrier spacing among the active DL BWP, the active UL BWP and the SL BWP; (6) the BWP with the smallest sub-carrier spacing among the active DL BWP and the SL BWP; (7) the BWP with the smallest sub-carrier spacing among the active UL BWP and the SL BWP; (8) the BWP with the largest sub-carrier spacing among the active DL BWP and the active UL BWP; (9) the BWP with the largest sub-carrier spacing among the active DL BWP, the active UL BWP and the SL BWP; (10) the BWP with the largest sub-carrier spacing among the active DL BWP and the SL BWP; and (11) the BWP with the largest sub-carrier spacing among the active UL BWP and the SL BWP.

A first SL UE can send a beam indication (e.g., TCI state codepoint, or TCI state ID or spatial relation information codepoint, or spatial relation information ID, or reference signal codepoint or reference signal ID) to a second SL UE; wherein the beam indication is used for the corresponding SL transmission.

In one example, the first SL UE is a UE other than UE transmitting the SL transmission and the UE receiving the SL transmission, the second SL UE can be (1) a UE transmitting a SL transmission, or (2) a UE receiving a SL transmission.

In one example, the first SL UE is a UE other than UE transmitting the SL transmission and the UE receiving the SL transmission, the beam indication can be unicast separately to a UE transmitting a SL transmission and a UE receiving the SL transmission.

In one example, the first SL UE is a UE other than UE transmitting the SL transmission and the UE receiving the SL transmission, the beam indication can be groupcast to a UE transmitting a SL transmission and a UE receiving the SL transmission.

In one example, the first SL UE is a UE transmitting the SL transmission and the second UE is a UE receiving the SL transmission.

In one example, the first SL UE is a UE receiving the SL transmission and the second UE is a UE transmitting the SL transmission.

In one example, a beam indication (e.g., TCI state codepoint, or TCI state ID or spatial relation information codepoint, or spatial relation information ID, or reference signal codepoint or reference signal ID) is from a first SL UE to a second SL UE by PC5 RRC signaling or PC5 MAC CE signaling or L1 control signaling (e.g., first stage SCI or second stage SCI signaling or PSFCH).

In one example, the beam indication is applied to the corresponding PSSCH, for example if the beam indication is in the PSCCH, the beam indication can be applied to the corresponding PSSCH.

In one example, the beam indication is applied to the slot after the slot of the channel/signal conveying the beam indication.

In one example, the beam indication is applied starting from or after the PSFCH transmission carrying HARQ-ACK corresponding to the channel/signal conveying the beam indication.

In one example, the beam indication is applied starting from the slot of the PSFCH transmission carrying HARQ-ACK corresponding to the channel/signal conveying the beam indication.

In one example, the beam indication is applied starting from the slot after the slot of the PSFCH transmission carrying HARQ-ACK corresponding to the channel/signal conveying the beam indication.

In one example, the beam indication is applied starting from a SL transmission indicated by the channel/signal conveying the beam indication. For example, this can be the next reserved resource (or the slot of the next reserved resource) by the PSCCH corresponding to the channel/signal conveying the beam indication.

In one example, the beam indication is applied starting from the slot at or after a SL transmission indicated by the channel/signal conveying the beam indication. For example, this can be the slot at or after the next (or the last) reserved resource by the PSCCH corresponding to the channel/signal conveying the beam indication.

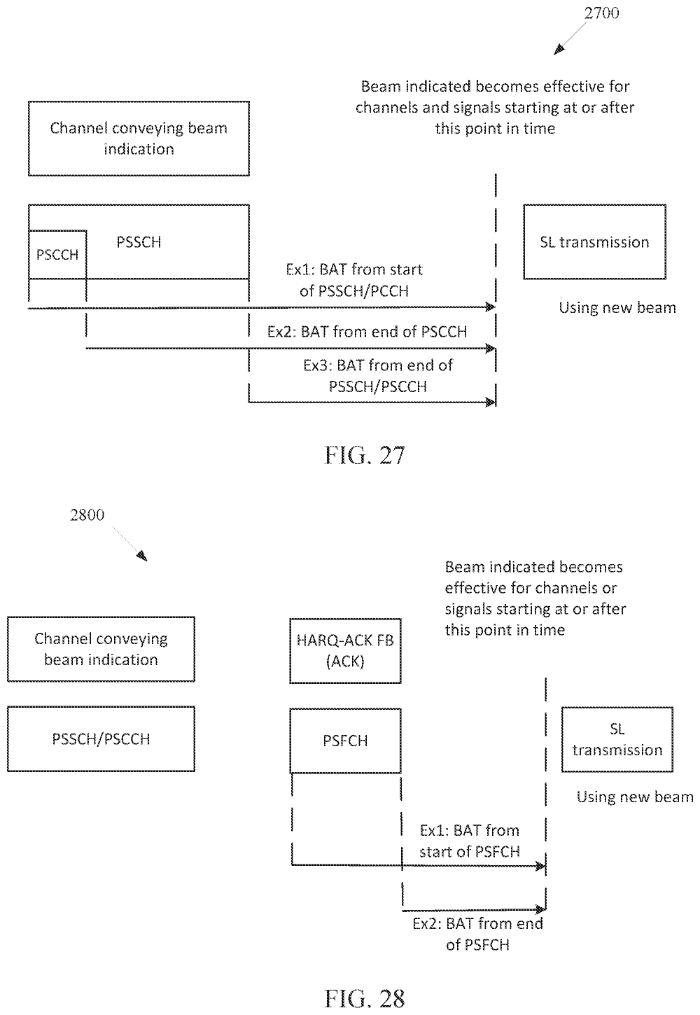

In one example, the beam indication is applied after a time T (e.g., beam application time (BAT)) from the start (e.g., first symbol) of the PSCCH/PSSCH channel carrying (1) the first stage SCI with a beam indication, or (2) the second stage SCI with a beam indication, (3) the MAC CE with a beam indication, or (4) the RRC signal with a beam indication, as illustrated in Ex1 of FIG. 27. In one example, the beam indication is applied after a time T (e.g., beam application time (BAT)) from the start (e.g., first symbol) of a PSFCH with a beam indication.

In one example, the beam indication is applied after a time T (e.g., beam application time (BAT)) from the end (e.g., last symbol) of the PSCCH channel carrying the first stage SCI with a beam indication as illustrated in Ex2 of FIG. 27.

In one example, the beam indication is applied after a time T (e.g., beam application time (BAT)) from the end (e.g., last symbol) of the PSCCH/PSSCH channel carrying (1) the first stage SCI with a beam indication, or (2) the second stage SCI with a beam indication, (3) the MAC CE with a beam indication, or (4) the RRC signal with a beam indication, as illustrated in Ex3 of FIG. 27. In one example, the beam indication is applied after a time T (e.g., beam application time (BAT)) from the end (e.g., last symbol) of a PSFCH with a beam indication.

In one example, the beam indication is applied at the first slot boundary after a time T (e.g., beam application time (BAT)) from the start (e.g., first symbol) of the PSCCH/PSSCH channel carrying (1) the first stage SCI with a beam indication, or (2) the second stage SCI with a beam indication, (3) the MAC CE with a beam indication, or (4) the RRC signal with a beam indication. In one example, the beam indication is applied at the first slot boundary after a time T (e.g., beam application time (BAT)) from the start (e.g., first symbol) of a PSFCH with a beam indication.

In one example, the beam indication is applied at the first slot boundary after a time T (e.g., beam application time (BAT)) from the end (e.g., last symbol) of the PSCCH channel carrying the first stage SCI with a beam indication.

In one example, the beam indication is applied at the first slot boundary after a time T (e.g., beam application time (BAT)) from the end (e.g., last symbol) of the PSCCH/PSSCH channel carrying (1) the first stage SCI with a beam indication, or (2) the second stage SCI with a beam indication, (3) the MAC CE with a beam indication, or (4) the RRC signal with a beam indication. In one example, the beam indication is applied at the first slot boundary after a time T (e.g., beam application time (BAT)) from the end (e.g., last symbol) of a PSFCH with a beam indication.

In one example, the beam indication is applied after a time T (e.g., beam application time (BAT)) from the start (e.g., first symbol) of the SL channel (e.g., PSFCH) carrying an acknowledgment of the first stage SCI or second stage SCI or MAC CE or RRC or PSFCH signaling with a beam indication as illustrated in Ex1 of FIG. 28.

In one example, the beam indication is applied after a time T (e.g., beam application time (BAT)) from the end (e.g., last symbol) of the SL channel (e.g., PSFCH) carrying an acknowledgment of the first stage SCI or second stage SCI or MAC CE or RRC or PSFCH signaling with a beam indication as illustrated in Ex2 of FIG. 28.

In one example, the beam indication is applied at the first slot boundary after a time T (e.g., beam application time (BAT)) from the start (e.g., first symbol) of the SL channel (e.g., PSFCH) carrying an acknowledgment of the first stage SCI or second stage SCI or MAC CE or RRC or PSFCH signaling with a beam indication.

In one example, the beam indication is applied at the first slot boundary after a time T (e.g., beam application time (BAT)) from the end (e.g., last symbol) of the SL channel (e.g., PSFCH) carrying an acknowledgment of the first stage SCI or second stage SCI or MAC CE or RRC or PSFCH signaling with a beam indication.

In examples of the present disclosure, T (e.g., beam application time (BAT)) can be determined based on a sub-carrier spacing of: (1) the SL BWP; (2) the active DL BWP of the Uu interface (between the gNB and the UE); (3) the active UL BWP of the Uu interface (between the gNB and the UE); (4) the smallest sub-carrier spacing among the active DL BWP and the active UL BWP; (5) the smallest sub-carrier spacing among the active DL BWP, the active UL BWP and the SL BWP; (6) the smallest sub-carrier spacing among the active DL BWP and the SL BWP; (7) the smallest sub-carrier spacing among the active UL BWP and the SL BWP; (8) the largest sub-carrier spacing among the active DL BWP and the active UL BWP; (9) the largest sub-carrier spacing among the active DL BWP, the active UL BWP and the SL BWP; (10) the largest sub-carrier spacing among the active DL BWP and the SL BWP; and (11) the largest sub-carrier spacing among the active UL BWP and the SL BWP.

In one example time T can depend on a UE capability.

In one example time T can be pre-configured or configured by a network RRC signaling or configured by PC5 RRC signaling. In one example, if no value is configured or pre-configured, a default value is used as specified in the system specification.

In one example time T can be in units of symbols and/or slots and/or sub-frames and/or frames or units of time e.g., ms or seconds. In one example, slots can be physical slots. In one example, slots can be logical slots.

In the aforementioned examples, a slot boundary can be determined based on a slot of one of: (1) the SL BWP; (2) the active DL BWP of the Uu interface (between the gNB and the UE); (3) the active UL BWP of the Uu interface (between the gNB and the UE); (4) the smallest sub-carrier spacing among the active DL BWP and the active UL BWP; (5) the smallest sub-carrier spacing among the active DL BWP, the active UL BWP and the SL BWP; (6) the smallest sub-carrier spacing among the active DL BWP and the SL BWP; (7) the smallest sub-carrier spacing among the active UL BWP and the SL BWP; (8) the largest sub-carrier spacing among the active DL BWP and the active UL BWP; (9) the largest sub-carrier spacing among the active DL BWP, the active UL BWP and the SL BWP; (10) the largest sub-carrier spacing among the active DL BWP and the SL BWP; and (11) the largest sub-carrier spacing among the active UL BWP and the SL BWP.

In one example, a beam indication channel or signal (e.g., by RRC or MAC CE or L1 control) or channel or signal acknowledging a beam indication (e.g., by RRC or MAC CE or L1 control) or a third channel or signal can indicate the time of application of the beam indication.

In one example, the indicated beam application time is an absolute time, e.g., as a symbol index and/or slot index and/or sub-frame index and/or frame (e.g., SFN or DFN index). For example, if the indicated slot index is slot S, the beam can be applied at the next slot S boundary, wherein slot S can be a slot index within a frame. In another example, if the indicated slot index is slot S, the beam can be applied at the next slot S boundary, wherein slot S can be a logical slot index. In another example, if the indicated sub-frame index is sub-frame SF, the beam can be applied at the next sub-frame SF boundary, wherein sub-frame SF can be a sub-frame index within a frame. In another example, if the indicated frame index is frame F, the beam can be applied at the next frame F boundary, F can be an SFN number or a DFN number. In another example, if the indicated slot index is slot S and frame index is F, the beam can be applied at the next slot S in frame F boundary, wherein slot S can be a slot index within a frame, and F can be an SFN number or a DFN number. In one example, a slot index can be a physical slot index. In one example, a slot index can be a logical slot index.

In one example, the indicated beam application time is a relative time. In one example, the indicated beam application time is relative to the start of the channel/signal conveying the beam indication (e.g., PSSCH/PSCCH or PSFCH). In one example, the indicated beam application time is relative to the end of the channel/signal conveying the beam indication (e.g., PSSCH/PSCCH or PSFCH) or the end of the associated PSCCH. In one example, the indicated beam application time is relative to the start of the channel conveying HARQ-ACK of the channel/signal conveying the beam indication. In one example, the indicated beam application time is relative to the end of the channel conveying HARQ-ACK of the channel/signal conveying the beam indication.

In one example, the indicated beam application time can be in units of symbols and/or slots and/or sub-frames and/or frames or units of time e.g., ms or seconds. In one example, slots can be physical slots. In one example, slots can be logical slots.

In one example, a set or list or group of beam application times is specified in the systems specification and/or pre-configured and/or configured by Uu-RRC signaling and/or PC5-RRC signaling. The indicated beam application time is an index of an element in the set or list or group of beam application times. Each beam application time in the list or group of beam application times can be in units of symbols and/or slots and/or sub-frames and/or frames or unit of time e.g., ms or seconds. In one example, slots can be physical slots. In one example, slots can be logical slots.

For the aforementioned examples, the symbol index or the symbol duration or the slot index or the slot duration can be determined based on the sub-carrier spacing of one of: (1) the SL BWP; (2) the active DL BWP of the Uu interface (between the gNB and the UE); (3) the active UL BWP of the Uu interface (between the gNB and the UE); (4) the smallest sub-carrier spacing among the active DL BWP and the active UL BWP; (5) the smallest sub-carrier spacing among the active DL BWP, the active UL BWP and the SL BWP; (6) the smallest sub-carrier spacing among the active DL BWP and the SL BWP; (7) the smallest sub-carrier spacing among the active UL BWP and the SL BWP; (8) the largest sub-carrier spacing among the active DL BWP and the active UL BWP; (9) the largest sub-carrier spacing among the active DL BWP, the active UL BWP and the SL BWP; (10) the largest sub-carrier spacing among the active DL BWP and the SL BWP; and (11) the largest sub-carrier spacing among the active UL BWP and the SL BWP.

The present disclosure provides: (1) a beam indication from a network, transmitting SL UE, receiving SL UE or a third SL UE and (2) a timing of application of a beam indication.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a transceiver configured to:
transmit, to a second UE, a first set of reference signals, or
receive, from the second UE, a second set of reference signal; and
a processor operably coupled to the transceiver, the processor configured to:
identify a beam indication for transmission to the second UE, or reception from the second UE, wherein the beam indication is associated with a reference signal from the first set of reference signals or the second set of reference signals,
determine, based on the beam indication, a spatial transmission filter or a spatial reception filter, and
determine a time T to apply the beam indication,
wherein the transceiver is further configured to:
transmit, to the second UE, a first sidelink (SL) channel using the spatial transmission filter starting from the time T, or
receive, from the second UE, a second SL channel using the spatial reception filter starting from the time T.

2. The UE of claim 1, wherein:
the transceiver is further configured to:
transmit the beam indication, and
receive a third SL channel conveying an acknowledgement for the beam indication, and
the time T is from a time of reception of the third SL channel.

3. The UE of claim 1, wherein:
the transceiver is further configured to:
receive the beam indication, and
transmit a third SL channel conveying an acknowledgement for the beam indication, and
the time T is from a time of transmission of the third SL channel.

4. The UE of claim 1, wherein:
the transceiver is further configured to:
receive, from a base station (gNB), the beam indication,
transmit, to the second UE, the beam indication, and
receive a third SL channel conveying an acknowledgement for the beam indication, and
the time T is from a time of reception of the third SL channel.

5. The UE of claim 1, wherein:
the transceiver is further configured to receive a set of SL transmission configuration indication (TCI) states, and
a SL TCI state, from the set of SL TCI states, includes a reference signal identifier (ID) corresponding to the first set of reference signals or the second set of reference signals.

6. The UE of claim 5, wherein:
the transceiver is further configured to transmit or receive a set of activated TCI states,
the set of activated TCI states is from the set of SL TCI states, and
the beam indication is from the set of activated TCI states.

7. The UE of claim 5, wherein:
the transceiver is further configured to transmit or receive a set of activated TCI state codepoints, and
a TCI state codepoint from the set of activated TCI state codepoints is one of:
a TCI state for the first SL channel,
a TCI state for the second SL channel,
a TCI state for the first SL channel and the second SL channel, or
a pair of TCI states including a TCI state for the first SL channel and a TCI state for the second SL channel.

8. The UE of claim 5, wherein:
the SL TCI state includes power control parameters for the first SL channel, and
the power control parameters include:
a P0 value for SL pathloss-based power control, and
an alpha value for SL pathloss-based power control.

9. The UE of claim 5, wherein:
the SL TCI state includes power control parameters for the second SL channel, and
the power control parameters include:
a P0 value for SL pathloss-based power control, and
an alpha value for SL pathloss-based power control.

10. The UE of claim 1, wherein the time T is based on a sub-carrier spacing configuration of a SL bandwidth part (BWP) associated with the first or second SL channel.

11. A base station (BS) comprising:
a transceiver configured to transmit configuration information for a set of reference signals on a sidelink interface; and
a processor operably coupled to the transceiver, the processor configured to determine a beam indication, based on the set of reference signals, for a sidelink channel,
wherein the transceiver is further configured to transmit a downlink control channel (DCI) format that includes the beam indication.

12. A method of operating a user equipment (UE), the method comprising:
at least one of:
transmitting, to a second UE, a first set of reference signals; or
receiving, from the second UE, a second set of reference signal;
identifying a beam indication for transmission to the second UE, or reception from the second UE, wherein the beam indication is associated with a reference signal from the first set of reference signals or the second set of reference signals;
determining, based on the beam indication, a spatial transmission filter or a spatial reception filter;
determining a time T to apply the beam indication; and
at least one of:
transmitting, to the second UE, a first sidelink (SL) channel using the spatial transmission filter starting from the time T, or
receiving, from the second UE, a second SL channel using the spatial reception filter starting from the time T.

13. The method of claim 12, further comprising:
transmitting the beam indication; and
receiving a third SL channel conveying an acknowledgement for the beam indication,
wherein the time T is from a time of reception of the third SL channel.

14. The method of claim 12, further comprising:
receiving the beam indication; and
transmitting a third SL channel conveying an acknowledgement for the beam indication,
wherein the time T is from a time of transmission of the third SL channel.

15. The method of claim 12, further comprising:
receiving, from a base station (gNB), the beam indication;
transmitting, to the second UE, the beam indication; and
receiving a third SL channel conveying an acknowledgement for the beam indication,
wherein the time T is from a time of reception of the third SL channel.

16. The method of claim 12, further comprising:
receiving a set of SL transmission configuration indication (TCI) states,
wherein a SL TCI state, from the set of SL TCI states, includes a reference signal identifier (ID) corresponding to the first set of reference signals or the second set of reference signals.

17. The method of claim 16, further comprising:
transmitting or receiving a set of activated TCI states, wherein:
the set of activated TCI states is from the set of SL TCI states, and
the beam indication is from the set of activated TCI states.

18. The method of claim 16, further comprising:
transmitting or receiving a set of activated TCI state codepoints,
wherein a TCI state codepoint from the set of activated TCI state codepoints is one of:
a TCI state for the first SL channel,
a TCI state for the second SL channel,
a TCI state for the first SL channel and the second SL channel, or
a pair of TCI states including a TCI state for the first SL channel and a TCI state for the second SL channel.

19. The method of claim 16, wherein:
the SL TCI state includes power control parameters for the first SL channel, and
the power control parameters include:
a P0 value for SL pathloss-based power control, and
an alpha value for SL pathloss-based power control.

20. The method of claim 16, wherein:
the SL TCI state includes power control parameters for the second SL channel, and
the power control parameters include:
a P0 value for SL pathloss-based power control, and
an alpha value for SL pathloss-based power control.
